(19) United States
(12) Patent Application Publication
(10) Pub. No.: US 2002/0071140 A1
(43) Pub. Date: Jun. 13, 2002

(54) Threshold matrix, and method and apparatus of reproducing gray levels using threshold matrix

(76) Inventors: Takashi Suzuki, Kanagawa (JP); Keiji Okinaka, Chiba (JP)

Correspondence Address: FITZPATRICK CELLA HARPER & SCINTO, 30 ROCKEFELLER PLAZA, NEW YORK, NY, 10112, US

(21) Appl. No.: 09/730,561

(22) Filed: Dec. 7, 2000

Related U.S. Application Data
(63) Continuation-in-part of application No. 09/324,507, filed on Jun. 3, 1999.

(30) Foreign Application Priority Data
Jun. 3, 1998 (JP) 10-154459

(51) Int. Cl. H04N 1/40

(52) U.S. Cl. 358/455

(57) ABSTRACT

A threshold matrix (a mask) that enables obtaining high-quality images each with a uniform dot distribution using a small or substantially small mask and enables to obviate the need to increase the mask size for high-definition printers and to reduce the memory capacity required to store the mask, as well as a gray-level reproduction method and apparatus using this threshold matrix is described.

A threshold matrix is formed so that (1) a dot pattern generated by executing a gray level reproducing process using the threshold matrix has at least a set of element pixel blocks having in all gray levels the same dot distribution in each element pixel block corresponding to each element mask, (2) weak irregularity or pseudo periodicity is introduced into one of the low gray levels equal to or higher than the first gray level, (3) in all gray levels, the number of dots is equal for all element pixel blocks, and (4) in every 4n (n is an integer) gray levels, the number of dots is equal in four individual partial element pixel blocks each obtained by quartering each element pixel block.

This is a continuation-in-part application of U.S. patent application Ser. No. 09/324,507 filed on Jun. 3, 1999 entitled “THRESHOLD MATRIX, AND METHOD AND APPARATUS OF REPRODUCING GRAY LEVEL USING THRESHOLD MATRIX”.

### BACKGROUND OF THE INVENTION

1. Field of the Invention

The present invention relates to a threshold matrix and a gray level reproducing method and apparatus using the threshold matrix, and more specifically to a threshold matrix and a gray level reproducing method and apparatus using the threshold matrix for converting input image data into binary or multivalue data in a gray level reproducing process.

2. Description of the Related Art

Digital halftoning technologies have been, roughly speaking, categorized into two methods, i.e., an error diffusion method and a mask method. In the mask method, basically, an output value of a pixel of an output image is determined by making a pixel of the original image correspond one to one to an element of a threshold matrix in a binarizing process.

On the other hand, in the error diffusion method, an output value, of a relevant pixel of an input image, is determined so that an error occurring therein can be compensated by calculation to diffuse the error into neighboring pixels. Therefore, although the quality of the output image is higher than that of the image produced by the mask method, processing time for this halftoning process usually takes 3 to 5 times longer than the mask method, even if a high speed processor is used.

Ordered dithering method, a well-known mask method, is roughly divided into clustered-dot dithering and dispersed-dot dithering (R. Ulichney, Digital Halftoning (MIT Press, Cambridge, Mass.) 1987).

About 10 years ago, when the resolutions of digital printers were coarse, such as 300 to 500 dpi on the average, the dispersed-dot dithering process was used for producing output images whose image quality could be low and, when the demand for image quality is high, error-diffusion process was used. The reason for the image quality of the dispersed-dot dithering method being low is that a regular pattern with periodicity, corresponding to mask size, appears two-dimensionally in some output image regions where values of gray levels are comparatively low and, furthermore, when regular patterns with periodicity small compared to the mask size are involved in input images, moiré, viz., a kind of regular artifact, can appear. The clustered-dot dithering process produces a periodic pattern, with periodicity of the mask size independent of the gray level in which each cluster becomes large as the gray level goes up. Hence, this method has been generally used in printing in which resolution is much higher than that of digital printers.

When an output image is actually observed by the eye with the optimal viewing distance of about 25 cm, since the characteristic of the modulation transfer function (MTF) for an eye has its peak at about 1 lp (line pairs)/mm and has a realistic resolution limit of 7 lp/mm or so, the eye resolution limit of the distance between neighboring two dots in the output image plane is about 0.14 mm. In the dispersed-dot dithering method, since the mask has 16×16=256 elements for the number of reproducible density levels of 256, its size projected on the output image plane is 1.4 mm square for printers with 300 dpi or 0.8 mm square for printers with 500 dpi. When an input image has regions where individual gray levels are constant and low, since a characteristic dot pattern, call a mask pattern for later convenience, produced by a single mask, in one of the above sizes, is repeatedly disposed two-dimensionally in those regions, a periodic pattern with period of 1 mm or so, a period which is sensitive to the eye, can be observed as a regular artifact.

In the dispersed-dot dithering method, in which a periodic dot pattern with the highest frequency appears at the middle gray level, i.e. the 128th gray level, individual dot patterns at every gray level have distinct periodicity. Therefore, if an input image involves a periodic pattern having a period similar to that of a mask pattern, moire as a periodic structure having a frequency determined by the difference of two frequencies of the above two periodic patterns can be observed as an artifact, easily perceivable for the eye, provided that the artifact has a period of about 1 mm to a few mm. Apart from the moiré, in order to make the period of a periodic pattern generated by repeatedly disposing the mask pattern be the same as the resolution limit of the eye, a printer with 2860 dpi resolution will be necessary.

In the error diffusion method, although there have been various methods for diffusing errors, it was shown by Ulichney (the above-mentioned book, §8.3.1, p. 268, and “Dithering with Blue noise”, Proc. IEEE, vol. 76, no. 1 (1988) p. 56) that the perturbed error diffusion method is visually superior to others because spatial frequency characteristics of a binary pattern (a dot pattern) generated at each respective gray level have the blue noise properties. Namely, this method can produce blue noise patterns which have benefits of a periodic, uncorrelated structure without low frequency graininess (Ulichney, the above-mentioned book, p. 233).

FIG. 68 shows the correspondence between the characteristics of the blue noise patterns in a frequency domain and those in an output-image domain (referred to as a scheme). In FIG. 68, small low frequency components in the spatial frequency domain means little low frequency graininess in the output-image domain, and being a periodic and isotropic in the frequency domain signifies that artifacts such as a visually periodic pattern caused by repeatedly disposing the same mask pattern, moiré caused by interference between the mask pattern and an input image, etc. are not generated in the output-image domain. That is, a visually pleasing dot pattern essentially requires both small low frequency components and a periodic and isotropic in the frequency domain. Therefore, according to the scheme on blue noise disclosed by Ulichney, it follows, between two ordinary propositions, that, if a dot pattern is visually pleasing, the pattern has blue noise spectra, and vice versa. Then, it naturally follows, between two propositions each being in contraposition to individual or dinary propositions, that, if a dot pattern is visually unpleasing, the pattern has non-blue noise spectra, and vice versa. Here, the non-blue noise spectra are characterized in the frequency domain as not having either one or both of the characteristics I and II of the blue noise spectra shown in FIG. 68. Hence, there are three types of non-blue noise spectra.

Based on the above result, in the error diffusion method, inventions to realize blue noise patterns in the mask method, having the merit of fast process time, were beginning to appear. First, a method in which each blue noise mask is prepared for indindividual gray levels was invented (U.S. Pat. No. 4,920,501 and U.S. Pat. No. 5,214,517). Next, a blue noise mask method preparing only a single mask as a threshold matrix, which is naturally applicable to every gray level, was invented (Japanese Patent Publication No. 2622429, U.S. Pat. No. 5,111,310, U.S. Pat. No. 5,477,305, etc. specifications). Further, a void and cluster method (U.S. Pat. No. 5,535,020) and its improvement (U.S. Pat. No. 5,317,418) were invented.

The blue noise mask method is a binarization method based on the scheme shown in FIG. 68. As described in all inventions (Japanese Patent Publication No. 2622429, U.S. Pat. No. 5,111,310, U.S. Pat. No. 5,323,247, U.S. Pat. No. 5,341,228, U.S. Pat. No. 5,477,305, U.S. Pat. No. 5,543,941 specifications) related to this method, the blue noise properties of the blue noise patterns generated by the method, when an arbitrary gray level is determined, indicate characteristics of the output pattern of dots (dot pattern) as being locally a periodic and isotropic with negligible or small low-frequency components. In addition, the blue noise properties are non-deterministic in that the dot distribution at an arbitrary gray level is not predetermined, or they depend only on the randomness caused by the algorithm for generating a mask. Therefore, the dot distribution having the blue noise properties can be defined as random, non-deterministic, and having non-white noise characteristics (U.S. Pat. No. 5,111,310).

Note that the scheme shown in FIG. 68 is prepared based on the error diffusion method in which an output signal is obtained through binarizing an input signal in real time. Hence, the dot distribution having the blue noise properties can be basically obtained regardless of the size of an output image. However, for an input image at a certain gray level in the mask method, the same dot pattern, whose size depends on the size of the mask and the resolution of an output device, for example, a printer, a facsimile, etc., periodically appears on the output image. This causes extremely high periodicity absent from the error diffusion method, and is a serious problem that is inconsistent, in principle, with the scheme of blue noise which is basically a periodic and isotropic. In the above-described various mask methods, relating to the blue noise properties, no disclosure is made on the practical conditions for solving the inconsistency.

Described below are limits of the blue noise mask method caused by the above-described basic problem and problems specific to the blue noise mask method.

At the time when the above-described method was invented, the resolution of printers were 300 to 500 dpi on the average (Japanese Patent Publication No. 2622429, U.S. Pat. No. 5,111,310, U.S. Pat. No. 5,323,247, U.S. Pat. No. 5,341,228, U.S. Pat. No. 5,477,305, U.S. Pat. No. 5,543,941 specifications). In the blue noise mask producing method disclosed in the inventions, when the number of reproducible gray levels is 256, a blue noise pattern at the 128th gray level is generated first. Then, the system of generating dot patterns is divided into two parts, namely, a system of generating dot patterns at gray levels below the 128th level, and another system of generating dot patterns at gray levels above the 128th level. Then, dot patterns are sequentially generated, one by one, for gray levels in the respective systems. When the dot patterns of all gray levels are determined, all threshold values are determined, and the mask is complete. In this case, since a new dot cannot be placed at a point where a dot has been placed earlier for one of the previous levels, the farther from the central gray level, the smaller the freedom of selecting the position of a dot and, therefore, the harder to obtain a well formed blue noise pattern. FIGS. 69 and 70 show dot patterns for the first gray level within the total 256 levels of the ordered dithering method (FIG. 69) and of the blue noise mask method (FIG. 70) when an output image size is 256×256 pixels. The dot pattern of the first gray level of the clustered dot dithering method is the same as that of the dispersed dot dithering method. As compared with the dispersed dot dithering method, the blue noise mask method has apparently poor uniformity in the dot distribution at very low gray levels.

In the blue noise mask method, if the first blue noise pattern is not prepared at the central gray level but is prepared at a low gray level, for example, at the first gray level, then good blue noise patterns should be obtained at very low gray levels. In this case, however, the properties become poorer at higher gray levels, and the properties at the 255th gray level should be twice as bad as the properties of the same level compared to the case when the dot pattern is determined by starting at the central gray level (128th gray level) at which a good blue noise pattern is prepared. In this way, the reason for starting from the central gray level in producing dot patterns in this method is to take the balance of the properties at all gray levels into consideration. Thus, the fact that good blue noise patterns can not be obtained at very low gray levels is inherent in the blue noise mask method.

Furthermore, with higher printer resolution, the limit of the blue noise mask method, caused by the aforementioned problem, in principle, becomes clear. That is, to obtain good blue noise properties in this method, the mask must be enlarged with higher printer resolution. In addition, with higher printer resolution, 600 through 700 dpi and extending to 1200 dpi, the periodic pattern peculiar to the dispersed-dot dithering method becomes fine and difficult to perceive. Therefore, as compared with the dispersed dot dithering method, the poor uniformity of the dot distribution at low gray levels is distinct in the blue noise mask method, thus more clearly disclosing its inherent problem.

Thus, the conventional blue noise mask method has the demerit of poor uniformity of the dot distribution at low gray levels. Furthermore, with high printer resolution, the poor uniformity becomes more distinct, which can only be recovered with a large mask, thereby requiring a larger memory capacity.

### SUMMARY OF THE INVENTION

Accordingly, it is an object of the present invention to provide a threshold matrix (a mask), and a gray level reproducing method and apparatus using the threshold matrix to obtain a high quality image with good uniformity of dot distribution using a small mask, and thereby reducing the memory capacity requirement for storing the mask because no large mask is required with higher printer resolution.

According to one aspect of the present invention, the foregoing object is attained by providing a method of reproducing gray levels to represent density of each pixel of an output image by binary or multivalue data based on a one-to-one correspondence of each pixel of an input image to each element of a threshold matrix (a mask), comprising the steps of: providing non-blue noise properties for each respective gray level of a dot pattern generated in a pixel block of a standard size using the mask of a size corresponding to a size smaller or substantially smaller than the standard size of the pixel block; and generating, in the output image, no visually unpleasing artifacts, when the input image undergoes the gray level reproducing process and the produced image is output by an output device.

Another gray level reproducing method according to the present invention is a method of reproducing gray levels to represent density of each pixel of an output image by binary or multivalue data based on a one-to-one correspondence of each pixel of an input image to each element of a threshold matrix (a mask), comprising the steps of: providing non-blue noise properties for each respective gray level of a dot pattern generated by the single mask; and generating, in the output image, no visually unpleasing artifacts when the input image undergoes the gray level reproducing process and the produced image is output by an output device.

A further gray level reproducing method according to the present invention is a method of reproducing gray levels to represent density of each pixel of an output image by binary or multivalue data based on a one-to-one correspondence of each pixel of an input image to each element of a threshold matrix (a mask), comprising the steps of: providing a plurality of isolated spectra for a two-dimensional spatial frequency spectrum of an individual dot pattern generated by the single mask at each respective gray level; and generating, in the output image, no visually unpleasing artifacts when the input image undergoes the gray level reproducing process and the produced image is output by an output device.

Another gray level reproducing method according to the present invention is a method of representing the density of each pixel of an output image by binary or multivalue data based on a one-to-one correspondence of each pixel of an input image to each element of a threshold matrix (a mask), comprising the steps of: said mask having the size of an array of a plurality of element masks, each of which being of the same size as that of a mask used in the dispersed-dot dithering method; and a dot pattern generated by said mask: (1) having at least a set of element pixel blocks, each of which corresponding to each element mask and having the same dot distribution at each respective gray level; (2)having weak irregularity (perturbation) or pseudo-periodicity introduced at a certain gray level; (3) having an equal number of dots in every element pixel block at each respective gray level; and (4) having an equal number of dots in four individual partial element pixel blocks each having a quarter size of an element pixel block at each respective (4n)th (n indicates an integer) gray level.

A gray level reproducing apparatus according to the present invention is an apparatus for reproducing gray levels l to represent density of each pixel of an output image by binary or multivalue data based on a one-to-one correspondence of each pixel of an input image to each element of a threshold matrix (a mask), wherein: providing non-blue noise properties for each respective gray level of a dot pattern generated in a pixel block of a standard size using the mask of a size smaller or substantially smaller than the standard size of the pixel block; and generating, in the output image, no visually unpleasing artifacts, when the input image undergoes the gray level reproducing process and the image is output by an output device.

A further gray level reproducing apparatus according to the present invention is an apparatus for reproducing gray levels to represent density of each pixel of an output image by binary or multivalue data based on a one-to-one correspondence of each pixel of an input image to each element of a threshold matrix (a mask), wherein: providing non-blue noise properties for each respective gray level of a dot pattern generated by the single mask; and generating, in the output image, no visually unpleasing artifacts when an input image undergoes a gray level reproducing process and the produced image is output by an output device.

A further gray level reproducing apparatus according to the present invention is an apparatus for reproducing gray levels to represent density of each pixel of an output image by binary or multivalue data based on a one-to-one correspondence of each pixel of an input image to each element of a threshold matrix (a mask), wherein: providing a plurality of isolated spectra for a two-dimensional spatial frequency spectrum of a dot pattern generated by the single mask at each respective gray level; and generating, in an output image, no visually unpleasing artifacts when the input image has undergone a gray level reproducing process and outputted by an output device.

A further gray level reproducing apparatus according to the present invention is an apparatus for representing the density of each pixel of an output image by binary or multivalue data based on a one-to-one correspondence of each pixel of an input image to each element of a threshold matrix (a mask), wherein: composing said mask by an array of a plurality of element masks, each of which being of the same size as that of a mask used in the dispersed-dot dithering method; and generating, by said mask, a dot pattern: (1) having at least a set of element pixel blocks, each of which corresponding to each element mask and having the same dot distribution at each respective gray level; (2) having weak irregularity (perturbation) or pseudo-periodicity introduced at a certain gray level; (3) having an equal number of dots in every element pixel block at each respective gray level; and (4) having an equal number of dots in four individual partial element pixel blocks each having a quarter size of an element pixel block at each respective (4n)th (n indicates an integer) gray level.

A further gray level reproducing apparatus according to the present invention is an apparatus for reproducing gray levels to represent density of each pixel of an output image by binary or multivalue data based on a one-to-one correspondence of each pixel of an input image to each element of a threshold matrix (a mask), comprising: storage means for storing the threshold matrix; comparison means for comparing each value of the threshold matrix with density of each pixel of the input image; and output means for outputting a binary or multivalue dot pattern based on comparison results of said comparison means, wherein: said threshold matrix has a size corresponding to a size smaller or substantially smaller than a standard size pixel block, a dot pattern generated in the standard size pixel block has non-blue noise properties at each respective gray level, and visually unpleasing artifacts are not generated in the output image when the input image undergoes the gray level reproducing process and the produced image is output by-an output device.

A further gray level reproducing apparatus according to the present invention is an apparatus for reproducing gray levels to represent density of each pixel of an output image by binary or multivalue data based on a one-to-one correspondence of each pixel of an input image to each element of a threshold matrix (a mask), comprising: storage means for storing the threshold matrix; comparison means for comparing each value of the threshold matrix with density of each pixel of the input image; and output means for outputting a binary or multivalue dot pattern based on comparison results of said comparison means, wherein: said threshold matrix produces, by itself, the dot pattern having non-blue noise properties at each respective gray level, and generates, in the output image, no visually unpleasing artifacts when the input image undergoes the gray level reproducing process and the produced image is output by an output device.

A further gray level reproducing apparatus according to the present invention is an apparatus for reproducing gray levels to represent density of each pixel of an output image by binary or multivalue data based on a one-to-one correspondence of each pixel of an input image to each element of a threshold matrix (a mask), comprising: storage means for storing the threshold matrix; comparison means for comparing each value of the threshold matrix with density of each pixel of the input image; and output means for outputting a binary or multivalue dot pattern based on comparison results of said comparison means, wherein: said threshold matrix produces, by itself, a dot pattern having a plurality of isolated spectra in a two-dimensional spatial frequency spectrum at each respective gray level and assigns a noise component having small low frequency components to a one-dimensional power spectrum of a dot distribution at a plurality of gray levels.

A further gray level reproducing apparatus according to the present invention is an apparatus for reproducing gray levels to represent density of each pixel of an output image by binary or multivalue data based on a one-to-one correspondence of each pixel of an input image to each element of a threshold matrix (a mask), comprising: storage means for storing the threshold matrix; comparison means for comparing each value of the threshold matrix with density of each pixel of the input image; and output means for outputting a binary or multivalue dot pattern based on comparison results of said comparison means, wherein: said mask has the size of an array of a plurality of element masks, each of which being of the same size as that of a mask used in the dispersed-dot dithering method, and generates a dot pattern: (1) having at least a set of element pixel blocks, each of which corresponding to each element mask and having the same dot distribution at each respective gray level; (2)having weak irregularity (perturbation) or pseudo-periodicity introduced at a certain gray level; (3) having an equal number of dots in every element pixel block at each respective gray level; and (4) having an equal number of dots in four individual partial element pixel blocks each having a quarter size of an element pixel block at each respective (4n)th (n indicates an integer) gray level.

A threshold matrix according to the present invention is a threshold matrix (a mask) for use in converting density of each pixel of an input image into binary or multivalue data, wherein said threshold matrix has a size corresponding to a size smaller or substantially smaller than a standard size of a pixel block, a dot pattern generated by said threshold matrix in the standard size pixel block has non-blue noise properties at each respective gray level, and visually unpleasing artifacts are not generated in an output image when the input image undergoes the gray level reproducing process and the produced image is output by an output device.

A further threshold matrix according to the present invention is a threshold matrix (a mask) for use in converting density of each pixel of an input image into binary or multivalue data, wherein said threshold matrix produces, by itself, a dot pattern having non-blue noise properties at each respective gray level, and generates in an output image no visually unpleasing artifacts when the input image undergoes the gray level reproducing process and the produced image is output by an output device.

A further threshold matrix according to the present invention is a threshold matrix (a mask) for use in converting density of each pixel of an input image into binary or multivalue data, wherein said threshold matrix produces, by itself, a dot pattern having a plurality of isolated spectra in a two-dimensional spatial frequency spectrum at each respective gray level and assigns a noise component having small low frequency components to a one-dimensional power spectrum of the dot distribution at a plurality of gray levels.

A further threshold matrix according to the present invention is a threshold matrix (a mask) for use in converting density of each pixel of an input image into binary or multivalue data, wherein said mask having the size of an array of a plurality of element masks, each of which being of the same size as that of a mask used in the dispersed-dot dithering method, and a generated dot pattern has: (1) at least a set of element pixel blocks, each of which corresponding to each element mask and having the same dot distribution at each respective gray level; (2) weak irregularity (perturbation) or pseudo-periodicity introduced at a certain gray level; (3) an equal number of dots in every element pixel block at each respective gray level; and (4) an equal number of dots in four individual partial element pixel blocks each having a quarter size of an element pixel block at each respective (4n)th (n indicates an integer) gray level.

A computer-readable storage medium according to the present invention is a computer-readable storage medium storing a control program for controlling a gray level reproducing process to represent density of each pixel of an output image by binary or multivalue data based on a one-to-one correspondence of each pixel of an input image to each element of a threshold matrix (a mask), comprising: a threshold matrix having a size corresponding to a size smaller or substantially smaller than a standard size of a pixel block, a dot pattern generated, by the threshold matrix, in a pixel block of the standard size having non-blue noise properties at each respective gray level, wherein visually unpleasing artifacts are not generated in the output image when the input image undergoes the gray level reproducing process and the produced image is output by an output device; and a module for comparing each value of the threshold matrix with density of each pixel of the input image, and for controlling an output of each binary or multivalue dot pattern depending on the comparison results.

A further computer-readable storage medium according to the present invention is a computer-readable storage medium storing a control program for controlling a gray level reproducing process to represent density of each pixel of an output image by binary or multivalue data based on a one-to-one correspondence of each pixel of an input image to each element of a threshold matrix (a mask), comprising: a threshold matrix for producing, by itself, a dot pattern having non-blue noise properties at each respective gray level, wherein visually unpleasing artifacts are not generated when the input image undergoes the gray level reproducing process and the produced image is outputted by an output device; and a module for comparing each value of the threshold matrix with density of each pixel of the input image, and for controlling an output of each binary or multivalue dot pattern depending on the comparison results.

A further computer-readable storage medium according to the present invention is a computer-readable storage medium storing a control program for controlling a gray level reproducing process to represent density of each pixel of an output image by binary or multivalue data based on a one-to-one correspondence of each pixel of an input image to each element of a threshold matrix (a mask), comprising: the threshold matrix producing, by itself, a dot pattern having a plurality of isolated spectra in a two-dimensional spatial frequency spectrum at each respective gray level and assigning a noise component having small low frequency components to a one-dimensional power spectrum of a dot distribution at each of a plurality of gray levels; and a module for comparing each value of the threshold matrix with density of each pixel of the input image, and for controlling an output of each binary or multivalue dot pattern depending on the comparison results.

A further computer-readable storage medium according to the present invention is a computer-readable storage medium storing a control program for controlling a gray level reproducing process to reproduce density of each pixel of an output image by binary or multivalue data based on a one-to-one correspondence of each pixel of an input image to each element of a threshold matrix (a mask), comprising: the threshold matrix having the size of an array of a plurality of element masks, each of which being of the same size as that of a mask used in the dispersed-dot dithering method, wherein a generated dot pattern has: (1) at least a set of element pixel blocks each of which corresponding to each element mask and having the same dot distribution at each respective gray level; (2) weak irregularity (perturbation) or pseudo-periodicity introduced at a certain gray level; (3) an equal number of dots in every element pixel block at each respective gray level; and (4) an equal number of dots in four individual partial element pixel blocks each having a quarter size of each element pixel block at each respective (4n)th (n indicates an integer) gray level; and a module for comparing each value of the threshold matrix with density of each pixel of the input image, and for controlling an output of each binary or multivalue dot pattern depending on the comparison results.

A gray level reproducing apparatus according to the present invention is a gray level reproducing apparatus for associating each pixel of an input image with each element of a threshold matrix (a mask) based on a one-to-one correspondence to reproduce the density of each pixel of an output image using binary or multivalue data, wherein: a dot pattern generated by the threshold matrix has an anisotropy spectrum having an average value of 3 dB or more and a maximum value of 10 dB or more at each respective gray level, and visually unpleasing artifacts are not generated in the output image when the input image undergoes the gray level reproducing process and the produced image is output by an output device.

According to the present invention, high quality images each with a uniform dot distribution can be obtained using a small or substantially small mask. A large mask is not necessary even with high printer resolution, thereby reducing the memory capacity for storing the mask.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 shows a scheme to which a mask method being concerned in the embodiments conforms.

FIG. 2 is a drawing for describing regular properties (2) and (3) according to the embodiments.

FIG. 3 is a drawing for describing regularity (4) according to the embodiments, wherein the unit denoted as bits should also be read as pixels in this and subsequent Figs.

FIG. 4 is a drawing for describing regular properties (1) and (4) according to the embodiments.

FIG. 5 is a flowchart of a flow of steps up to obtaining a dither matrix according to the embodiments.

FIG. 6 is a drawing for describing a method for introducing perturbation to a dot pattern for the second gray level.

FIG. 7 schematically shows the shape of a repulsive potential.

FIG. 8 shows graphs of repulsive potentials used in the embodiments.

FIG. 9 is a drawing for describing a method for forming dot patterns for the third and subsequent gray levels.

FIG. 10 shows a method for providing a pseudo periodic pattern for the first gray level by changing step S3 in the flowchart in FIG. 5.

FIG. 11 shows an example of steps for the second and subsequent gray levels when step S3 in FIG. 5 is changed.

FIG. 12 shows another example of steps for the second and subsequent gray levels when step S3 in FIG. 5 is changed.

FIG. 13 shows an example of a composition of a basic system for processing an image according to the embodiments.

FIG. 14 shows the shape and size of a unit pixel block corresponding to a unit mask and a set of element pixel blocks having the same dot distribution at each respective gray level according to a first embodiment.

FIG. 15 shows how the unit pixel blocks according to the first embodiment are two-dimensionally arranged on an output image plane.

FIG. 16 is a drawing for describing steps S3 and S4 in the flowchart in FIG. 5 according to the first embodiment.

FIG. 17 shows a dot pattern magnified 10 times larger than an actual printout of a dot pattern for the eighth gray level generated in an image plane of 256×256 pixels according to the first embodiment.

FIG. 18 shows a dot pattern magnified 10 times larger than an actual printout of a dot pattern for the 32nd gray level generated in an image plane of 256×256 pixels according to the first embodiment.

FIG. 19 shows the one-dimensional power spectrum of a dot pattern for the 32nd gray level generated using a single unit mask according to the first embodiment.

FIG. 20 shows the anisotropy spectrum of the dot pattern for the 32nd gray level generated using the single unit mask according to the first embodiment.

FIG. 21 shows the one-dimensional power spectrum of the dot pattern for the 32nd gray level generated in the image plane of 256×256 pixels repeatedly using the unit mask according to the first embodiment.

FIG. 22 shows the anisotropy spectrum of the dot pattern for the 32 gray level generated in the image plane of 256×256 pixels repeatedly using the unit mask according to the first embodiment.

FIG. 23 shows the shape and size of a unit pixel block corresponding to a unit mask and two sets of element pixel blocks having the same dot distribution at each respective gray level according to the second embodiment.

FIG. 24 shows how the unit pixel blocks according to the second embodiment are two-dimensionally arranged on an output image plane.

FIG. 25 is a drawing for describing steps S3 and S4 in the flowchart in FIG. 5 according to the second embodiment.

FIG. 26 shows a dot pattern magnified 10 times larger than an actual printout of a dot pattern for the eighth gray level generated in an image plane of 256×256 pixels according to the second embodiment.

FIG. 27 shows a dot pattern magnified 10 times larger than an actual printout of a dot pattern for the 32nd gray level generated in an image plane of 256×256 pixels according to the second embodiment.

FIG. 28 shows the one-dimensional power spectrum of a dot pattern for the 32nd gray level generated using a single unit mask according to the second embodiment.

FIG. 29 shows the anisotropy spectrum of the dot pattern for the 32nd gray level generated using the single unit mask according to the second embodiment.

FIG. 30 shows the one-dimensional power spectrum of the dot pattern for the 32nd gray level generated in the image plane of 256×256 pixels repeatedly using the unit mask according to the second embodiment.

FIG. 31 shows the anisotropy spectrum of the dot pattern for the 32nd gray level generated in the image plane of 256×256 pixels repeatedly using the unit mask according to the second embodiment.

FIG. 32 shows the shape and size of a unit pixel block corresponding to a unit mask and two sets of element pixel blocks having the same dot distribution at each respective gray level according to the third embodiment.

FIG. 33 shows how the unit pixel blocks according to the third embodiment are two-dimensionally arranged on an output image plane.

FIG. 34 is a drawing for describing steps S3 and S4 in the flowchart in FIG. 5 according to the third embodiment.

FIG. 35 shows a Gaussian weight applied to a small pixel block in which one pixel is probabilistically determined to put a dot for the second gray level according to the third embodiment.

FIG. 36 is a drawing for describing steps S3 and S4 in the flowchart in FIG. 5 according to the third embodiment.

FIG. 37 shows a dot pattern magnified 10 times larger than an actual dot pattern for the eighth gray level generated in an image plane of 256×256 pixels according to the third embodiment.

FIG. 38 shows a dot pattern magnified 10 times larger than an actual dot pattern for the 32nd gray level generated in an image plane of 256×256 pixels according to the third embodiment.

FIG. 39 shows the one-dimensional power spectrum of a dot pattern for the 32nd gray level generated using a single unit mask according to the third embodiment.

FIG. 40 shows the anisotropy spectrum of the dot pattern for the 32nd gray level generated using the single unit mask according to the third embodiment.

FIG. 41 shows the one-dimensional power spectrum of the dot pattern for the 32nd gray level generated in the image plane of 256×256 pixels repeatedly using the unit mask according to the third embodiment.

FIG. 42 shows the anisotropy spectrum of the dot pattern for the 32nd gray level generated in the image plane of 256×256 pixels repeatedly using the unit mask according to the third embodiment.

FIG. 43 shows the shape and size of a unit pixel block corresponding to an initially assumed unit mask and two sets of element pixel blocks having the same dot distribution at each respective gray level according to the fourth embodiment.

FIG. 44 shows the shape and size of a unit pixel block corresponding to an actually produced-unit mask and sets of element pixel blocks having the same dot distribution at each respective gray level according to the fourth embodiment.

FIG. 45 shows how the unit pixel blocks according to the fourth embodiment are two-dimensionally arranged on an output image plane.

FIG. 46 is a drawing for describing steps S3 and S4 in the flowchart in FIG. 5 according to the fourth embodiment.

FIG. 47 shows a dot pattern magnified 10 times larger than an actual printout of a dot pattern for the eighth gray level generated in an image plane of 256×256 pixels according to the fourth embodiment.

FIG. 48 shows a dot pattern magnified 10 times larger than an actual printout of a dot pattern for the 32nd gray level generated in an image plane of 256×256 pixels according to the fourth embodiment.

FIG. 49 shows the one-dimensional power spectrum of a dot pattern for the 32nd gray level generated using a single unit mask according to the fourth embodiment.

FIG. 50 shows the anisotropy spectrum of the dot pattern for the 32nd gray level generated using the single unit mask according to the fourth embodiment.

FIG. 51 shows the anisotropy spectrum obtained by subtracting the anisotropy spectrum of a dot pattern obtained using a blue noise mask and cut out in the same unit pixel block shape as that shown in FIG. 44 from the anisotropy spectrum of the dot pattern for the 32nd gray level generated using the single unit mask according to the fourth embodiment, in order to eliminate the effects of the shape anisotropy of the unit mask according to this embodiment.

FIG. 52 shows the one-dimensional power spectrum of the dot pattern for the 32nd gray level generated in the image plane of 256×256 pixels repeatedly using the unit mask according to the fourth embodiment.

FIG. 53 shows the anisotropy spectrum of the dot pattern for the 32nd gray level generated in the image plane of 256×256 pixels repeatedly using the unit mask according to the fourth embodiment.

FIG. 54 shows the shape and size of a unit pixel block corresponding to an initially assumed unit mask and sets of element pixel blocks having the same dot distribution at each respective gray level according to the fifth embodiment.

FIG. 55 shows the shape and size of a unit pixel block corresponding to an actually produced unit mask and sets of element pixel blocks having the same dot distribution at each respective gray level according to the fifth embodiment.

FIG. 56 shows how the unit pixel blocks according to the fifth embodiment are two-dimensionally arranged on an output image plane.

FIG. 57 is a drawing for describing steps S3 and S4 in the flowchart in FIG. 5 according to the fifth embodiment.

FIG. 58 is a drawing for describing a rule for selecting one pixel from a small pixel block where a dot is put for the second gray level according to the fifth embodiment.

FIG. 59 shows a dot pattern magnified 10 times larger than an actual print out of a dot pattern for the eighth gray level generated in an image plane of 256×256 pixels according to the fifth embodiment.

FIG. 60 shows a dot pattern magnified 10 times larger than an actual print out of a dot pattern for the 32nd gray level generated in an image plane of 256×256 pixels according to the fifth embodiment.

FIG. 61 shows the one-dimensional power spectrum of a dot pattern for the 32nd gray level generated using a single unit mask according to the fifth embodiment.

FIG. 62 shows the anisotropy spectrum of the dot pattern for the 32nd gray level generated using the single unit mask according to the fifth embodiment.

FIG. 63 shows the anisotropy spectrum obtained by subtracting the anisotropy spectrum of a dot pattern obtained using a blue noise mask and cut out in the same unit pixel block shape as that shown in FIG. 55 from the anisotropy spectrum of the dot pattern for the 32nd gray level generated using the single unit mask according to the fifth embodiment in order to eliminate the effects of the shape anisotropy of the unit mask according to this embodiment.

FIG. 64 shows the one-dimensional power spectrum of the dot pattern for the 32nd gray level generated in the image plane of 256×256 pixels repeatedly using the unit mask according to the fifth embodiment.

FIG. 65 shows the anisotropy spectrum of the dot pattern for the 32nd gray level generated in the image plane of 256×256 pixels repeatedly using the unit mask according to the fifth embodiment.

FIG. 66 shows a part of a gray scale output using the mask according to the second embodiment and a 600-dpi printer.

FIG. 67 shows a part of a gray scale output using the mask according to the fourth embodiment and a 600-dpi printer.

FIG. 68 shows the scheme to which the dithering method having the blue noise properties conforms.

FIG. 69 shows a dot pattern for the first gray level according to the ordered dithering method.

FIG. 70 shows a dot pattern for the first gray level according to the blue noise mask method.

FIG. 71 shows a part of a gray scale output using a blue noise mask of 256×256 elements and a 600-dpi printer.

FIG. 72 shows a part of a gray scale output using a blue noise mask of 128×128 elements and a 600-dpi printer.

FIG. 73 shows a part of a gray scale output using a blue noise mask of 64×64 elements and a 600-dpi printer.

FIG. 74 shows the one-dimensional power spectrum of a dot pattern for the 32nd gray level generated using the single blue noise mask of 128×128 elements.

FIG. 75 shows the anisotropy spectrum of the dot pattern for the 32nd gray level generated using the single blue noise mask of 128×128 elements.

FIG. 76 shows the one-dimensional power spectrum of a dot pattern for the 32nd gray level generated in an image plane of 256×256 pixels repeatedly using the blue noise mask of 128×128 elements.

FIG. 77 shows the anisotropy spectrum of the dot pattern for the 32nd gray level generated in the image plane of 256×256 pixels repeatedly using the blue noise mask of 128×128 elements.

FIG. 78 shows the one-dimensional power spectrum of a dot pattern for the 32nd gray level generated using the single blue noise mask of 64×64 elements.

FIG. 79 shows the anisotropy spectrum of the dot pattern for the 32nd gray level generated using the single blue noise mask of 64×64 elements.

FIG. 80 shows the one-dimensional power spectrum of a dot pattern for the 32nd gray level generated in an image plane of 256×256 pixels repeatedly using the blue noise mask of 64×64 elements.

FIG. 81 shows the anisotropy spectrum of the dot pattern for the 32nd gray level generated in the image plane of 256×256 pixels repeatedly using the blue noise mask of 64×64 elements.

FIG. 82 is a drawing for describing a known technique using random quasi-periodic patterns for a halftone reproduction screen.

FIG. 83 is a drawing for describing another known technique using the clustered-dot dithering method with a cross-shaped threshold matrix.

FIG. 84 is a drawing for describing the known technique using the clustered-dot dithering method with the cross-shaped threshold matrix wherein a weak irregularity (perturbation) has been introduced into a dot distribution for the first gray level.

FIG. 85 shows a schematic diagram generally illustrating a system which can execute the scheme to which the present invention being concerned in 1st through 5th embodiments conforms.

FIG. 86 shows a block diagram illustrating the general construction of the image processing apparatus shown in FIG. 85.

FIG. 87 shows an external view of an image input/output device.

FIG. 88 shows a block diagram illustrating the construction of the scanner image processor 2080 shown in FIG. 86.

FIG. 89 shows a block diagram illustrating the construction of the printer image processor 2090 shown in FIG. 86.

### DETAILED DESCRIPTION OF THE PREFERRED EMBODIMENTS

Preferred embodiments of the present invention will now be described in detail in accordance with the accompanying drawings.

Described below are the embodiments of the present invention.

The present invention can be applied to render halftone in an apparatus such as a conventional type ink-jet printer, a bubble-jet (BJ) printer, etc. for generating an image by determining, in the simplest case, whether or not a dot of ink is to be placed for each pixel of an output image. Similarly, it can be applied to halftone rendering in a liquid crystal device etc. for displaying an image by bi-level pixels, each of which is bright or dark.

More generally, the present invention can be applied to desirable halftone rendering in an apparatus such as a laser beam printer, facsimile, a printing machine, etc. including an ink-jet printer etc., each of which converts a monochrome or color image having continuous change of gradation into a binary or multivalue density output image.

Furthermore, the present invention is more effectively applied to an output device such as a printer etc. having high resolution from about 600 dpi through 1200 dpi.

To more easily understand the embodiments of the present invention, the problems in the conventional blue noise mask method are described in detail, and then the important points of the embodiments are explained furthermore in detail.

Described below is the concrete reason why the above-mentioned large blue noise mask is required.

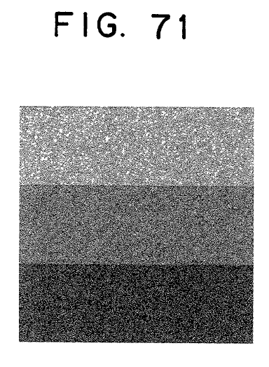

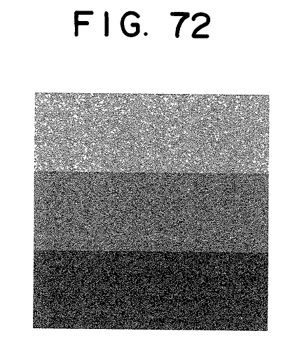

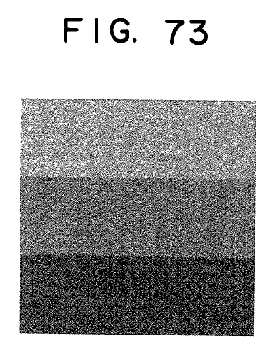

Experiments were carried out to study quality of images produced by the above blue noise mask method under the condition that the number of gray levels reproducible in output images should be 256, using, mainly, an ink-jet printer with 600 dpi which is commercially available. In accordance with the prior art methods for preparing blue noise masks (U.S. Pat. No. 5,111,310 and others; T. Mitsa and K. J. Parker, J. Opt. Soc. Am., A, Vol. 9, pp. 1920-1929, (1992); M. Yao and K. J. Parker, J. Electronic Imaging, Vol. 3, pp. 92-97, (1994)), three masks with different sizes were made, i.e., 256×256 elements (10.8 mm square on an output-image plane), 128×128 elements (5.4 mm square), and 64×64 elements (2.7 mm square). First, we visually evaluated the quality of output images produced by using the above blue noise masks. The input image used was a gray scale consisting of a number of 18.5 mm square images, each of which had a constant gray level, and their gray levels change step by step like a staircase up to the 255 gray level. Portions of the output images of the above gray scale are shown in order of the mask sizes in FIG. 71 (256×256), FIG. 72 (128×128), and FIG. 73 (64×64). Each figure illustrates 30th, 31st, and 32nd gray levels from left to right in the upper line, 40th, 41st, and 42nd gray levels in the middle line, and 50th, 51st, and 52nd gray levels in the bottom line.

Although about 2×2=4 pieces of a 10.8 mm square blue noise mask pattern produced by the above 256×256 blue noise mask should be included in each square image, no periodic pattern was perceived whereas some irregular distributions of density were observed in FIG. 71. Results of evaluation for gray level images, other than those shown in this figure, were similar to the above result.

However, in the case of the above blue noise mask with the size of 128×128, a two-dimensional periodic pattern consisting of about 3×3=9 pieces of mask patterns, each of which is produced by a single mask, appears at many gray-level square images shown in FIG. 72. The appearance of these periodic patterns in the output images are not suitable for practical use.

In the case of the above blue noise mask with the size of 64×64 elements, the situation gets worse as shown in FIG. 73, where a two-dimensional lattice pattern with 2.7 mm periods can be clearly observed in almost all gray level range. The above situations indicate that, when the mask size decreases, since the gradient of spatial variation of a dot distribution to that size increases, irregularity of a mask pattern is relatively emphasized, resulting in an output image in which the same irregular mask patterns are two-dimensionally laid down periodically. Further, since the individual period becomes a few mm, a distance sensitive for the eye, artifacts of a two-dimensional lattice pattern can be clearly perceived in the output image.

According to the above results, it is concluded that a blue noise mask with 256×256 elements provides a size suitable for an ink-jet printer with 600 dpi.

For printers with low resolution from 300 through 500 dpi, that is, for example, with 300 dpi, a distinct artifact is obtained in a regular pattern specific to a mask in the dispersed-dot dithering method, whereas an artifact as shown in FIG. 72 is less perceivable with the 128×128 blue noise mask. However, when the resolution of the printer is as high as 600 dpi, the size of a dot pattern generated by a single mask becomes smaller, and a periodic artifact in the dispersed-dot dithering method becomes less perceivable while an artifact in the blue noise mask method is more perceivable as shown in FIG. 72. Namely, it is understood from the aspect of visual perception characteristic that, to obtain an acceptable dot pattern in the blue noise mask method, a larger mask is required with a higher resolution printer.

Next, a quantitative investigation is performed, in the frequency domain, to ascertain whether or not dot patterns produced by using aforementioned blue noise masks of different sizes have the blue noise properties. For this purpose, the output image size is fixed to the size of a mask pattern of a 256×256 blue noise mask. This size is the same as the image plane size used when Ulichney (p. 54) investigated the one-dimensional frequency characteristic Pᵣ (fᵣ) (indicating the power spectrum averaged within individual annular domains with each radius fᵣ in the two-dimensional spatial frequency domain with the radial direction fᵣ as an abscissa) and the anisotropy (Ulichney, p. 56).

Ulichney defines the anisotropy in the error diffusion method as follows.

$$Anisotropy = \frac{{s}^{2} ( {f}_{r} )}{{P}_{r}^{2} ( {f}_{r} )} \qquad ( 1 )$$

Here, s² (fᵣ) denotes the variance of the one-dimensional power spectrum Pᵣ(fᵣ) and Pᵣ²(fᵣ) is the square of the power spectrum. In the case of error diffusion method, however, since a dot pattern in an output image with a certain gray level differs each time when the location of the dot pattern differs, the power spectrum for the gray level is defined as an average of 10 different samples of power spectra calculated for each dot pattern in an image plane of 256×256 pixels under the supposition that individual power spectra are independent of one another. Then, the value of anisotropy equals −10 dB for the case of being completely isotropic.

It should be noted that if a dot pattern is isotropic, it is a periodic but that the converse is not always true. Conversely speaking, if a dot pattern is periodic, it is always anisotropic. As shown before, it should be noted that a dot pattern must be a periodic and uncorrelated rather than isotropic so as to be a blue noise pattern defined by Ulichney, therefore, a visually pleasing pattern.

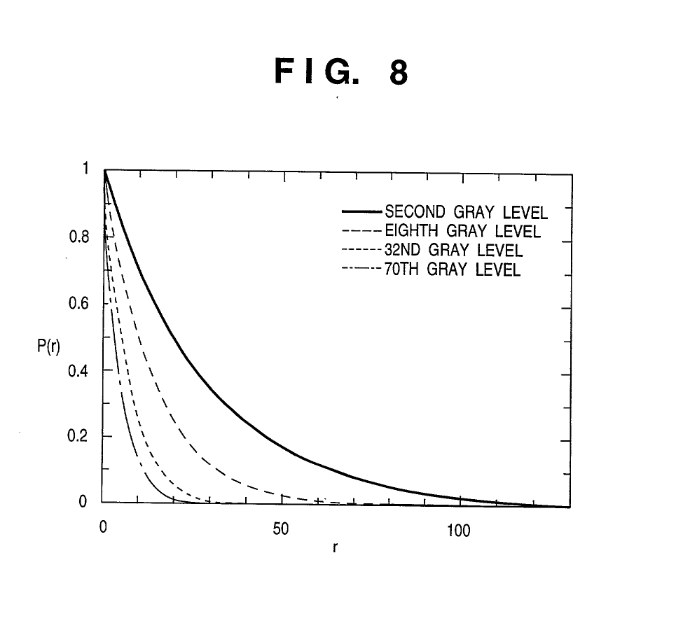

As described by Ulichney (§8.2), in the error diffusion method introduced by Floyd and Steinberg (SID Int. Sym. Digest of Tech. Papers, 36-37(1975), Proc. SID, Vol. 17/2, pp, 75-77 (1976)), although images at several gray levels are represented as pleasingly isotropic, structureless dot patterns, correlated artifacts in many of the gray level patterns and artifacts of directional hysteresis in very light and very dark regions of images, etc. are observed. According to graphs illustrating anisotropy spectra of the above method (Ulichney, FIG. 8.8), the measure of anisotropy averaged across all available frequency range at seven gray levels being able to refer shows −6 dB or more, when the maximum of gray level number g is normalized to 1.

In addition, the maximum anisotropy value is greater than 0 dB at six gray levels and −2 dB at g=⅞. In frequency regions near the lowest and highest frequencies, the number of dots being small causes the anisotropy values to fluctuate intensively, so that these regions must be excluded.

If the anisotropy spectrum of a dot pattern indicates any value greater than 0 dB at any frequency, the pattern is designated as being especially anisotropic (Ulichney, cited above, p. 242). Actually, correlated artifacts are always observed at six levels at which the average anisotropy values are −6 dB or more and the maximum anisotropy values are greater than 0 dB. At g=⅞, however, although the maximum value does not reach 0 dB, the average value is high indicating −5.5 dB and weak artifacts appear.

Further, in the error diffusion method by Jarvis et al.(Computer Graphics and Image Processing, Vol. 5, pp. 13-40 (1976)), in which some of the artifacts seen in the error diffusion method of Floyd and Steinberg are reduced, directional hysteresis in the very dark and light regions has increased, and pixels are clustered together more in the middle gray region (Ulichney, §8.2.1, p. 253). However, the anisotropy in this error diffusion method becomes, as a whole, weaker than that in the error diffusion method by Floyd and Steinberg. Incidentally, in the error diffusion method by Jarvis et al., the average anisotropy at all five gray levels (Ulichney, FIG. 8.11) is within the range from just over −7 dB to the extent of −4 dB, and their average amounts to near −6 dB. In three gray levels at which average anisotropy values are just over −7 dB or greater and the maximum anisotropy values are just over 0 dB or greater, artifacts are always observed. Accordingly, it follows that, through both error diffusion methods, artifacts always appear in a dot pattern having an anisotropy spectrum exhibiting an average anisotropy value of just over −7 dB or greater and a maximum anisotropy value of 0 dB or greater.

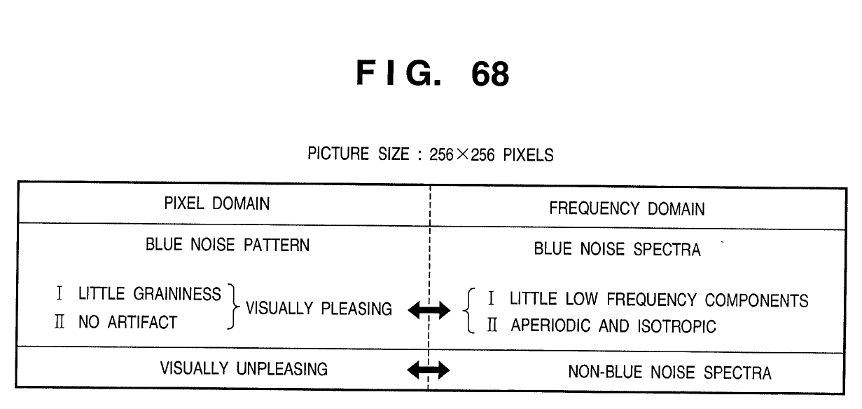

Based on the above description, a dot pattern obtained by an error diffusion method and having a maximum anisotropy value of 0 dB or greater and an average anisotropy value of just over −7 dB or greater cannot be asserted to have the blue noise properties but it must be concluded to have the non-blue noise properties. This is because, as shown in FIG. 68, based on Ulichney (cited above), a dot pattern having the blue noise properties does not generate artifacts such as those described above. Accordingly, such a dot pattern can always be determined to have the non-blue noise properties based only on the maximum and average anisotropy values regardless of the power spectrum.

Furthermore, referring to the case of gray level g=⅛ in Jarvis et al.'s error diffusion method, it may be determined that the limit of the blue noise properties is the property of a dot pattern having an average value of −7 dB or so on the premise that it has small low-frequency components. Incidentally, the maximum anisotropy value at this gray level is considerably high, −2.5 dB.

The reason why g=⅛, where the dot pattern which is visually pleasing, is adopted as the limit for the blue noise properties will be explained below. The shape of the power spectrum at g=⅛ is very close to the shape of the ideal power spectrum of the blue noise shown by Ulichney (Ulichney, cited above, p. 238, FIG. 8.3). Compared to the above Ulichney's figure, however, the power spectrum, at g=⅛, has a very high peak at the position of the principal frequency f_{g}, at which anisotropy also has the maximum value. In addition, the average anisotropy value is −7 dB indicating comparatively high anisotropy and this value is very close to the lower limit of the average anisotropy value just over −7 dB of the non-blue noise properties shown by this error diffusion method. If these values concerning anisotropy become larger, visual properties of a dot pattern abruptly get worse, clearly making it exhibit the non-blue noise properties. On the contrary, however, if the average anisotropy value becomes −7 dB or less and approaches −10 dB (isotropic), the visual property has a tendency to getting worse as described later. That is, this gray level based on Jarvis et al.'s error diffusion method is very likely to be optimized at the highest level of anisotropy resulting from the aspect of visual perception characteristic.

In the case of the dispersed dot dithering method, even if the maximum anisotropy value increases further, above the level exhibiting the non-blue noise properties, a dot pattern at g=⅛ (the 32nd gray level when the total number of gray levels is 256), for example, is visually very pleasing, as soon when producing the dot pattern using a 600-dpi printer. Even so, however, this dot pattern does not have the blue noise properties.

Spectral characteristics of the perturbed error diffusion method with a stochastic error filter with one weight, which is shown by Ulichney (p.272 and FIG. 8.15) as an example of generating blue noise, are described as fulfilling the following conditions at every gray level shown in the above FIG. 8.15 (6 levels of g=1/32, 1/16, ⅛, ¼, ½, and 3/4), when the maximum of gray level number g is normalized to 1;

(1) very low anisotropy,

(2) flat blue noise region, and

(3) cutoff at fg.

Here, (1) is a characteristic concerning an anisotropy spectrum and (2) and (3) are properties relating to a power spectrum. Accordingly, whether or not a dot pattern has the blue noise properties cannot be evaluated from only one of the spectra, that is, either the anisotropy or power spectrum.

As described above, however, whether or not a dot pattern has the non-blue noise properties can be determined from only the maximum and average anisotropy values. In light of the above definition of the blue noise, the level of anisotropy designated “especially anisotropic” evidently contradicts property (1). In any case, it is clear that, the blue noise properties are defined only by the above spectrum properties (1) to (3) regardless of the resolution of printers and the number of gray level g of the dot pattern.

If the above three conditions are met at all gray levels, the dot patterns can be asserted to have the blue noise properties. Strictly speaking, however, even the perturbed error diffusion method, disclosed by Ulichney, does not meet condition (3) at g=½ and shows a considerable amount of low-frequency components. Consequently, the dot pattern is prominent in graininess. According to Ulichney, however, such a deviation from condition (3) falls within the allowable range of the blue noise properties, as compared with white noise. Thus, on the basis of the blue noise properties defined by Ulichney, the perturbed error diffusion method is characterized as having no apprehension for generating moiré because it strictly restrain periodic and/or correlated artifacts at every gray level, but is also characterized to be weak in restraining graininess.

In the above perturbed error diffusion method, the anisotropy values at three of the six gray levels, that is, g =⅛, ¼, and ⅞, are within a range of −10±2.5 dB in almost all frequency bands, and having an average value of −10 dB, being able to assert to be isotropic. At the remaining three gray levels, however, the average value is larger than −10 dB with regard to a certain frequency band, thus definitely exhibiting some anisotropy. At a gray level with higher anisotropy, the maximum value is about −4 dB and the average value is about −7 dB. Such anisotropy, however, exists in a frequency band lower than the principal frequency f_{g}, and the power spectrum shows no specific frequency peak. Thus, no artifact is perceived.

As described above, the limit for the blue noise properties has been set at gray level g=⅛ in the Jarvis et al.'s error diffusion method. According to the perturbed error diffusion method, when the number of gray level g=⅛ and the average anisotropy value is almost −10 dB, it exhibits good isotropy. However, the power spectrum shows a lot of low-frequency components and the dot pattern gets considerably worse in graininess as compared with that at g=⅛ in the Jarvis et al.'s error diffusion method.

The mask method can always, repeatedly, provide the same dot pattern at the same gray level, thereby making operations of taking 10 samples and averaging unnecessary to obtain power and anisotropy spectra of dot patterns. Accordingly, concerning each of the maximum and average anisotropy values, it is necessary to examine the correspondence between the respective values in the error diffusion method and those in the mask method. Thus, the Floyd and Steinberg's error diffusion method and the Jarvis et al.'s error diffusion method were examined with respect to the correspondence between these respective values of unified 10 samples and these values for each of the 10 samples in the individual method. Even in the error diffusion method, actually viewed dot patterns are individual samples, so the anisotropy and power spectra for each sample have more direct correspondence with visual properties.

First, when an anisotropy spectrum shown in the error diffusion method has a peak value of about 5 dB or less, the difference between an average anisotropy value of each sample and the base value of 0 dB, representing a completely isotropic property, is a little smaller than half of the difference between an average anisotropy value of the unified 10 samples and the base value of −10 dB. This means that, when the error diffusion method and the mask method are compared with each other in anisotropy, if the mask method exhibits a value half of that in the error diffusion method in terms of the difference between an average value and the base value, these two methods can be determined to have almost equal anisotropy, and more precisely speaking, the mask method can be determined to have a little higher anisotropy.

Next, individual maximum values of 10 samples were examined in a case when the maximum value determined in the error diffusion method using these samples is slightly greater than 0 dB (slightly greater than +10 dB higher than the base value of −10 dB), indicating the individual samples to be especially anisotropic. Only the results are presented below. Although each value of the 10 individual samples varies, the values fell within the range of 5 dB±1 dB=4 dB to 6 dB. In addition, since the average value in the case when artifacts always appear in the error diffusion method was just over −7 dB, which is just over 3 dB above the base value of −10 dB, on the premise that the maximum value is greater than 0 dB, the corresponding average value is supposed to be just over 1.5 dB or less in the mask method. When the average values of each of the 10 samples were actually calculated, the lowest value was 0.6 dB.

In addition, a dot pattern having an average anisotropy value of −7 dB or less and a maximum anisotropy value of −2.5 dB was defined as being the limit of the blue noise properties, by referring to the case of gray level g=⅛ in the Jarvis et al.'s error diffusion method. Thus, the limit for the blue noise properties in the mask method is given by a dot pattern in which the average anisotropy value is supposed to be less than 1.5 dB. When the average values of each of the 10 samples were actually calculated, the largest value was 0.9 dB. This value is higher than the lower limit, 0.6 dB, of the average values of the samples that should have the non-blue noise properties.

The maximum value of each of the 10 samples varied between 2.5 dB and 4 dB, and the average value of these maximum values was 3.2 dB. Nine of the 10 samples, however, had the maximum values at different frequencies that were lower than f_{g}, the frequency having the maximum anisotropy value in the error diffusion method, and the largest of these maximum values reached 5.4 dB. Artifacts, however, were not perceived.

The reason will be explained below. According to the error diffusion method, the 10 samples all have different dot patterns. Besides, for example, the spectrum indicating a maximum anisotropy value of 5.4 dB in one particular sample has a frequency lower than the principal frequency f_{g}, and no peak is found at the frequency in the power spectrum. Since this means that a very small number of dots are related to this anisotropy, artifacts are doubly hard to perceive. Consequently, for the maximum value of each pattern, only the frequency having the maximum value in the error diffusion method should be noted.

However, even if anisotropy values in the two methods are numerically equivalent, individual dot patterns produced by the mask method are visually more anisotropic in the sense that artifacts are easier to perceive. This is because, since the same dot pattern corresponding to a single mask is repeatedly disposed in the mask method, the deviation of dot distribution becomes more conspicuous. This conspicuous property of the above deviation increases, as already shown, with decreasing the size of the mask. As a result, even if the dot pattern corresponding to one mask exhibits anisotropy numerically equivalent to that in the error diffusion method, the mask method provides visually stronger non-blue noise properties resulting in the above visual properties, and the degree of these properties increases with decreasing the mask size.

In addition, in relation to the visual characteristics, a higher resolution printer generates more distinct artifacts even if the size of a mask is kept in the same.

Returning to the previous subject, even in the mask method, non-blue noise can always be determined from only the maximum and average values of anisotropy as shown below. Since a maximum value, which corresponds to slightly greater than 0 dB in the error diffusion method, falls within the range of 5 dB ±1 dB=4 dB to 6 dB in the mask method, the indication of a maximum value of 4 dB or greater may allow us to determine as exhibiting the non-blue noise properties. However, since, the largest of the maximum values of the respective 10 samples is 4 dB at gray level g=⅛ in the error diffusion method by Jarvis et al., the pattern that originally exhibits the blue noise properties meets the requirements for being non-blue noise if a maximum value alone is taken into account. To exclude such examples, a criterion for average anisotropy values must be provided in addition to the criterion that the maximum value is 4 dB or greater, preferably, 5 dB or greater.

With respect to the average anisotropy values, the lower limit value of 0.6 dB for individual 10 samples indicating the non-blue noise properties was in fact lower than the upper limit value for 10 samples indicating the limit for the blue noise properties. Thus, to make reliable determinations, the lower limit must be set higher than the aforementioned upper limit value of 0.9 dB. Then, in a dot pattern according to the error diffusion method having a maximum anisotropy value of 3 dB and an average anisotropy value of almost −5.5 dB, the average values of individual 10 samples were examined and the lower limit was found to be 1.2 dB. Thus, this value is defined as the lower limit of the average anisotropy values for dot patterns each exhibiting the non-blue noise properties in the mask method. The average anisotropy value of −5.5 dB corresponds to the average value, at g=⅞, according to the Floyd and Steinberg's error diffusion method, where the dot pattern shows the non-blue noise properties, in the sense that, even when the maximum value is less than 0 dB, artifacts, weak as they are, are observed.

In this manner, even in the mask method, a dot pattern can be determined to have the non-blue noise properties based only on the two values of anisotropy. Then, the two values in the error diffusion method are, provided that the base value for the isotropic case is 0 dB, larger than 10 dB for the maximum value and larger than just over 3 dB for the average value. However, the maximum value must be 4 dB or greater, preferably, 5 dB or greater, and the average value must be 1.2 dB or greater in the mask method. Of the three properties of blue noise defined for the error diffusion method by Ulichney, property (1), “very low anisotropy”, must use the above two values as references in the mask method.

In either halftone processing method, according to the blue noise properties defined by Ulichney, whether or not a dot pattern has the blue noise properties cannot be determined from only one of the spectra, that is, either the anisotropy or power spectrum. An actual example is described below in which, despite a relatively good blue noise power spectrum is shown by a few individual samples in 10 samples, the maximum and average anisotropy values for the error diffusion method exhibit the non-blue noise properties.

The maximum anisotropy value at g=1/16 according to the Jarvis et al.'s error diffusion method is about 1 dB, together with the average value of a little over −7dB, indicating non-blue noise. In this case, the dot pattern actually involves artifacts due to directional hysteresis. When each power spectrum of individual patterns was calculated, 2 of the 10 samples showed a relatively good blue noise power spectrum. This evidently shows that even in the mask method, whether or not a dot pattern is blue noise cannot be defined using only properties of its power spectrum.

In the perturbed error diffusion method having the blue noise properties, three of six gray-levels being able to refer are isotropic, the difference of the average value from the base value indicates lower than 1 dB in two gray levels, and the difference is approximately 1.5 dB at a gray level with the highest anisotropy. Therefore, in the mask method, if an average value of anisotropy is less than 0.8 dB, then it is supposed to have the same blue noise properties as the perturbed error diffusion method.

In all the inventions relating to the blue noise mask method (Japanese Patent Publication No. 2622429, U.S. Pat. No. 5,111,310, U.S. Pat. No. 5,323,247, U.S. Pat. No. 5,341,228, U.S. Pat. No. 5,477,305, and U.S. Pat. No. 5,543,941), it is described that dot patterns produced by the patented method are more isotropic than those produced by the perturbed error diffusion method of Ulichney. Concerning each of the aforementioned three blue noise masks having different sizes, we first evaluated spectral characteristics of individual dot patterns generated by a single mask and, then, of individual dot patterns each produced in a square of 256×256 pixels, which is the standard size when Ulichney evaluated spectral characteristics of dot patterns generated by various error diffusion methods.

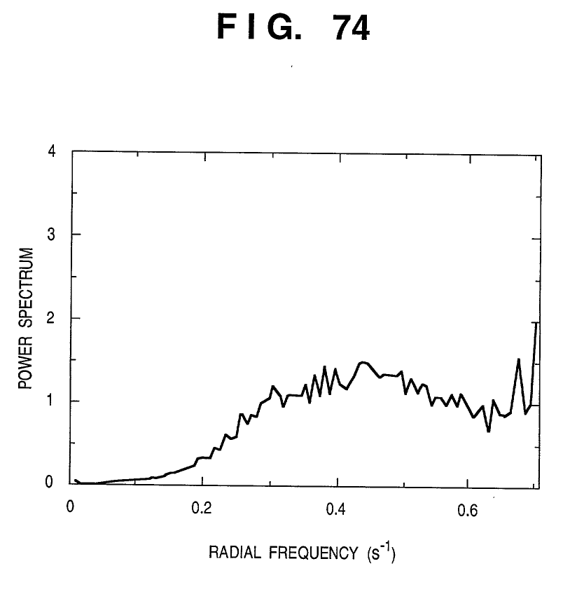

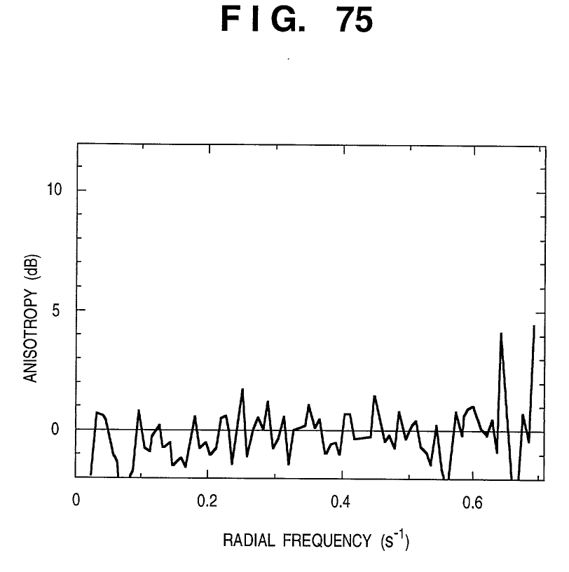

FIG. 74 shows the one-dimensional power spectrum of the dot pattern for the 32nd gray level generated using the single blue noise mask of 128×128 elements. FIG. 75 shows the anisotropy spectrum of the above dot pattern.

Since the above power spectrum shows small low-frequency components, together with an average anisotropy value of 0 dB over the whole frequency band, it can be said to exhibit the blue noise properties. However, inspecting anisotropy at individual frequencies, fluctuations around 0 dB is observed together with the maximum amplitude of 4 dB. This value, itself, is more anisotropic than that of the perturbed error diffusion method of Ulichney. Although similar anisotropic property is obtained at other various gray levels, anisotropy of mask patterns produced by the single 128×128 blue noise mask is more isotropic than dot patterns produced by the perturbed error diffusion method in terms of the average anisotropy.

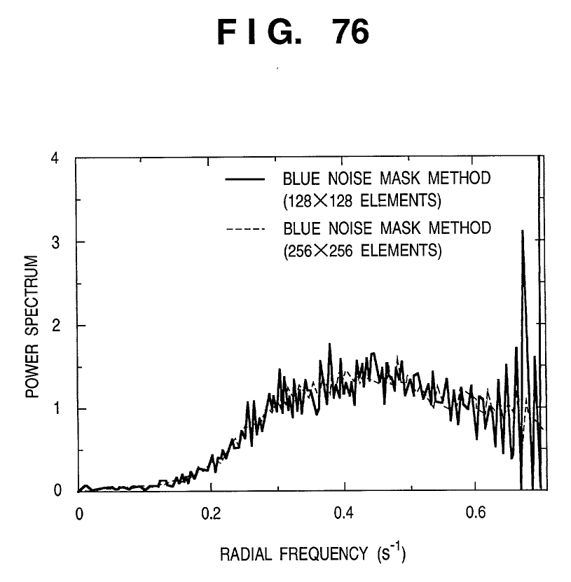

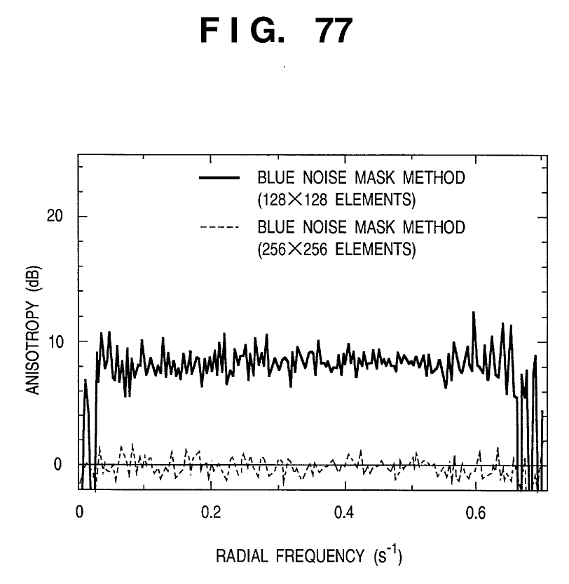

FIG. 76 shows the one-dimensional power spectrum of a dot pattern for the 32nd gray level generated in an image plane of 256×256 pixels using the blue noise mask of 128×128 elements and FIG. 77 shows the anisotropy spectrum of the pattern. In these Figs., characteristics concerning the 256×256 blue noise mask pattern are indicated by broken lines, for ease in comparison. First, the broken lines show superior blue noise properties and, especially, anisotropy is within the range of 0±1.5 dB, and similar characteristics are seen in the other gray levels. Hence, we can say that the 256×256 blue noise mask produces superior mask patterns that are more isotropic than dot patterns produced by the Ulichney's perturbed error diffusion method.

With respect to the one-dimensional power spectrum of the above dot pattern produced by using the 128×128 blue noise mask, many isolated spectra with sharp peaks are superposed on a noise component, and especially in a high frequency range, isolated spectra are prominent. Regarding the anisotropy spectrum, the average value is determined to be about 8 dB, and a plurality of spectra having maximum values higher than 10 dB exist. Taking into consideration that all the spectra with respect to dot patterns produced by the dispersed-dot dithering method have maximum values over 10 dB, this dot pattern, of an output-image plane of 256×256 pixels, has extremely high anisotropy. This dot pattern cannot be a blue noise pattern.

Summarizing the above results for the 128×128 blue noise mask, although it can be said that, since the dot pattern produced by the single mask shows an average anisotropy value of 0 dB, the dot pattern exhibits the blue noise properties, it can be concluded that the dot pattern produced in a 256×256 image plane does not possess the blue noise properties.

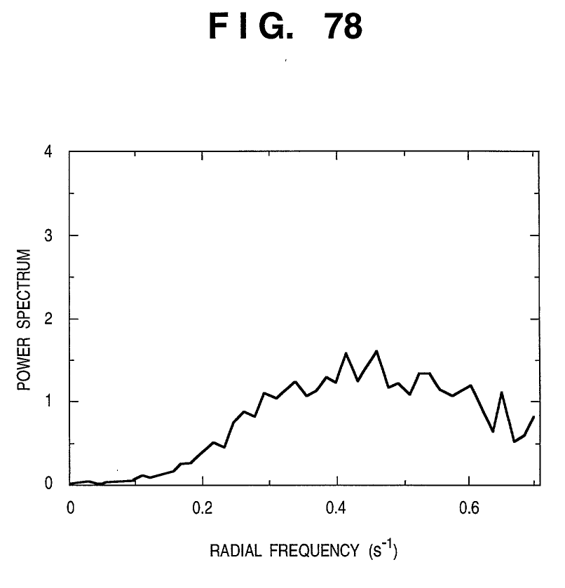

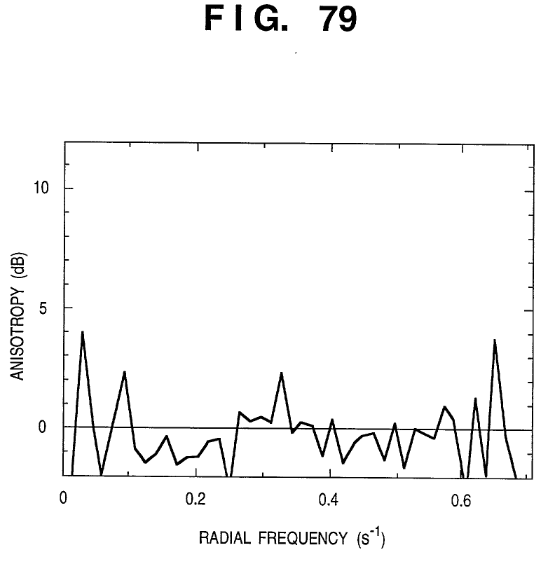

FIG. 78 shows the one-dimensional power spectrum of the dot pattern for the 32nd gray level generated using a single blue noise mask of 64×64 elements. FIG. 79 shows the anisotropy spectrum of the above dot pattern for the 32nd gray level generated using the single blue noise mask of 64×64 elements.

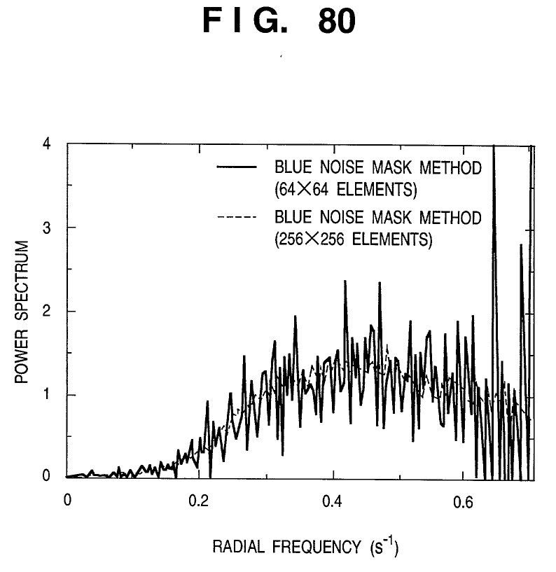

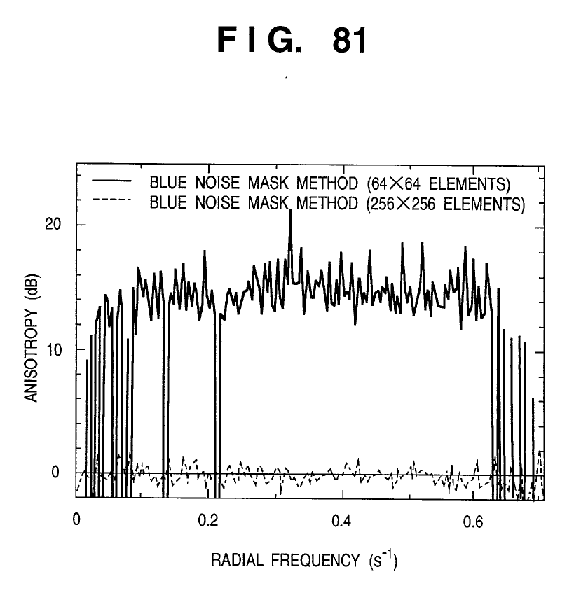

FIG. 80 shows the one-dimensional power spectrum of a dot pattern for the 32nd gray level produced by the single 64×64 blue noise mask in a 256×256 image plane. FIG. 81 shows its anisotropy spectrum. The values of the 256×256 blue noise mask are indicated by broken lines. The characteristics at other gray levels are similar to the characteristics shown in both Figs.

According to FIGS. 78 and 79, since the dot pattern from the single 64×64 blue noise mask indicates an average anisotropy value of 0 dB of anisotropy, it can be said to have the blue noise properties. However, since a plurality of spectra exist indicating maximum values of 4 dB, it can be said that the smaller the mask, the larger the deviation of dot distribution in the blue noise mask method.

According to FIG. 81, the dot pattern generated using the above mask in a 256×256 image plane indicates an average value of anisotropy as high as 14 dB, thereby having the non-blue noise properties.

The blue noise properties are inherently defined, as shown by Ulichney, for evaluating spectral characteristics of dot patterns produced by various error diffusion methods in the standard output-image size of 256×256 pixels. In blue noise masks of the size of 64×64 elements and 128×128 elements, although individual mask patterns, each produced by a single mask, indicate the blue noise properties, dot patterns produced in the above standard output-image size do not have all the blue noise properties. In this way, unlike the descriptions in specifications of prior arts (U.S. Pat. No. 5,111,310, etc.), these patterns are more anisotropic than those obtained by the perturbed error diffusion method by Ulichney. Both results of the above spectral evaluation and the previous visual estimation of dot patterns have been compared (as shown below).

Of the three different sizes of blue noise masks, in the case of masks with a size smaller than 256×256 elements, even if isotropy of each mask pattern, itself, is better than that of the perturbed error diffusion method, dot patterns individually produced in the standard output-image size of 256×256 pixels exhibited the extremely strong non-blue noise properties, resulting in perceiving conspicuous periodic artifacts consisting of repetition of a small irregular density patterns, each corresponding to the mask pattern. Accordingly, visually pleasing blue noise patterns are obtainable at any gray level only by using the 256×256 blue noise mask, which produces dot patterns more isotropic than those produced by the perturbed error diffusion method.

Based on the above results, it is seen that, even if anisotropy of a single mask pattern indicates an isotropic average value, if the scale of the pattern becomes small, a slight deviation in dot distribution, i.e., nonuniformity of density, repeatedly appears at a visually sensitive period, resulting in visually perceiving the periodic nonuniformity as artifacts in the mask method, in which the same pattern is repeated, in principle, different from the error diffusion method.

FIG. 68 showing the scheme on the blue noise properties denotes, as a logical consequence, that “a dot pattern is not visually pleasing unless it possesses blue noise spectra.” That is, since the blue noise mask method fundamentally follows the scheme shown in FIG. 68, the method also follows the above denotation when the mask is considerably smaller than the 256×256 standard size.

As a result of the above-described investigation, to solve the contradiction in principle concerning the periodicity, when the blue noise properties defined in the error diffusion method is intended to be realized by using the blue noise mask method, it is clearly proven that a large mask with sufficient degrees of freedom must be used to obtain isotropy at least better than that of the perturbed error diffusion method. Since the mask size in the dispersed-dot dithering method is 16×16=256 elements, a practical blue noise mask size of 256×256 elements with a 600 dpi printer is 256 times larger.

The anisotropy of a dot pattern of the 256×256 image size generated by the 256×256 blue noise mask results in values better than those by the perturbed error diffusion method. However, if the anisotropy of the dot pattern is evaluated using an even larger image plane, for example, a 512×512 pixel image plane, it theoretically indicates maximum values over 10 dB, turning out that the dot pattern has no blue noise properties. Nevertheless, no artifacts are perceived, and it appears as if the scheme of the blue noise properties shown in FIG. 68 is not followed.

In this case, it is necessary to remember that the scheme shown in FIG. 68 is defined for the error diffusion method in which a dot pattern has no periodicity as in the mask method and that a 256×256 pixel image plane is determined as the appropriate size for use in evaluating the frequency characteristics. That is, the scheme in FIG. 68, when it is applied to the mask method, should be understood such that, if the evaluated result of spectra of a dot pattern in the 256×256 pixel image-plane size shows isotropy and uniformity better than those in the perturbed error diffusion method, there should be no artifacts visually perceived even if the dot pattern is repeated with a visually insensitive long period without discontinuity.

Contrarily, a dot pattern having higher anisotropy, that is, larger deviation in the dot distribution, than that of the perturbed error diffusion method can be perceived as having artifacts if the deviation is distributed at visually sensitive intervals. The above experiments with a 600 dpi printer have proven this fact.

In another disclosed method (U.S. Pat. No. 5,477,305) of generating blue noise masks, it is described that, for example, a 256×256 mask is necessary for reproducing 256 gray levels, providing sufficient degrees of freedom to modify the cumulative distribution function so as to provide non-linear mapping of input and output characteristics. On the other hand, as shown above, inventions on the blue noise mask method describe that blue noise patterns obtained are more isotropic than those by the perturbed error diffusion method shown by Ulichney. However, according to the result of the above-described experiments, a large mask of 256×256 elements is required to obtain such blue noise patterns with a printer of 600 dpi resolution which is a little higher in resolution than the maximum 500 dpi of the average resolutions estimated when the inventions for the method were made.

In addition, it is not assured true that the 256×256 blue noise mask can be practically used with a 1,200 dpi printer only because it can be practically used with a 600 dpi printer. Actually, a super resolution laser printer (of Cymbolic Sciences International Inc.) is used for the test. The resolution is set to two levels, that is, 1,016 dpi and 2,032 dpi. The size of the 256×256 blue noise mask in the image plane is 6.4 mm square for the resolution of 1,016 dpi; and 3.2 mm square for the resolution of 2,032 dpi. In the experiment for the resolution of 1,016 dpi, graininess is intensely observed at gray levels lower than the 120th gray level. On the other hand, at gray levels higher than the 160th gray level, periodic artifacts corresponding to repeatedly disposing the mask pattern can be perceived although its contrast is lower. At the resolution of 2,032 dpi, the graininess gets less compared to that of the resolution of 1,016 dpi, but periodic artifacts corresponding to the repeated use of the mask can be perceived with high contrast at gray levels higher than the 160th gray level. Thus, with a high resolution printer of approximately 1,200 dpi or higher, the size of a blue noise mask to obtain a visually pleasing characteristic should be larger than 256×256 elements.

On the other hand, a mask size in the dispersed-dot dithering method is fundamentally independent of the resolution of printers, and the higher the resolution of the printers, the better the visual characteristic.

Next, the nonuniformity in dot distributions, which is a problem peculiar to the blue noise mask method, is compared with that of the dispersed-dot dithering method.

When a printer with 600 dpi resolution is used, the mask pattern of the 256 gray level dispersed-dot dithering method is 0.68 mm square. As long as a stepwise gray scale is the output, the uniformity of dot patterns in the dispersed-dot dithering method is naturally better than that of the blue noise mask method because regularity is superior to that of the blue noise mask method. When a natural image taken by a digital camera using a CCD sensor of about 580,000 pixels is used as an input image, and if the image does not contain a periodic pattern with a period of about 0.68 mm or less having some degree of contrast in its output-image plane, then no moiré is generated, and the difference in the quality of an output image between the blue noise mask method and the dispersed-dot dithering method is hard to perceive. However, in the case of a gray scale, 0.68 mm square periodicity corresponding to the mask pattern size can be perceived in individual dot patterns at odd number gray levels up to the 50th level.

With a printer of the resolution of 1,200 dpi, the visual uniformity in the dispersed-dot dithering method is furthermore improved, and a dot pattern of periodicity of 0.34 mm square corresponding to a mask pattern size is hardly perceivable even at a low gray level, in cooperation with the effect of dots themselves getting smaller. Therefore, when an image taken by a digital camera with a ⅓ inch CCD image sensor of about 350,000 pixels for a VGA system (640×480 pixels) is outputted using the 1,200 dpi printer on a card size (8 cm×12.5 cm) image plane, the dispersed-dot dithering method is sufficiently practical.

Because a locally periodic pattern having a period of about 0.34 mm, which may cause moiré in the above image, corresponds to a periodic pattern of about 17 μm period on the above sensor, and because the period is equal to or smaller than 20 μm which is the maximum resolution of the sensor, even if a pattern having the periodicity near the above value (17 m) exists in the input image, it cannot be resolved with sufficient contract, thereby resulting in generating no distinct moire. Actually, an image sensor usually provides a low-pass filter to prevent moiré from being generated between a complementary or primary color filter on the sensor and a periodic pattern in an image. Therefore, the resolution is furthermore reduced from 70 to 80 percent of the maximum resolution, that is, about 25 to 29 μm, thereby also reducing the contrast.

In this case, the size of the mask for the dispersed-dot dithering method can be 1/256 of the size of the mask in the blue noise mask method. Therefore, it is cost effective to provide a small ROM capacity for storing threshold values of the mask in the direct print system for outputting an image stored in the digital camera directly by a printer without using a computer.

Recently, digital cameras having a ½ inch CCD image sensor of about 1,300,000 pixels have been marketed by a number of manufacturers at a price of 100,000 yen or less. Such digital cameras can clearly record even fine striped patterns on clothes etc.

Therefore, when such an input image having fine stripe patterns is binarized by the dispersed-dot dithering method and is output in a card size medium using a 1200 dpi printer, moiré can appear as artifacts. In such a digital imaging system, the blue noise mask method in which the mask is large and does not have periodicity is advantageous in that moiré is not, in principle, generated. However, in the case of an input image such as a CG image etc. which generally does not have a finely periodic pattern, the dispersed-dot dithering method is better as usual from the point of uniformity.

When only natural images are dealt with, the detailed comparison proves that the quality of an image, using an error diffusion method with a 600 dpi printer, is better than that by the blue noise mask method except for the problem in a processing time. However, with a 1,200 dpi printer, there is little difference in the image quality between the blue noise mask method and the error diffusion method, and the blue noise mask method excels in the processing speed.

As described above, the resolutions of printers, as output devices, used in the latest consumer digital image processing systems are outstandingly improved compared with those of 8 years ago when the blue noise mask method was invented. That is, the current resolutions are normally 600 dpi through 700 dpi at minimum, and 1,200 dpi at maximum. In addition, digital cameras of image input devices, which did not exist then, can be classified into two classes, that is, a high resolution class and a low resolution class.

Thus, under the conditions that systems have diversified, it is certain that the blue noise mask method cannot be the most suitable solution for all systems as a halftoning method. Although the differences have been reduced, the error diffusion method still excels in quality of image when the resolution is about 600 dpi, and, in the case where the resolution is about 1,200 dpi, there are systems in which the dispersed-dot dithering method is effectively used.

Therefore, when a future system is foreseen presupposing output devices with the resolution about 600 dpi or more, the most suitable solution, naturally, should not choose a processing method in accordance with individual systems. Then, the solution should make the most of the dispersed-dot dithering method having characteristics of high speed processing and excellent uniformity despite a small mask, while removing the defect of generating artifacts caused by periodicity of the mask and the small mask. The object of the present invention is to provide such a method.

An important factor to be considered in designing the above described ideal mask method is the characteristics of a periodic pattern, i.e., spatial frequency and contrast, contained in a recorded natural image, while is to be used as an input image. Another factor is the characteristics of the human eyes viewing an output image provided through a halftoning process, that is, the frequency response of the eyes, when the output image is observed with the optimal viewing distance of about 25 cm. As described above, it is necessary to consider that the sensitivity of eyes is sufficiently high to sense periodic patterns ranging from 1 mm to several mm periods. However, it should be taken into account that the periodic patterns, here, means a sinusoidal variation of light and dark with contrast of 1.

The parameters at the system side directly related to the above-described factors are shown below using a printer as an example of an output device. The following are four parameters as determined by the results of the above-described investigation.

(1) Pixel rate of a printer (dpi)

(2) Image size of an output image

(3) Mask size

(4) Number of gray levels

The main range of the above-described parameters to be considered, at present when a new mask method is developed, is described as follows.

(1) Output resolution: 600 dpi through about 1200 dpi

(2) Document size: Card size through A4 size

(3) Mask size: 128×128 elements or smaller (¼ or smaller of the optimum size of the blue noise mask for 256 gray levels, supposing a 600 dpi printer).

(4) Gray levels: 256 or more.

The reason for making (3), i.e., a mask size, ¼ or smaller of the optimum size of the blue noise mask is to reduce the cost of a direct print system. However, when relevant systems provide large capacity storage media, the mask size is not limited to the above condition (3).

The dot patterns for the blue noise mask method and those for the dispersed-dot dithering method are quite different except the common characteristic of having negligible or small low frequency components. That is, the former have a random property (an isotropic property in the frequency domain) and the latter have a regular property (an anisotropic property in the frequency domain).

As an example of introducing regularity into the blue noise mask method, there is a method of adopting a checker board pattern at the 128th gray level similar to that of the 128th gray level of the dispersed-dot dithering method, in order to decrease the problem of dot gain (M. Yao and K. J. Parker, Proc. SPIE, vol. 2411, pp. 221-225, 1995). To decrease the problem of dot gain, adjacent 2×2=4 pixels are treated as one square pixel at the 128th gray level. A dot pattern generated with a check mask is a two-dimensional periodic pattern with the highest contrast at the 128th gray level. Therefore, if an input image contains a high contrast periodic pattern with a period near that of the 128th gray level, it is naturally predicted that moiré will appear as artifacts. Actually, an object having a periodic pattern is taken by a digital camera of 580,000 pixels, processed in halftone using a 256×256 check mask, and output by a 600 dpi printer as an image of about ½ of a card size, resulting in observing moiré as clear artifacts. The quality of the image output using the mask is apparently worse than the quality of the image generated by the blue noise mask method or the dispersed-dot dithering method.

A similar experiment was conducted on another type of a check mask which, at the 128th gray level, generates the same checker board pattern as that at the 128th gray level in the dispersed-dot dithering method.

When a moiré check pattern having fine periodicity is used as an input image, processed with the above check mask, and outputted in the cabinet size by a 600 dpi printer; the output image also has moiré as artifacts, although its contrast is low. The total quality of the image excels that of the dispersed-dot dithering method, but when it is compared with the quality of an image of the blue noise mask method, it is naturally inferior in that there is the possibility of generating moiré.

The anisotropy spectrum of a dot pattern processed using either one of these two types of 256×256 check masks has a very high maximum value over a wide range of gray levels around the 128th level, including relatively lower and higher gray levels. Even in these cases, the average anisotropy values are low, almost 0 dB. Concerning these two types of check masks, the aforementioned gray scale whose gray levels vary like a staircase is produced by each mask provided by three individual sizes of 256×256 elements, 128×128 elements, and 64×64 elements. All of the check masks show poor uniformity in dot distributions at low gray levels, as in the ordinary blue noise mask method. Artifacts similar to those shown in FIGS. 72 and 73, caused by repetitive dot patterns each corresponding to the size of a mask, are perceivable on a gray scale with the 128×128 or 64×64 check mask.

The scheme of the blue noise properties shown in FIG. 68-indicates that periodicity should be removed as much as possible to obtain a visually pleasing image. Therefore, experiments ;P using the above-described check masks proved that simple introduction of periodicity (anisotropy) to the scheme invites, in principle, the deterioration of the quality of an image.

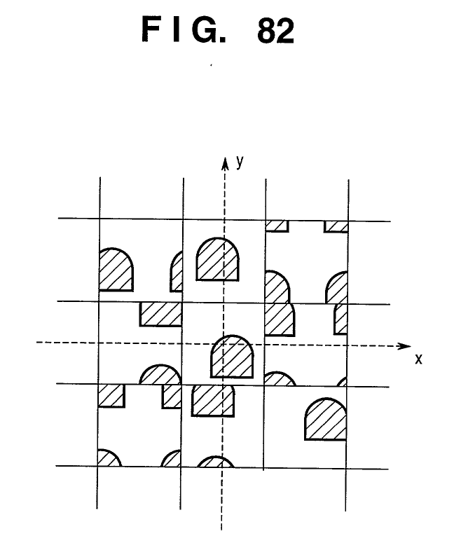

An attempt to implement irregularity in the regular ordered dithering method has been made in the clustered-dot dithering method. Allebach and Liu (J. Opt. Soc. Am., vol. 66, No. 9, p. 909 (1976)) introduced pseudo-periodicity at the center of each dot (corresponding to a cluster of dots in the clustered-dot dithering method) to avoid the generation of moiré caused by a screen. FIG. 82 shows the outline of the pattern on the screen. In FIG. 82, a section containing a dot is called a cell, and nine (3×3) cells are called a block. The central position of the dot shifted from the normal position is confined in each cell including the boundary. Therefore, the irregularity has certain regularity.

When the number of gray levels is 256, the dot patterns at the first and 255th gray levels can be made to have the blue noise properties. However, since the characteristic of the clustered-dot dithering method, i.e., the higher the gray level gets, the larger the cluster of dots gets, remains unchanged, it is not applicable to a printer having the current resolution. In addition, to-realize a mask having the blue noise properties, even at the first gray level, the number of cells should be increased, and the block (mask) itself should be large enough, as shown, relating to the blue noise mask. Therefore, it is not applicable for the purpose of the present invention.

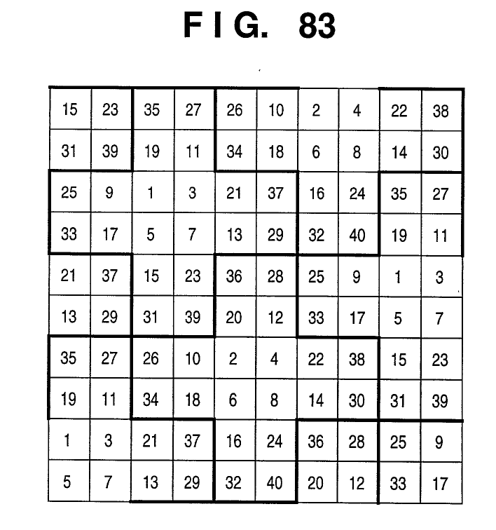

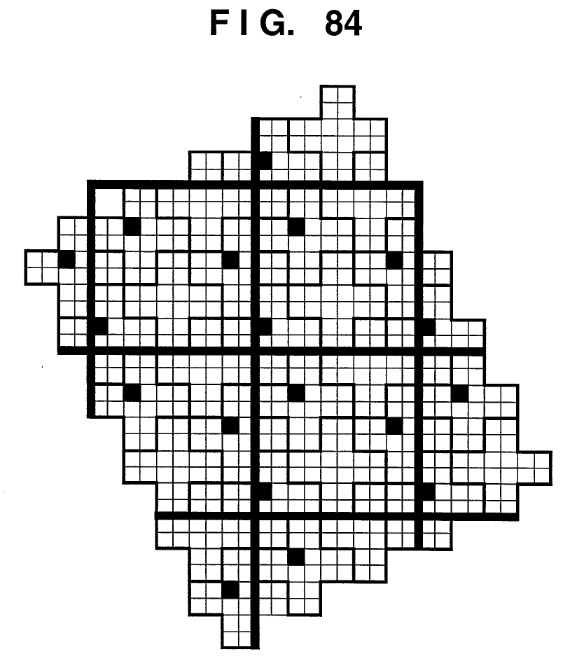

An attempt of introducing some changes to the regularity of a mask in the clustered-dot dithering method (U.S. Pat. No. 4,752,822) is described below. FIG. 83 shows an example of a threshold matrix in the modified clustered-dot dithering method. FIG. 84 shows a dot pattern at the first gray level generated by the matrix.

In this method, two changes are made. One is to provide a partial threshold matrix for odd gray level numbers and a partial threshold matrix for even gray level numbers, thereby dividing the domain to which thresholds are assigned as shown in FIG. 83, resulting in heightening the resolution by 40%. The other is, also as shown in FIG. 83, to make the partial threshold matrix in a cross shape to give a tilt between the primary scanning direction of a printer and the mask arrangement direction. Actually, the first gray level shows a dot pattern with a little irregularity compared to that of the first gray level in the clustered-dot dithering method as shown in FIG. 84. In this method, since a regular arrangement of clusters of dots is obtained at a tilt by predetermined degrees (corresponding to the tilt of a screen) at and after the second gray level, it is not practical for a low resolution printer although the resolution is improved by 40%. However, in this method, since the primary scanning direction is not parallel to the dot arrangement direction, the problem that uneven stripes are generated in each scanning direction can be reduced even though nonuniformity remains in the primary and secondary scanning.

As described above, in the ordinary clustered-dot and dispersed-dot dithering methods, the dot pattern at the first gray level is the same if the number of reproducible gray levels is equal to each other. Therefore, it is possible to consider that the dot pattern at the first gray level in the clustered-dot dithering method obtained in the above-described method is set as the first gray level of the dispersed-dot dithering method. Then, a weak irregularity (perturbation) is also introduced to some extent at and after the second gray level of the method so that the cause of the generation of various artifacts can be removed from the ordinary dispersed-dot dithering method.

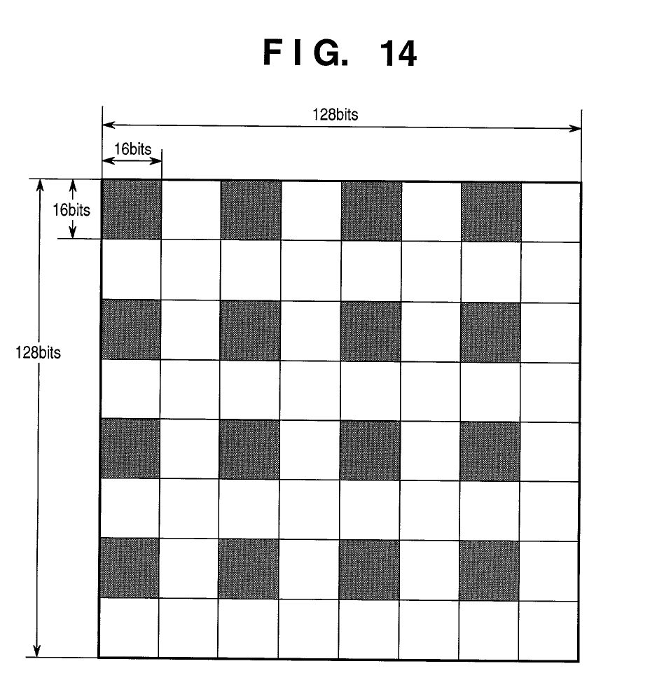

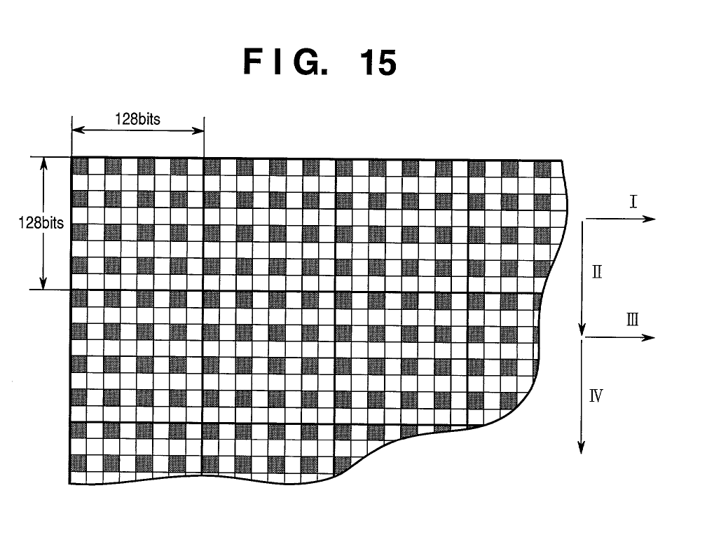

Incidentally, there is an example (U.S. Pat. No. 5,109,282) of introducing periodicity indicating a value of extremely high anisotropy in the error diffusion method, in which, however, dot patterns (FIGS. 14B and 15B of '282 patent) each for a uniform gray level show strong periodicity. A simple experiment proves the generation of moiré. As in the case of the check mask described above, this method also proves that introducing periodicity, therefore, anisotropy, to the scheme concerning the blue noise properties shown in FIG. 68 leads, in principle, to the deterioration of the quality of an image.

The present embodiments are basically a mask method preserving various kinds of periodicity of dot patterns similar to those in the dispersed-dot dithering method, further introducing some weak irregularity or, in other words, perturbation thereto. Hence, when a 600 dpi printer is used, the size of a mask according to the present invention can be made, at largest, ¼ (128×128) of the optimum size of the 256×256 blue noise mask, which was, as previously shown, the minimum size of three different sizes of the blue noise mask to get visually pleasing dot patterns for the resolution of the printer. For a much smaller case of the masks, it can be made 1/16 (64×64) of the above 256×256 blue noise mask, and the memory size required to store thresholds of the mask can substantially be 1/25 of the 256×256 blue noise mask.

Furthermore, anisotropy of a dot pattern produced using a single small mask according to the present method reflects various forms of periodicity and is much higher than that of the perturbed error diffusion method shown by Ulichney, in contrast with the blue noise mask method. It has an average anisotropy value of −1.2 dB or more and has a maximum value of 4 dB or greater, preferably 5 dB or greater at all gray levels. These values have been previously shown to be conditions required for a dot pattern to always exhibit the non-blue noise properties in the mask method.

When the size of the mask is substantially reduced in terms of the storage capacity by increasing the internal periodicity while maintaining the same external shape, both the average and maximum anisotropy values further increase at all gray levels to exhibit the conspicuous non-blue noise properties. Thus, when this method is evaluated using an output image plane of a standard size 256×256 pixels, a dot pattern produced by a single small mask is repeated four times or more, so the average anisotropy value at all gray levels is about 10 dB or much greater, indicating extremely high anisotropy. Therefore, the present method exhibits an incomparably higher anisotropy than the perturbed error diffusion method disclosed by Ulichney.

In this way, in spite of showing higher anisotropy than the case of using the 128×128 or 64×64 blue noise mask, irrespective of output image size, the repetition of the same mask patterns each corresponding to a single mask is comparatively not conspicuous even if the pattern size becomes about a few mm square and moiré does not appear, because of high uniformity together with moderate irregularity of dot distribution. Within the scope of the four parameters mentioned before, the mask method can reproduce visually most pleasant halftone image comparing to any other known mask methods.

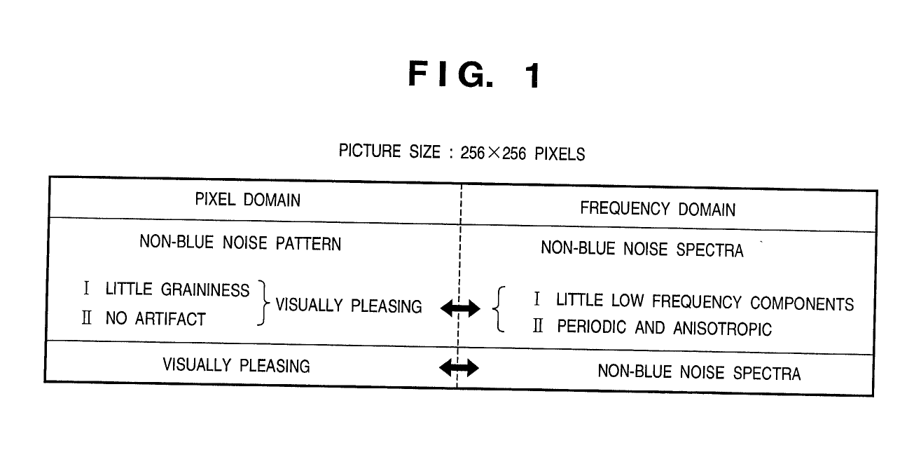

Therefore, the scheme according to the mask method of the present embodiment is quite different from the conventional scheme (shown in FIG. 68) on blue noise. All of individual dot patterns produced by using the mask in the present embodiment have one of the three types of non-blue noise spectra explained previously in relation to FIG. 68. Therefore, these dot patterns must be visually unpleasing according to the blue noise scheme. But contrarily, the patterns are visually pleasing according to the scheme of non-blue noise shown in FIG. 1. In other words, in the scheme on non-blue noise, a dot pattern as visually pleasing as or even more visually pleasing than the dot pattern generated by a large blue noise mask can be obtained by accepting the periodicity (anisotropy), which should be removed as much as possible in the conventional scheme to obtain a visually pleasing dot pattern. As a supplement, it is noted that such a visually pleasing characteristic is more easily obtained with higher resolution of an output device.

Each mask in the present embodiment has four fundamental periodic or regular properties, which follow the similar periodic or regular properties of the mask in the dispersed-dot dithering method or of the dithering method. The regularity of the mask and that of individual dot patterns produced by the mask has a one-to-one correspondence. Hence, for better understanding, setting 256 gray levels to be reproducible, the above four regular properties in terms of an output-image domain are enumerated below. Incidentally, in the case of 256 gray levels, the mask of the dispersed-dot dithering method has 16×16 elements. Then, the mask of the present embodiment has a size of 16 element square multiplied by an integer. In this embodiment, the individual 16×16 mask is designated as an element mask and the mask itself is called a unit mask. In the pixel domain, the element mask corresponds to an element pixel block and the unit mask corresponds to a unit pixel block. Further, a quarter sized element pixel block is defined as a partial element pixel block.

The four regular properties of the mask can be described as follows.

(1) Having at least a set of 16×16 element pixel blocks each of which has the same dot distribution at all gray levels.

(2) The dot pattern at the first gray level is the same as that in the dispersed-dot dithering method.

(3) Individual element pixel blocks of 16×16 pixels have the same number of dots at all gray levels, and

(4) Each partial element pixel block of 8×8 pixels has the same number of dots at every 4n gray level, where n represents a positive integer.

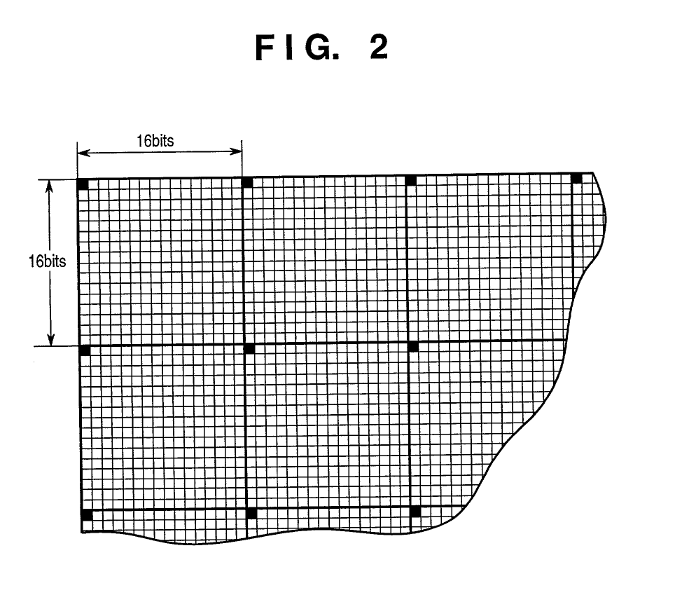

The above four regular properties and their effects are explained in detail by referring to FIG. 2.

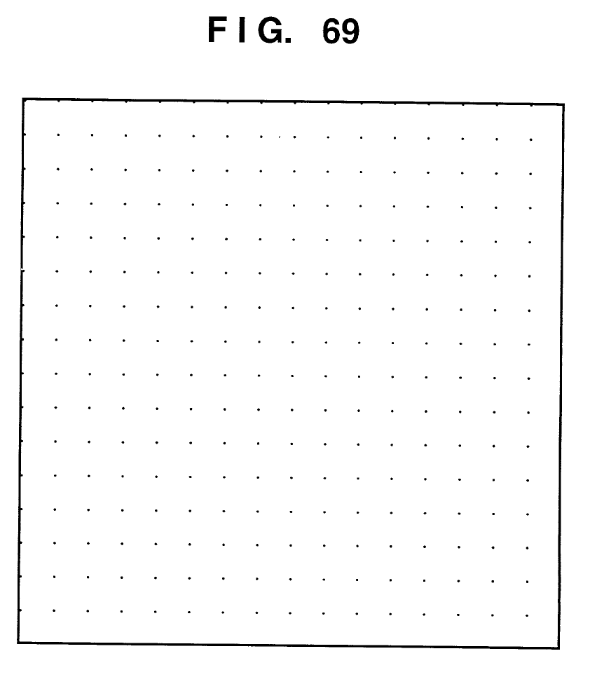

FIG. 2 shows a portion of the dot pattern at the first gray level in the dispersed-dot dithering method, (the same as a portion of FIG. 69 illustrating the dot pattern at the first gray level in the dithering method). Each 16×16 element pixel block in this figure corresponds to the size of a mask pattern in the dispersed-dot dithering method and black pixels represent dots for the first gray level in the dithering. A dot pattern at the first gray level of this method is basically made to coincide with that of the dispersed-dot dithering method shown in FIG. 2 according to the above regularity (2).

The effects of property (2) are as follows. In natural images, high contrast stripe patterns are often seen in non-natural things such as patterns, textures, or stitches on clothes, wall surfaces or lattice structures of buildings and so on. On the other hand, the possibility of seeing very low contrast periodic patterns becomes lower as their regularity becomes more and more definite. Further, in the images taken by digital cameras or by video cameras, very low contrast periodic patterns are scarcely recorded because of the narrow dynamic range of present image sensors. Moreover, very low contrast periodic patterns are rarely recognized as visually unpleasing patterns from the beginning.

Actually, even if a 600 dpi printer is used, the distance between two neighboring dots of a dot pattern at the first gray level is 0.68 mm, being resolvable by the eye, however, different from a striped pattern in which black stripes and white stripes have the same width, since the diameter of each dot itself is about 40 μm (0.04 mm), very much smaller than the distance between two neighboring dots, such a dot pattern cannot be perceived as an unpleasing periodic pattern. Hence, even if an input image contains a striped pattern having a similar period at such a very low gray level, there is little the possibility of generating moiré (artifacts) having so high contrast as to be visually unpleasing.

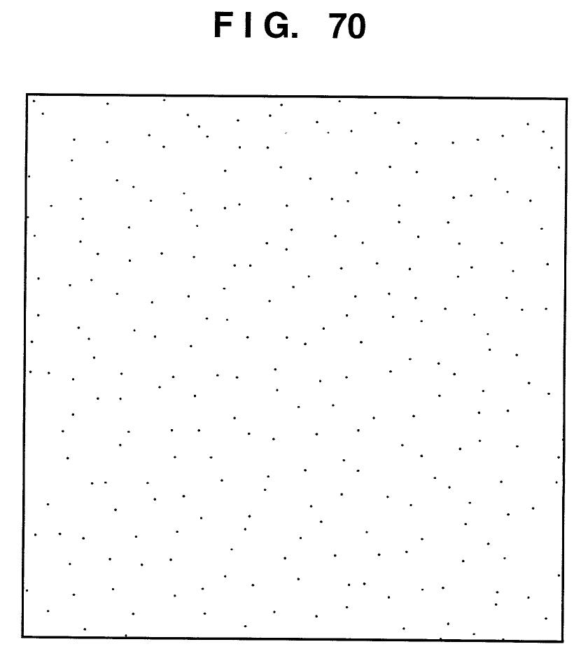

In addition, in an output image with a low and constant gray level, the uniformity is overwhelmingly superior in a completely regular dot pattern such as that of the first gray level shown in FIG. 69 produced by the dispersed-dot dithering method, than in a dot pattern shown in FIG. 70 with random appearances of the first gray level produced by the blue noise mask method. This regularity together with individual regularity (1), (3), and (4) contributes to raise reproducibility of moderate gradation change in a lower gray level range of an input image. The power spectrum of a dot pattern at individual lower gray level up to about the 20th gray level has isolated spectra caused by the completely periodic dot pattern at the first gray level and, therefore, anisotropy measure of dot patterns is very high in these gray levels. In other words, regularity (2) raises the uniformity of dot patterns at low gray levels, simultaneously introducing periodicity, therefore, high anisotropy, to a mask itself.

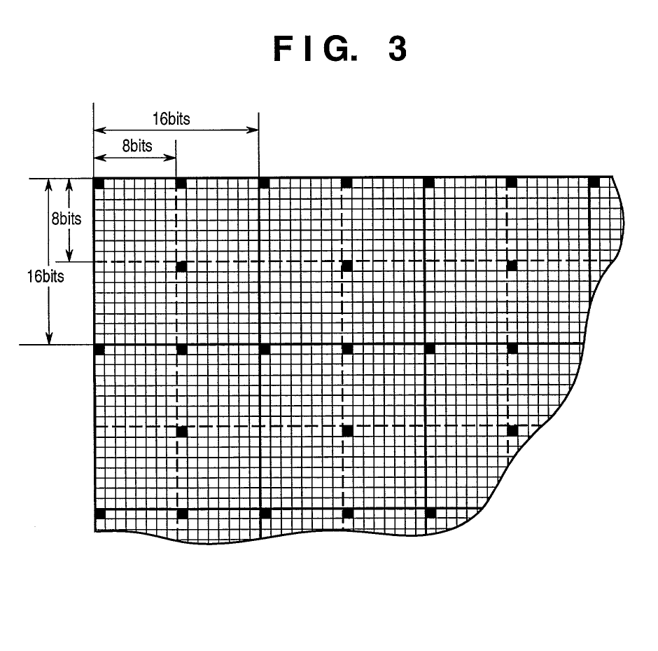

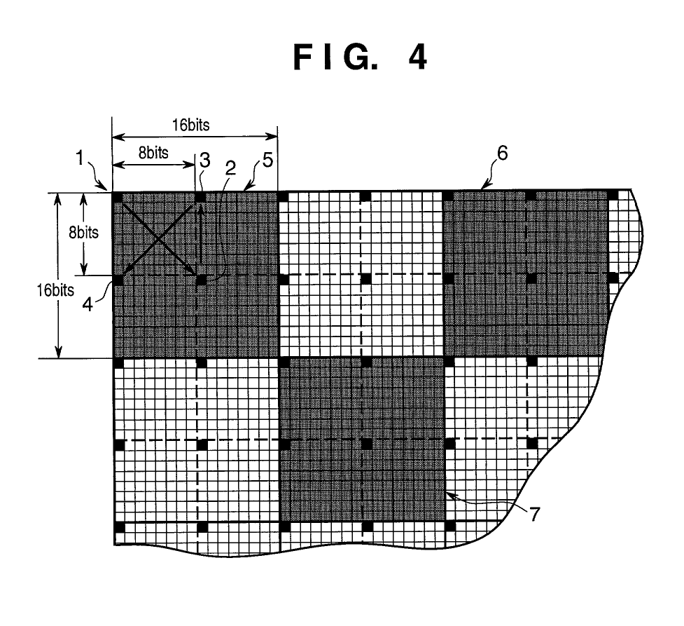

In FIG. 2, each square of 16×16 pixels divided by bold lines corresponds to an element pixel block which is occupied by a dot pattern produced by a single mask in the dispersed-dot dithering method and, on this output-image plane, the same dot patterns are periodically disposed laterally and vertically with the same period of 16 pixels. An element pixel block mentioned in the expression of regularity (1) indicates this 16×16 pixel block. As described above, the mask according to this embodiment has several multiples of element masks each having the size of 16×16 elements. Hence, although locations of dots within the element pixel blocks are different at and after the second gray level, the number of dots included in every 16×16 element pixel block is the same as that in the dispersed-dot dithering method at any gray level according to regularity (3). Further, a mask of several multiples of element masks is designated as a unit mask in the embodiment, however, the shape is not always limited to a square. FIG. 3 shows a portion of a dot pattern at the third gray level, and FIG. 4 shows a portion of a dot pattern at the fourth gray level in the dispersed-dot dithering method.

In these figures, blocks each having 8×8 pixels divided by broken lines are denoted as partial element pixel blocks in the regularity (4). In the dispersed-dot dithering method, as shown in FIG. 4, the first dot at the first gray level is at pixel 1 in the upper left partial element pixel block. The second dot for the second gray level is at pixel 2 in the lower right partial element pixel block. The third dot for the third gray level is at pixel 3 in the upper right partial element pixel block. The fourth dot for the fourth gray level is at pixel 4 in the lower left partial element pixel block. Subsequently, the location of the fifth dot for the fifth gray level returns to the upper left partial element pixel block again. Thus, the order of placing dots in each 8×8 partial element pixel block is, as indicated by the arrows, predetermined for 4 gray levels as one period.

In this way, the number of dots in each partial element pixel block of 8×8 pixels becomes the same at every 4n gray level in the dispersed-dot dithering method, where n is positive integer. Thus, each position of the dot placed at and after the second gray level is different from that in the dispersed-dot dithering method, but the regularity (4) with respect to the number of placed dots in the present embodiment is the same as the above regularity in the dispersed-dot dithering method.

The effects of regular properties (3) and (4) are, as in the dispersed-dot dithering method, to rise the uniformity of the dot distribution. As described later, the algorithm for determining the position of each dot according to the present embodiment has an effect of making the distance between dots approach a predetermined value depending on individual gray level (i.e., the effect of rising the uniformity of the dot distribution). These two regularities have the function of vigorously improving the uniformity together with the above-described effect of the algorithm.

Regularity (1) and its effects are explained based on FIG. 4. Assume that a unit mask has a square shape which consists of 4×4=16 element masks, each having 16×16 thresholds. If FIG. 4 shows a part of a dot pattern produced from the unit mask, the regularity (1) means, for example, to generate the same dot distributions in alternate element pixel blocks 5, 6 and 7, painted gray, wherein the pixel blocks form a pattern similar to a checkerboard. Since a dot pattern in the dispersed-dot dithering method is obtained from the beginning by orderly arranging a dot pattern in a single element pixel block laterally and vertically, as shown in FIG. 4, all the dot patterns in individual element pixel blocks are the same. Hence, the regularity (1) also partly coincides with a regularity of the dispersed-dot dithering method in the sense that the same dot pattern as in a certain 16×16 element pixel block periodically appears in other element pixel blocks.

Further, understanding that regularity (1) is the periodicity of a mask itself, since the arrangement of each dot in the dispersed-dot dithering method has periodicity in the mask at and after the second gray level, regularity (1) also coincides with the regularity of the mask in the dispersed-dot dithering method.

Accordingly, regularity (1) has two effects. One is memory size saving for a mask and another is giving anisotropy to every dot pattern at every gray level. In the case of a 64×64 unit mask, the memory size must be sufficient to store 64×64=4096 thresholds. However, provided that a readout means is contrived, since only one threshold matrix is sufficient for 8 element masks having the same threshold matrices, essential matrix elements turn out to (16×16)×(8+1)=2304, bringing about an effect of reducing the necessary memory size to about a half.

When periodicity having a period smaller than the size of a mask is designated as local periodicity, the regularity (1) also has an effect of introducing local periodicity as the above. That is, this regularity like regularity (2), also introduces anisotropy to a unit mask itself. Therefore, although a limit exists, it generally follows that the larger the number of element masks each having the same threshold array gets, the smaller the memory size for the unit mask, and the higher the anisotropy of individual dot patterns generated by the single mask.

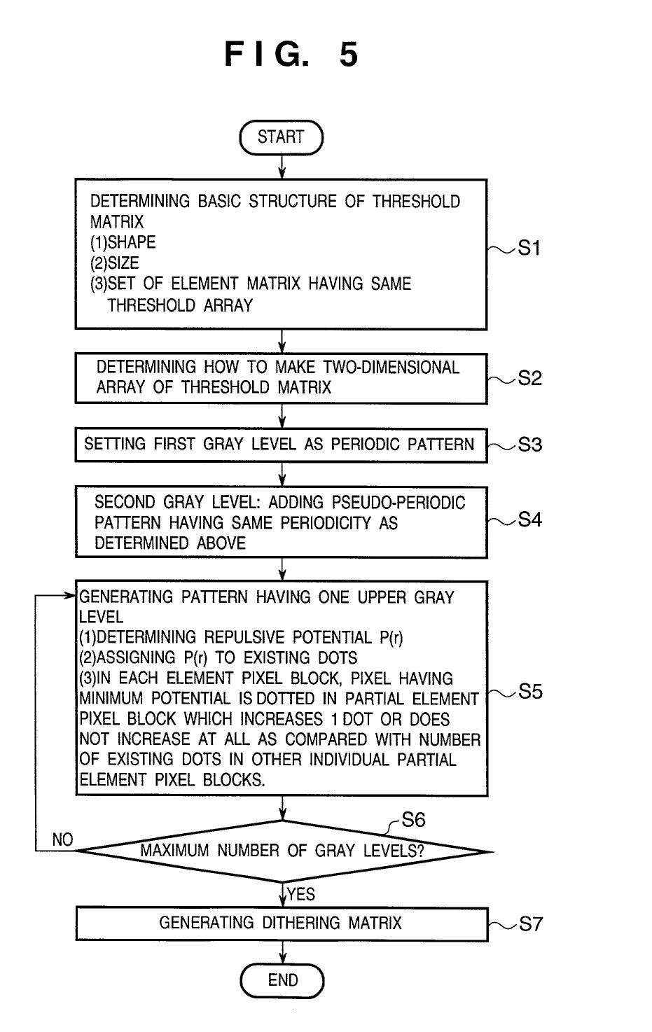

FIG. 5 shows an outline of a flowchart concerning an algorithm for producing masks. In FIG. 5, the relationships between steps S1 through S3 and individual regular properties have been clarified in the above explanation. That is, regularity (1) is implemented in step S1, and regularity (2) is implemented in step S3.

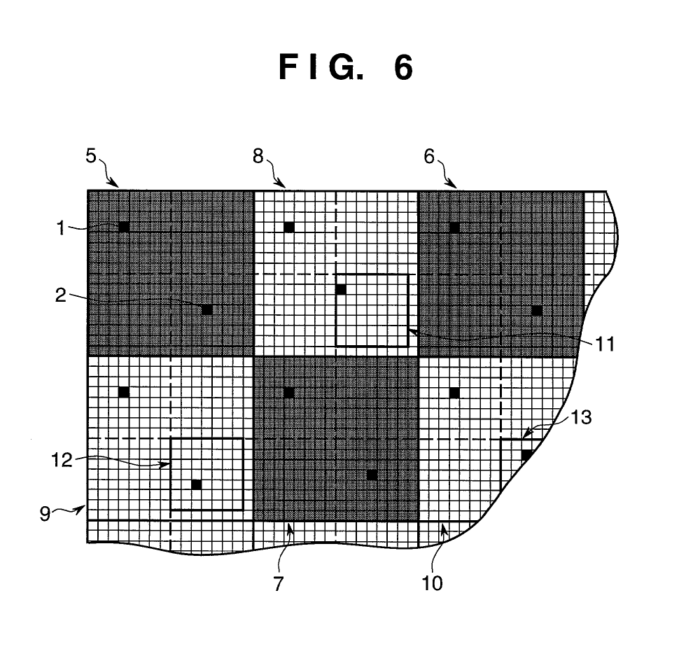

FIG. 6 shows an example of step S4 in which weak irregularity (perturbation) is introduced to a dot pattern for the second gray level.

FIG. 6 shows a portion of a dot pattern for the second gray level produced by a unit mask having 4×4=16 element masks, each of which has 16×16 elements. Among element pixel blocks 5 through 10, element masks corresponding to individual element pixel blocks 5 through 7 painted gray are already determined in step S1 (FIG. 5) so that every element mask has entirely the same array of thresholds 1 through 255. The remaining element pixel blocks 8, 9,and 10 mutually form independent dot patterns at and after the second gray levels.

In FIG. 6, when a horizontal row of pixels is designated as a line i and a vertical one is designated as a column j in each element pixel block, the position of a pixel can be expressed as (i, j). Then, dot 1 at pixel (4, 4) in element pixel block 5 was dotted for the first gray level at step S3 in FIG. 5 and, therefore, every pixel at (4, 4) in other element pixel blocks is also dotted for the gray level. This dot pattern coincides with that of the first gray level produced by the dispersed-dot dithering method.

In step S4 in FIG. 5, a pseudo-periodic pattern is added at the second gray level to the periodic pattern for the first gray level as follows.

In element pixel block 5 shown in FIG. 6, dot 2 at pixel (12, 12) was dotted at the second gray level. Hence, dots are also positioned at individual pixel at (12, 12) in element pixel blocks 6 and 7, which correspond to element masks having the same threshold arrays. Incidentally, the dot pattern consisting of these dots is a portion of the dot pattern at the second gray level in dispersed-dot dithering method.

Positions for individual pixels dotted at the second gray level in element pixel blocks 8 through 10, which correspond to element masks whose threshold arrays are independent of one another, are determined as follows.

In the above-described individual pixel blocks 8 through 10, the center of each small pixel block 11, 12, or 13, individually consisting of 7×7=49 pixels, is located at (12, 12). The reason for transferring each dot position (1, 1) for the first gray level in FIG. 2 to (4, 4) in individual element pixel blocks beforehand is to make each small pixel block be included in individual 8×8 partial element pixel block at the lower right in each element pixel block. Then, a dot is positioned at a pixel which is randomly selected in each small pixel block.

In this way, the above dots positioned/placed at the second gray level constitute a dot pattern (a dot distribution) having weak irregularity (perturbation) introduced to those dotted at the second gray level in the dispersed-dot dithering method. Since this dot pattern has the same basic period as that of the dot pattern for the first gray level, the pattern represents a pseudo-periodic pattern. In the above-described process in step S4, the degree of irregularity introduced can be made weaker by making the size of the individual small pixel blocks 11 through 13 smaller, such as 5×5 pixel blocks or 3×3 pixel blocks. Hence, the framework of individual dot patterns at gray levels above the second gray level is basically determined by this weak irregularity introduced at the second gray level. The weak irregularity thus introduced, together with an algorithm producing individual dot patterns for gray levels above the second gray level, brings about the effect of almost eliminating the defect in the dispersed-dot dithering method that causes periodic artifacts to appear.

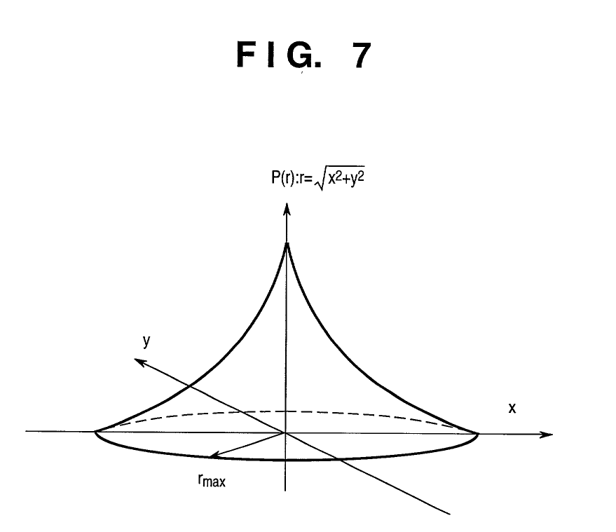

The process of generating a dot pattern at and after the third gray level in step S5 shown in FIG. 5 is explained by referring to FIGS. 7 through 9.

The algorithm which determines individual positions for new dots at every gray level above the second level is basically similar to the algorithm to determine a dot pattern for the third gray level. According to the algorithm, giving a certain repulsive potential P(r) shown in FIG. 7 to all pixels already dotted and, superposing them, an overall potential distribution is obtained. Then, fundamentally, by dotting a pixel where the overall potential takes the minimum value in each 16×16 element pixel block, a dot pattern for the third gray level is obtained.

As for element pixel blocks subject to regularity (1), if a pixel to be dotted is determined first with respect to, for example, element pixel block 5 (FIG. 6), each position of a pixel to be dotted in individual element pixel block 6 and 7 is automatically determined without any calculation for the same position corresponding to the position of the pixel dotted in element pixel block 5.

Since the number of pixels dotted in each element pixel block up to the second gray level is, as shown in FIG. 6,two, satisfying regularity (3), this regularity is necessarily satisfied at every gray level above the second level, provided that positions of pixels newly dotted are determined according to the algorithm described above.

The repulsive potential is usually used in solid state physics (C. Kittel, “Introduction to Solid State Physic”, 6th ed. (John Wisley & Sons, 1986)). Let λ and ρ be parameters. Denoting a three-dimensional distance from the center of the potential as r, the mathematical form of the potential is given by

P(r)=λe^{-r/ρ}.

In our case, the repulsive potential can be defined for two-dimensional distance r as

P(r)=e^{αr}, (2)

where, letting the range of gray level number g be 1≦g ≦256,

$$α = \frac{β}{\sqrt{256 / g}} , \qquad ( 3 )$$

β being a constant. Here, \sqrt{2561} g corresponds to a length (distance) proportional to an average distance between arbitrary two neighboring dots, assuming that every dot is distributed uniformly at the relevant gray level g. In this case, the higher the gray level, the higher the dot density and the larger the α, and, therefore, the repulsive potential changes to a function more rapidly decreasing with respect to r. For removing the gray level dependence of the potential, it is sufficient to set g=256 in equation (3).

In FIG. 7, when the origin of orthogonal axes is fixed at the center of a dot to which a repulsive potential is given, the lateral coordinate axis is denoted as the x axis and the vertical coordinate axis is denoted as the y axis. Then, rₘₐₓ is the distance beyond which the potential becomes zero. The unit distance is the distance between neighboring pixels, that is, the length of a side s of each square pixel.

FIG. 8 shows an example of repulsive potentials with gray level dependence. In this potential, β=0.4, and rₘₐₓ=128s. As clear in this figure, the larger the number of a gray level and the higher the density of dots, the more rapid the individual repulsive potential is attenuated.

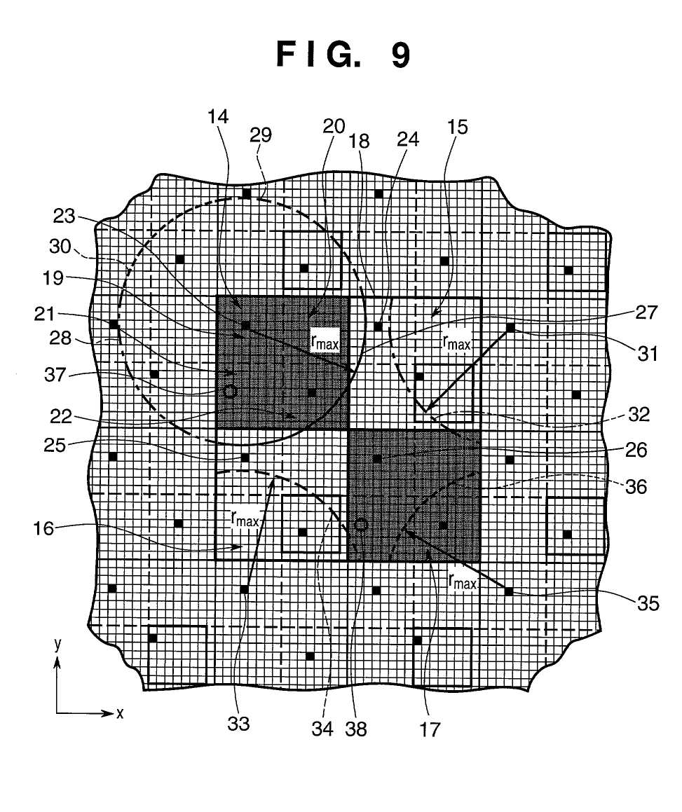

The method of producing individual dot patterns at and after the third gray level by applying the above potential is explained by referring to FIG. 9.

In FIG. 9, for simplicity of explanation, let a unit mask be of 32×32 elements. Then, this mask corresponds in the output-image domain to a unit pixel block 18 of 32×32 pixels consisting of four element pixel blocks 14 through 17 each with the size of 16×16 pixels. Here, element pixel blocks 14 and 17 painted gray are a pair of element pixel blocks having the same dot patterns at all gray levels in accordance with regularity (1). Further, the way to repeatedly array the unit mask on an input image corresponds to repeatedly laying down unit pixel block 18 over an output-image plane along both directions of the x axis and the y axis.

In unit pixel block 18, dots 23 through 26 for the first gray level, following regularity (2), and four dots for the second gray level are already positioned within each element pixel block.

At this stage, in each element pixel block, two partial element pixel blocks each with 8×8 pixels in which a dot is already positioned are memorized so as not to be newly dotted before a dot pattern for the fourth gray level is to be completed. This control is provided for realizing regularity (4).

The maximum radius rₘₐₓ is, for simplicity, assumed to be 13s. The method of giving this potential for the third gray level to dot 23 for the first gray level positioned in element pixel block 14 is explained below.

An arc showing the boundary of a portion of the above potential covering inside unit pixel block 18 is drawn by solid line 27. Another portion of the potential outside the left side boundary of block 18, whose boundary is shown by the arc of a single-point chain line 28, is transferred inside block 18 parallel to the x axis toward the right side boundary, maintaining its shape. This transferred portion is equivalent to a portion of another potential inside block 18 covered by the potential which is given to dot 31 for the first gray level, whose boundary inside block 18 is denoted by the same type of chain line 32.

A portion of the above potential outside the upper boundary of block 18 whose boundary is denoted by broken line 29 is transferred inside the block parallel to the y axis toward the bottom boundary of the block, maintaining its shape. This transferred portion is equivalent to a portion of the other potential inside block 18 covered by the potential which is given to dot 33 for the first gray level, whose boundary inside block 18 is denoted by the same broken line 34.

A portion of the above potential inside another unit pixel block situated diagonally to the upper left of block 18 whose boundary is denoted by dotted line 30 is transferred inside block 18 diagonally to the lower right corner of the block, maintaining its shape. This transferred portion is equivalent to a portion of a potential inside block 18 covered by the potential which is given to dot 35 for the first gray level, whose boundary inside the block is drawn by the same dotted line 36.

When repulsive potentials are given to all the dots inside block 18 in a similar manner as that described above, overall repulsive potential distribution inside the block 18 is constructed as a result of superposing all the repulsive potentials.

Next, a dot for the third gray level is positioned at pixel 37 inside element pixel block 18 where the above overall potential is minimum. At the same time, another dot for the third gray level is automatically dotted at pixel 38 inside element pixel block 17, whose position corresponds to that of pixel 37 inside element pixel block 14. Giving the repulsive potential for this gray level to these dots 37 and 38 and superposing these potentials with the above overall potential, a new overall potential distribution is obtained. At this stage, the partial element pixel blocks in which the dots were positioned and the element pixel blocks including these partial element pixel blocks are memorized for controlling so as not to place a new dot in the above element pixel blocks before a dot pattern for the third gray level is completed and (not to place a new dot) in the above partial element pixel blocks before a dot pattern for the fourth gray level is completed, realizing regular properties (3) and (4).

With respect to the overall potential distribution obtained above, a dot is placed at the pixel where the potential is minimum within both element pixel blocks 15 and 16 and, then, giving the repulsive potential of the third gray level to the dot, a new overall potential distribution is obtained. Here, the partial element pixel block in which the dot was placed and the element pixel block including the partial element pixel block are memorized for controlling so as not to place a new dot in the above element pixel blocks before a dot pattern for the third gray level is completed and (not to place a new dot) in the above partial element pixel blocks before a dot pattern for the fourth gray level is completed, realizing regular properties (3) and (4).

At this stage, there remains only one element pixel block in which a dot for the third gray level is not yet placed. According to the algorithm shown above, the last dot is placed in the block to complete the third gray level mask pattern. Then, the partial element pixel block in which the dot was placed is memorized so as not to dot the block before a dot pattern for the fourth gray level is completed, realizing regularity (4).

A dot pattern for the fourth gray level is produced as follows.

At the stage in which the dot pattern for the third gray level is accomplished, there remains only one partial element pixel block without a dot in each of four element pixel blocks 14 through 17. Hence, the first dot for the fourth gray level is to be dotted at a pixel where the overall repulsive potential for the fourth gray level is minimum within the four remaining partial element pixel blocks, simultaneously giving the repulsive potential for the fourth gray level to the pixel to produce a new potential distribution. Here, the partial element pixel block in which the dot was placed is memorized so as not to dot the block before a dot pattern for the fourth gray level is completed, realizing regularity (4).

If the partial element pixel block memorized as above belongs to either of the pair of element pixel blocks subject to regularity (1), a pixel to be dotted within another element pixel block is automatically determined, thereby determining a new potential distribution and the partial element pixel blocks in which dotting is inhibited before a dot pattern for the fourth gray level is completed.

By repeating similar process and placing a dot in every element pixel block, a dot pattern for the fourth gray level is determined.

A method of producing dot patterns for those levels greater than the fourth gray level is explained. Let n be a positive integer and a mask pattern for the 4nth gray level be known. First, a dot pattern for the (4n+1)th gray level is produced.

In the unit pixel block, a dot is placed at a pixel where the overall potential of this gray level is the minimum, simultaneously giving repulsive potential to the pixel resulting in obtaining a new potential distribution. Further, both the partial element pixel block and the element pixel block, including the pixel, are memorized so as not to dot the element pixel block before a dot pattern for the (4n+1)th gray level is completed and (not to dot) the partial element pixel block before a dot pattern for the 4(n+1)th gray level is completed, maintaining regular properties (3) and (4).

If the element pixel block in which the dot was placed belongs to one of the pair of element pixel blocks which satisfy property (1), a pixel to be dotted within the other of the pair element pixel block is automatically determined, resulting a new overall potential distribution and determining both the element pixel blocks in which no dot is placed before a dot pattern for the (4n+1) th gray level is completed and the partial element pixel blocks in which no dot is placed before a dot pattern for the 4(n+1)th gray level is completed, keeping regular properties (3) and (4).

Under the above new potential distribution, a dot is placed at a pixel where the potential is the minimum within partial element pixel blocks and element pixel blocks individually including the partial element pixel blocks, simultaneously giving the repulsive potential to the dot resulting in producing a new potential distribution. Further, both the element pixel block in which no dot is placed before a dot pattern for the (4n+1)th gray level is completed and the partial element pixel block in which no dot is placed before a dot pattern for the 4(n+1)th gray level is completed, including the dot, are memorized to keep regular properties (3) and (4).

By repeating a similar process and placing a new dot to every four element pixel blocks, a dot pattern for the (4n+1)th gray level is determined.

Then, by applying a similar procedure as described above, in which the dot pattern at the (4n+1)th gray level was accomplished based on the dot pattern for the 4nth gray level, dot patterns at the (4n+2)th, (4n+3)th, and 4(n+1)th gray levels are determined.

Finally, after confirming in step S6 that dot patterns of all gray levels up to the 255th gray level are completed, all the thresholds for a mask can be determined by step S7 in FIG. 5.

In the present method, mask patterns are produced step by step from the first gray level to the 255th and, therefore, a pixel where a dot is already placed at a lower gray level necessarily has the same dot at a higher gray level. In this procedure, let the number of a gray level be n (nₘₐₓ=256) for one of the input images each with constant gray level and a threshold value of one of the elements of the mask be a positive integer m (mₘₐₓ=255). Then, when the threshold value of an element is increased one by one from 1, on the mask, where the element corresponds to a pixel in which a dot is already placed at each of the above gray levels, the dot turns out to have been placed when

m=n. (4)

Determining the value of each element in this manner, all the threshold values are determined and the mask is completed.

In the case of a general input image, when a gray level number of a pixel and a threshold value of a corresponding element in a mask satisfy the relation expressed by

m≦n, (5)

a dot is to be placed at the pixel in an output image.

In this way, in the present embodiment, each mask pattern for individual gray levels is designed to get optimum dot distribution by applying repulsive potentials and periodic or regular properties (1) through (4). Hence, dot patterns having extremely superior uniformity are obtained in every gray level from the 1st through 255th. Actually, as can be confirmed in all embodiments described later, when the number of placed dots gets large in accordance with a gray level number getting large, isolated spectra with high peaks appear in the high frequency range of a noise component in a one-dimensional power spectrum (not shown in the attached drawings). This is because, on account of the above optimization, the number of dots forming a group of dots having a predetermined dot interval becomes relatively larger than the number of dots having no such interval.

Such a characteristic in the present embodiment shows conspicuous difference from the blue noise mask method. Because, in the method, since the optimization of dot distribution is usually carried out from the middle gray level, viz., the 128th gray level, uniformity of the above distribution gets worse as the gray level number gets larger or smaller.

Although the basic procedure of generating masks is explained by referring to FIGS. 5 through 9, the method to produce the masks can be variously modified but still maintaining regular properties (1) through (4).

In the above-described method, when the dot pattern at the (n+1)th gray level is generated from the dot pattern at the nth gray level, a pixel at which a new dot is placed is determined based on the distribution of the overall repulsive potential. Simultaneously, the repulsive potential is assigned to the pixel, and the distribution of the potential is updated. This process of placing a new dot was repeated three times.

For example, the above procedure can be simplified in one process by placing a new dot at the pixel at which the distribution of the overall potential indicates the minimum value inside each of the three in four element pixel blocks. In this modified method, at each higher gray level, the difference from a dot pattern in the original method becomes smaller, and there is no fundamental difference in the one-dimensional power spectrum and the anisotropy spectrum of a dot pattern.

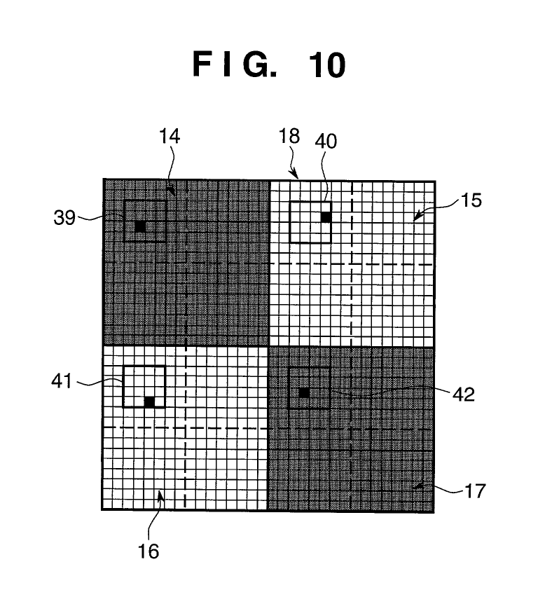

It is also possible to make a small change of regularity (2) only. According to regularity (2), the dot pattern at the first gray level coincided with that in the dispersed-dot dithering method as shown in FIG. 9. Adding weak irregularity (perturbation) to the dot pattern, it can be changed to a pseudo-periodic dot pattern. FIG. 10 shows an example of such pseudo-periodic dot patterns.

As shown in FIG. 10, the unit mask has a size of 32×32 elements and corresponds, in an output image domain, to the unit pixel block 18 of 32×32 pixels consisting of four element pixel blocks 14 through 17, each having a size of 16×16 pixels. Here, element pixel blocks 14 and 17 constitute a pair of blocks which have the same dot patterns at every gray level in accordance with regularity (1).

In order to produce a dot pattern at the first gray level in this modified method, 4×4 small pixel blocks 39, 40, 41, and 42 are first set up in the center of individual partial element pixel blocks situated at the upper left within each element pixel block. Then, one pixel is randomly selected from the 16 pixels within each small pixel block and by placing a dot at that pixel, the dot pattern for the first gray level is accomplished. However, here, the position of the pixel dotted within each individual small pixel blocks 39 and 42 corresponds to the same positions. Also, in this method, the degree of irregularity can be controlled by changing the size of the small pixel blocks.

Then, the flow to produce dot patterns greater than the second gray level branches into two ways.

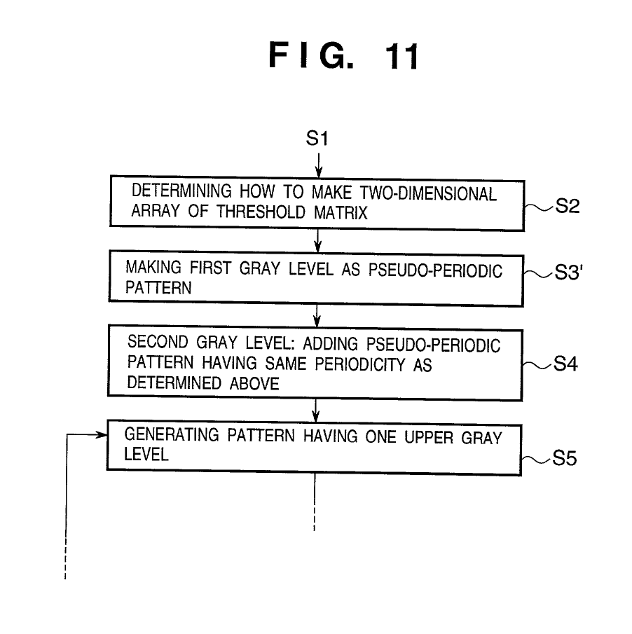

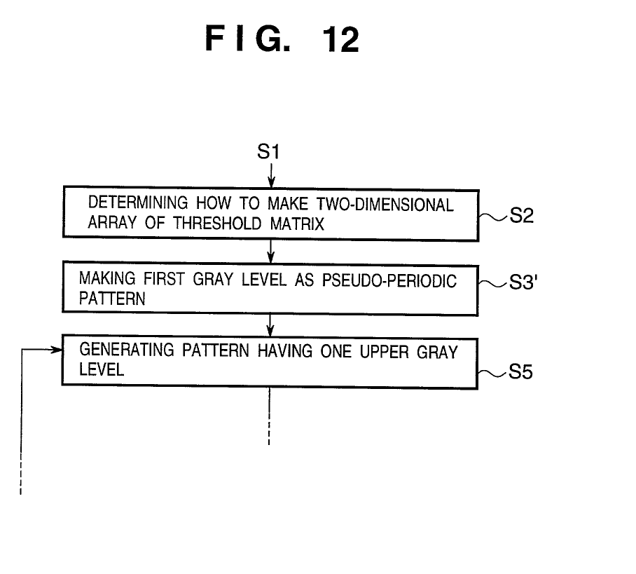

One is shown in FIG. 11, where a pseudo-periodic pattern is also added at the second gray level according to step S4 of the flowchart of FIG. 5 and, then, dot patterns above the second gray level are produced by performing the steps after step S4 in the flowchart. Another is, as shown in FIG. 12, to produce dot patterns greater than the second gray level by following to step S5 and the subsequent steps of the flowchart of FIG. 5. In either methods, although the anisotropy decreases a little at each lower gray level, the one-dimensional power spectrum and the anisotropy spectrum of individual dot patterns basically do not change.

In contrast to the above methods, provided that the resolutions of the printers are much higher, e.g., 1200 dpi, a gray level in which weak irregularity is introduced can be raised, for example, at the fifth gray level, by making better use of superior uniformity in dot distribution of the dispersed-dot dithering method.

As explained above in detail, problems in conventional dithering methods were solved by utilizing, aside from introducing weak irregularity, fundamental four regular properties similar to those of the dispersed-dot dithering method. These properties brought about, in this invention, as they work in the dithering method, an effect of giving high anisotropy to dot patterns together with reduction in memory size and, at the same time, another effect of being able to produce visually more pleasing dot patterns as the resolution of output devices becomes higher.

Considering that improvement in the resolution of an output device requires a larger mask in the blue noise mask method, therefore having a disadvantage, the advantage of the mask method following the scheme (FIG. 1) over the blue noise mask method having the opposite scheme (FIG. 68) with respect to anisotropy is apparent. Described below in detail are embodiments of the present invention. Their advantages are clearly verified.

The embodiments of the present invention are described below in detail by referring to the attached drawings. The embodiments relate to the masks generated according to the basic flowchart shown in FIG. 5.

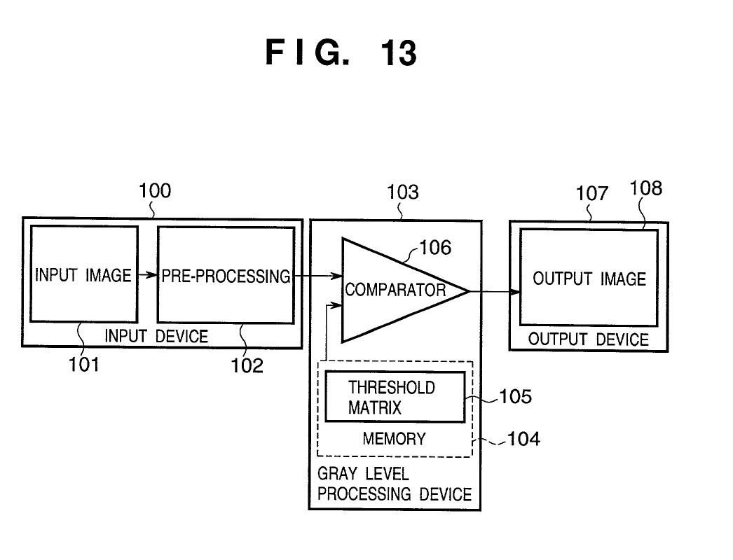

FIG. 13 shows the basic system for processing an image according to an embodiment of the present invention.

In this FIG., 100 is an image input device such as a scanner that scans an input image 101. This device executes pre-processing 102 including the digitization of continuous change of tones in the input image 101 into, for example, 256 gray levels; non-linear processing; and color processing for each color component of a color input image. Reference numeral 103 designates a gray level processing device including a memory 104 for storing a threshold matrix (a mask) 105 having various periodic characteristics of this embodiment, that is, high anisotropy and low irregularity (perturbation); and a comparator 106 for comparing the value of the gray level of each pixel of an input image with the corresponding threshold value based on equation (5) and determining whether a 0 (no dot) or 1 (a dot) is to be provided as an output value, depending on the result of the comparison. Reference numeral 107 is a device for displaying or printing the output image 108 formed based on the output values from the comparator 106.

In addition, in a direct print system using a digital camera as an input device, the luminance and color information of the input image, in FIG. 13, are converted into digital information, and then stored in a memory of the camera. Thus, as part of the pre-processing 102, non-linear and color processing, in which the properties of the printer are taken into account, and the gray level processing device 103 are incorporated in an ink-jet printer 107 acting as an output device.

<First embodiment>

A procedure for creating a mask having the features of this embodiment will be described with reference to the flowchart of FIG. 5.

FIG. 14 shows the shape, the size, and the set of element pixel blocks having the same dot distribution of a unit pixel block corresponding to a unit mask of this embodiment. This figure shows that the mask is a square matrix of 128×128 elements. In addition, all element pixel blocks painted gray, each consisting of 16×16 pixels, have the same dot pattern at each gray level. Thus, the element masks, each having 16×16 elements, have the same threshold value array.

FIG. 15 shows a two-dimensional array of the unit pixel block of 128×128 pixels corresponding to the unit mask on an output image plane determined at step S2 in FIG. 5. If the output device is a printer, the rightward arrow represents the main scanning direction for a print head ejecting ink or a laser beam, the downward arrow indicates the sub-scanning direction, i.e., the opposite direction of sheet feeding, and the numbers (roman numerals) accompanying the arrows indicate the order in which the mask is scanned on the image plane.

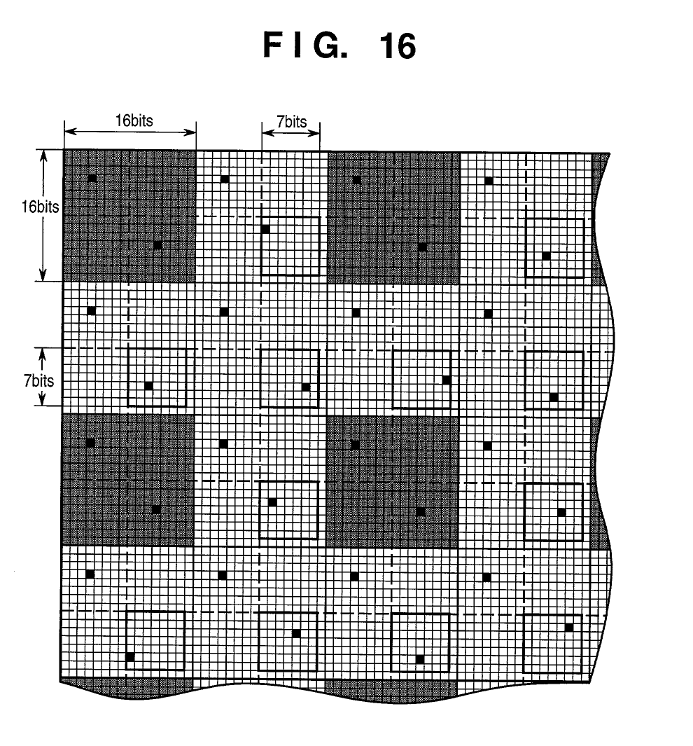

Steps S3 and S4 in FIG. 5, according to this embodiment, will be described with reference to FIG. 16. In FIG. 16, the dots each provided at the (4, 4) pixel of each element pixel block of 16×16 pixels constitute the same dot pattern as that of the first gray level of the dispersed-dot dithering method.

All element pixel blocks painted gray have the same dot patterns and the dots each newly provided at the (12, 12) pixel of each element pixel block are for the second gray level. In addition, their positions coincide with the positions of dots newly provided for the second gray level in the dispersed-dot dithering method. A small pixel block of 7×7 pixels is provided in each of the other element pixel blocks, i.e., the unpainted element pixel blocks, and one of the 49 pixels of the small pixel block is selected for the second gray-level dot. Accordingly, the dots newly provided for the second gray level constitute a pseudo periodic pattern, having the same period as the dot pattern for the first gray level of the dispersed-dot dithering method.

For the third and subsequent gray levels, repulsive potentials expressed by equations (2) and (3) and shown in FIG. 8 are used to form dot patterns according to step S5 of FIG. 5, as described above. The potentials are varied with the gray level up to the 70th level. However, the potential provided for the 70th gray level is kept to use for the 71st and subsequent gray levels.

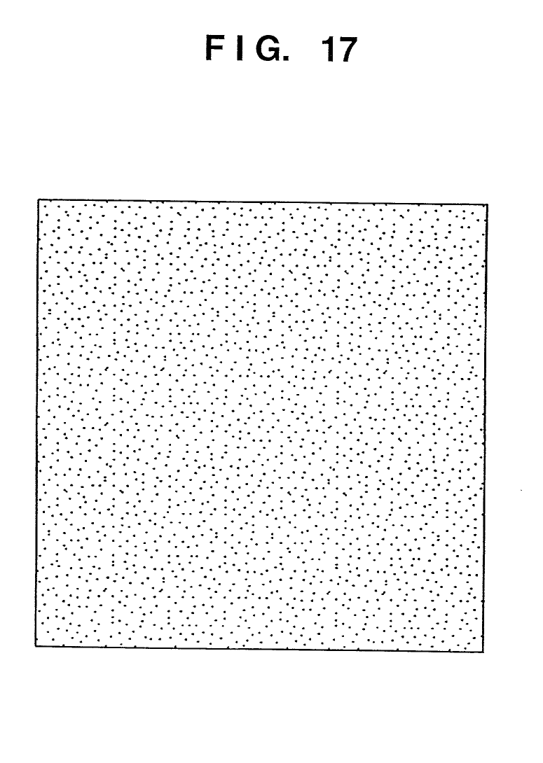

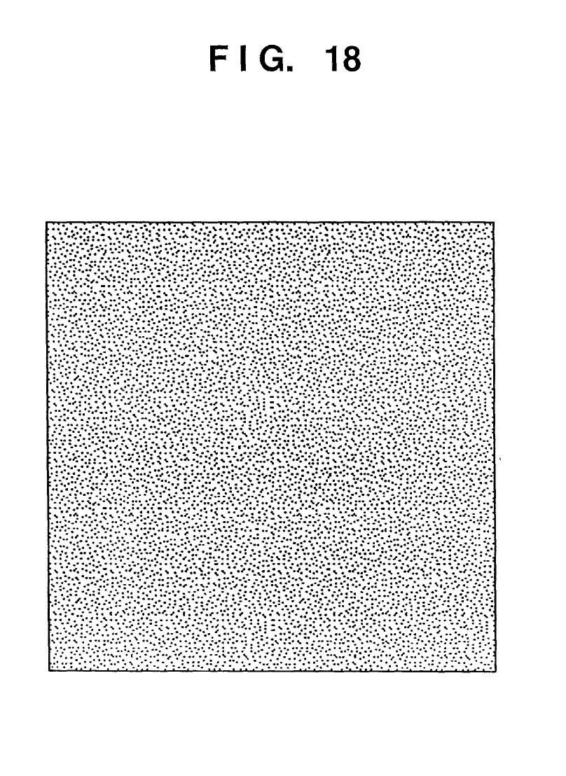

A mask created in this manner was used to output dot patterns for input images each of a uniform density on an image plane of 256×256 pixels by using a 600-dpi BJ printer. FIG. 17 shows a dot pattern for the 8th gray level, and FIG. 18 shows a dot pattern for the 32nd gray level. These figures show the dot patterns enlarged 10 times in both length and width of the actually printed dot patterns obtained by using the 600-dpi BJ printer. The individual unit pixel blocks each corresponding to the unit mask are exactly one-fourth of the individual dot patterns in size, and the distributions of dots shown in FIGS. 17 and 18 exhibit periodicity and/or artifacts caused by the unit mask itself.

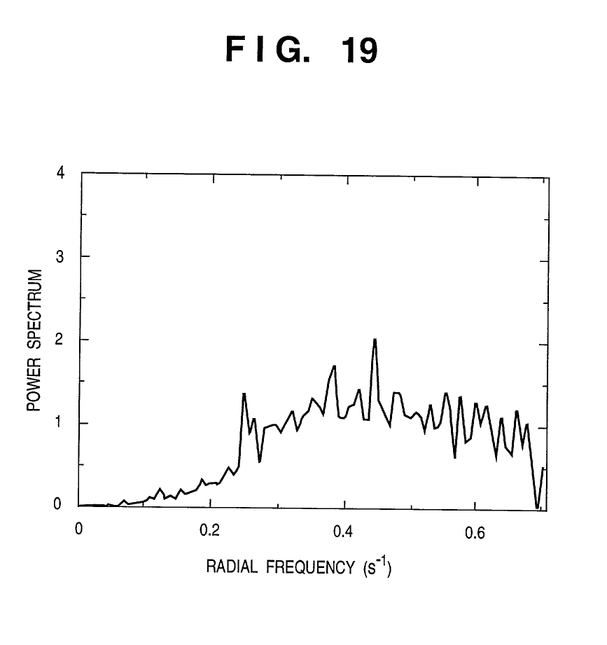

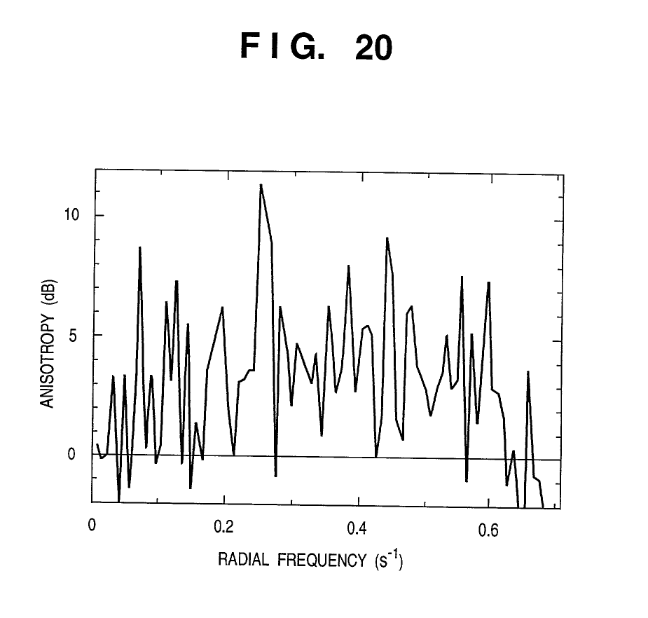

FIGS. 19 and 20 show the spatial frequency properties of the dot pattern of 128×128 pixels for the 32nd gray level generated using a single unit mask according to this embodiment. FIG. 19 shows the one-dimensional power spectrum of the above dot pattern. This figure shows many isolated spectra having sharp peaks on a noise component.

FIG. 20 shows the anisotropy spectrum of the above dot pattern. This figure shows a spectrum having an average anisotropy value of a little over 3 dB and a maximum anisotropy value far exceeding 4 dB, which are evaluated to be an especially anisotropic level, and reaching close to 10 dB or more, which is evaluated to be an extremely anisotropic level. Both the average and maximum values are at a level that can be said to exhibit the non-blue noise properties even in the error diffusion method. Thus, this dot pattern, corresponding to the single mask, evidently has the non-blue noise properties. The coincidence between the frequencies indicating high anisotropy and the frequencies of isolated spectra in the one-dimensional power spectrum shows that these spectra are attributable to the periodicity of the mask itself.

Such spectral properties are not limited to the 32nd gray level but are found in all gray levels. Hence, the unit mask according to this embodiment obviously has the non-blue noise properties in the all gray levels of dot patterns.

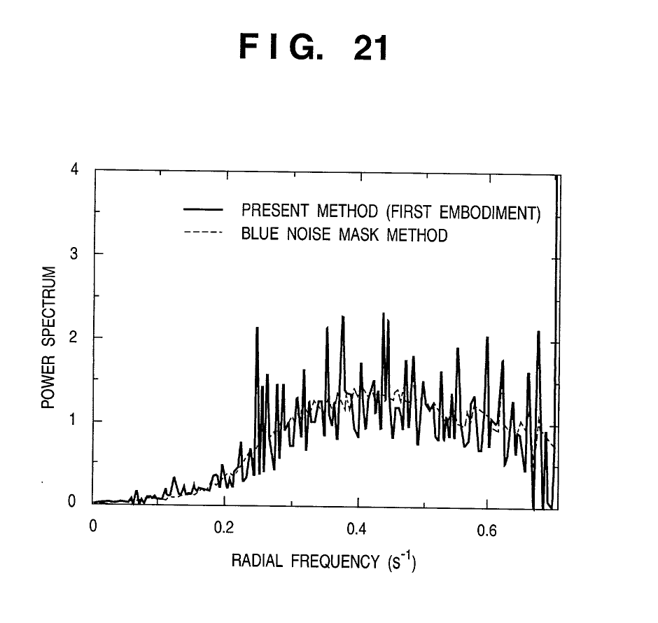

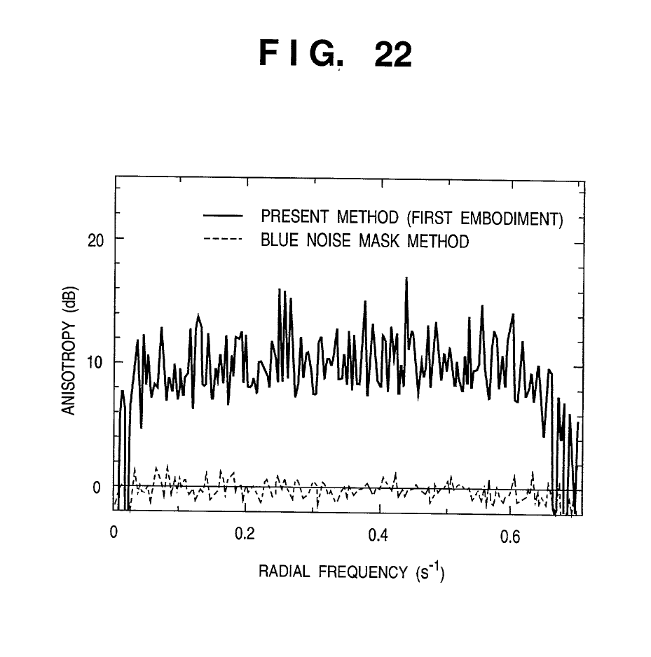

FIGS. 21 and 22 show the spatial frequency properties of a dot pattern for the 32nd gray level generated using the 128×128 unit mask according to this embodiment on an image plane of 256×256 pixels, which is used as a standard in evaluating spectra.

FIG. 21 shows the one-dimensional power spectrum of the above dot pattern. In this figure, the solid line shows this embodiment, while the broken line shows the case of applying the aforementioned 256×256 blue noise mask. This figure shows noticeable differences from the case of using only single unit mask in that the noise component decreases, increasing the isolated spectra having high sharp peaks conspicuously different from the power spectrum for the case of the above blue noise mask.

FIG. 22 shows the anisotropy spectrum of the above dot pattern for the 32nd gray level generated in the image plane of 256×256 pixels using the unit mask according to this embodiment. In this figure, the solid line shows this embodiment and the broken line shows the case of applying the 256×256 blue noise mask. This embodiment exhibits extremely high anisotropy of about 10 dB as an average value clearly different from the isotropic blue noise mask method exhibiting an anisotropy of 0 dB as an average value.

As shown in FIG. 77, the dot pattern generated by the aforementioned 128×128 blue noise mask on an image plane of 256×256 pixels did not show the blue noise properties, because exhibited an anisotropy of about 8 dB as an average value. In this case, the periodical array of non-uniformity of 128×128 pixels was sensed as an artifact on the gray scale shown in FIG. 72, so this blue noise mask was not suitable for practical use. According to this embodiment, however, such non-uniformity was not sensed despite its much higher anisotropy.

In addition, when output images obtained respectively using the present mask and the 256×256 blue noise mask for an input image of, for example, the human skin having gradually changing tones in lower gray levels were compared, the present mask exhibited a slightly better performance in reproducing the gradually changing tones. The high uniformity of the dot distribution according to this embodiment is numerically verified as follows: when a pixel block of 16×16 pixels was scanned on the image plane to examine the variation of the number of dots included in this block, this embodiment which keeps regular properties (2) and (3) exhibited smaller values at most gray levels.

Besides, the size of the mask, generating visually pleasing dot patterns, is only one-fourth of that of the blue noise mask of an optimal size for a printer of this resolution. Furthermore, since the element masks corresponding to the 16 element pixel blocks, painted gray in FIG. 14, have the same threshold array, only one element mask needs to be stored, thereby reducing the storage requirement for the mask down to about one-fifth.

These results of evaluations show that the mask according to this embodiment is not based on the scheme for the blue noise properties shown in FIG. 68 but on the new scheme -shown in FIG. 1. That is, premising from the beginning that a small mask is repeatedly and periodically used, in other words, the spatial frequency properties exhibit very high anisotropy, it was shown that a visually pleasing dot pattern, without periodic artifacts, can be obtained even by reducing the size of a mask and providing it with various regular and periodic properties shown in (1) to (4), that is, a very high anisotropy, contrary to the scheme in FIG. 68.

<Second embodiment>

A procedure for creating another mask having the features of the second embodiment will be described with reference to the flowchart in FIG. 5.

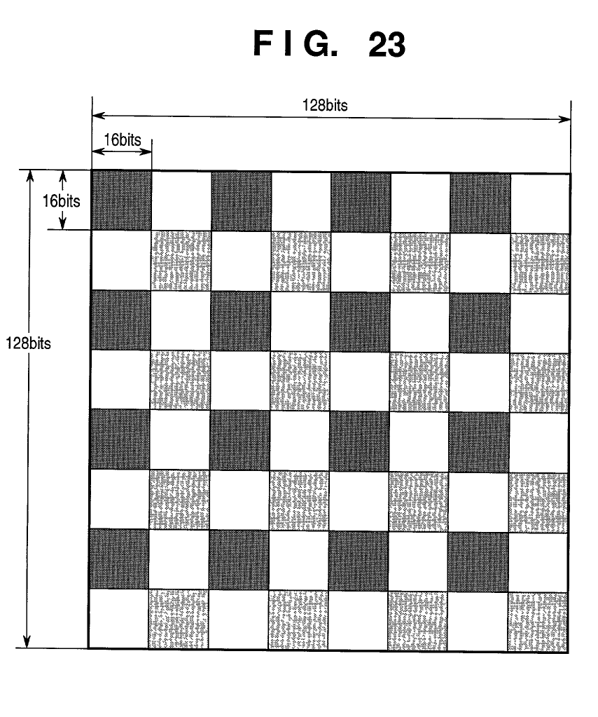

FIG. 23 shows the shape, the size, and the sets of element pixel blocks having the same dot arrangement of a unit pixel block corresponding to the unit mask according to this embodiment. A mask pattern in this embodiment differs from a mask pattern according to the first embodiment in that, in addition to 16 element pixel blocks painted dark gray, this mask pattern has 16 element pixel blocks painted light gray with the same dot arrangement to further reduce the substantial storage requirement for the mask and in that anisotropy is further increased.

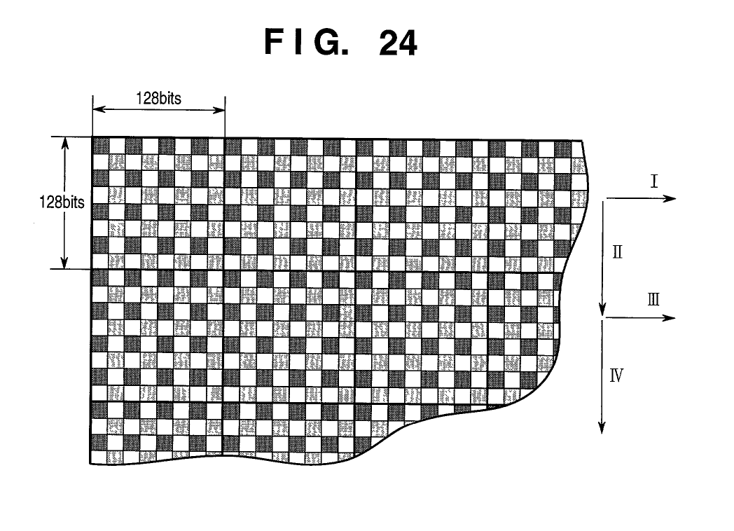

FIG. 24 shows how the unit pixel blocks each of 128×128 pixels corresponding to the unit mask are two-dimensionally arranged on an output image plane. This arrangement is determined at step S2 in FIG. 5. The meanings of the arrows and roman numerals shown at the right side of the figure are the same as in FIG. 15.

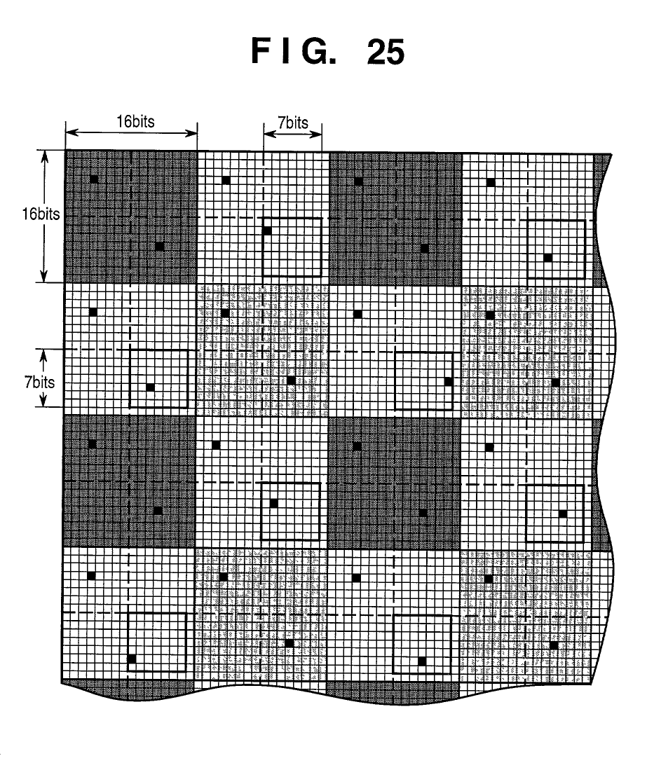

Steps S3 and S4 in FIG. 5 according to this second embodiment will be described with reference to FIG. 25. This figure shows a part of a dot pattern for the second gray level in a unit pixel block corresponding to a single mask, and the set of element pixel blocks painted dark gray and the set of element pixel blocks painted light gray respectively have exactly the same dot pattern over every gray level. In addition, the dots provided for the (4, 4) pixel of each element pixel block of 16×16 pixels form a dot pattern for the first gray level, which coincides with the dot pattern for the first gray level of the dispersed-dot dithering method.

The dots each placed at the (12, 12) pixel of each element pixel block of the individual set of element pixel blocks having the same dot pattern are provided for the second gray level and their positions coincide with those of a part of dots for the second gray level of the dispersed-dot dithering method. A small pixel block of 7×7 pixels is provided in each of the other, unpainted element pixel blocks, and one of the 49 pixels is randomly selected for the second gray-level dot.

For the third and subsequent gray levels, dot patterns are formed according to step S5 in FIG. 5 using exactly the same items as in the first embodiment including the repulsive potentials, and a mask is then produced based on these dot patterns.

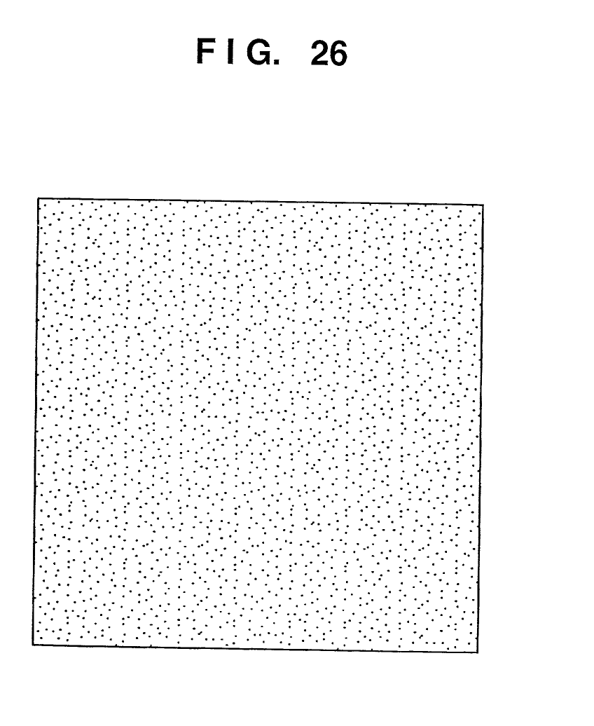

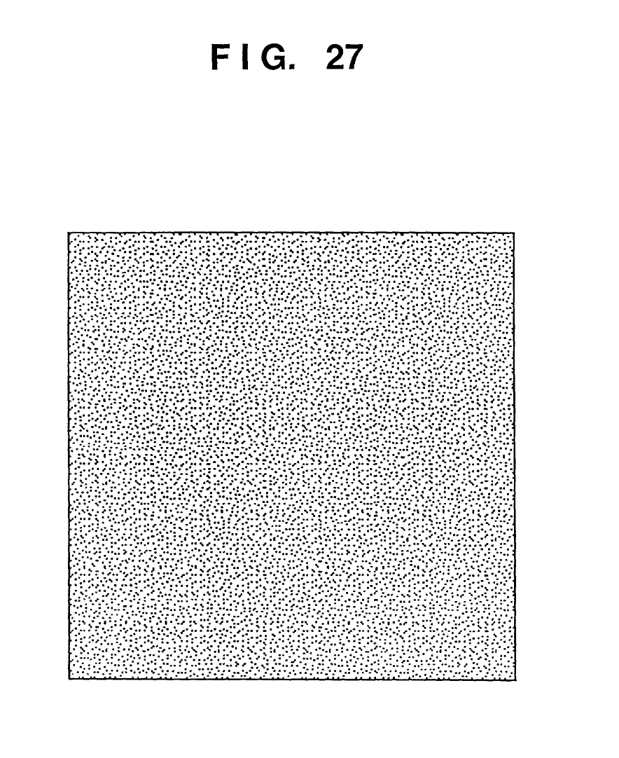

A mask created in this manner was used to output dot patterns for input images, each of a uniform density, on an image plane of 256×256 pixels by using the 600-dpi BJ printer. FIG. 26 shows a dot pattern for the eighth gray level, and FIG. 27 shows a dot pattern for the 32nd gray level. These figures show the dot patterns enlarged 10 times in both length and width of actually printed dot patterns obtained by using the 600-dpi BJ printer. The individual unit pixel blocks, each corresponding to the unit mask, are exactly one-fourth of these individual patterns in size, and the distributions of dots shown in FIGS. 26 and 27 evidently show the periodicity and/or artifacts caused by the unit mask itself.

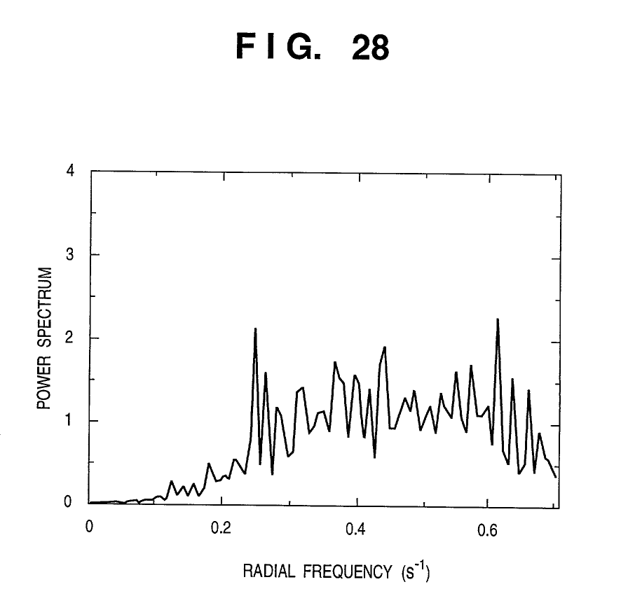

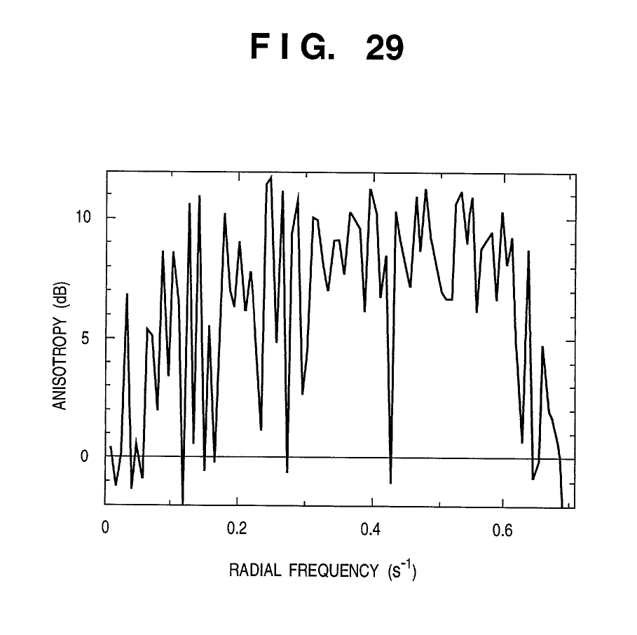

FIGS. 28 and 29 show the spatial frequency properties of the dot pattern of 128×128 pixels for the 32nd gray level generated using only the single unit mask according to this embodiment. FIG. 28 shows the one-dimensional power spectrum of the above dot pattern and also shows many isolated spectra having sharp peaks on the noise component. Compared to the first embodiment (FIG. 19), the peaks of the isolated spectra become relatively higher than the noise component. This is because the number of sets of element pixel blocks having the same dot pattern was doubled to increase the periodicity.

FIG. 29 shows the anisotropy spectrum of the dot pattern for the 32nd gray level generated using the single unit mask according to the second embodiment. In this figure, the average anisotropy value itself exceeds 4 dB, which indicates as being especially anisotropic, and is a little over 6 dB, and the maximum value exceeds 10 dB, which indicates as being extremely anisotropic, and the largest of the maximum values reaches a little under 12 dB. Both the average and maximum values are higher than the levels that can be determined to exhibit the non-blue noise properties even in the error diffusion method. Therefore, this dot pattern evidently has the non-blue noise properties.

The coincidence between the frequencies indicating high anisotropy and the frequencies of the isolated spectra in the one-dimensional power spectrum indicates that the spectra are attributable to the periodicity of the mask itself.

Such spectral properties are not limited to the 32nd gray level but are found in all gray levels, so the unit mask according to this invention obviously has the non-blue noise properties in the all gray levels of dot patterns.

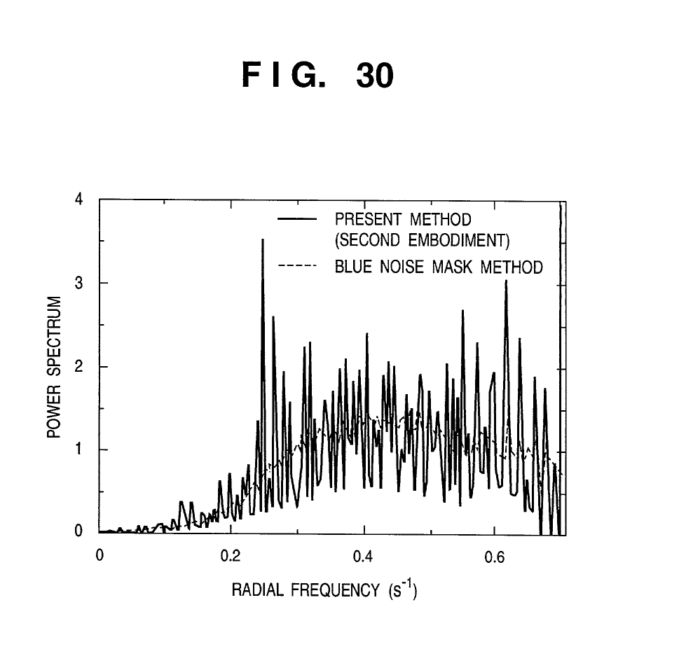

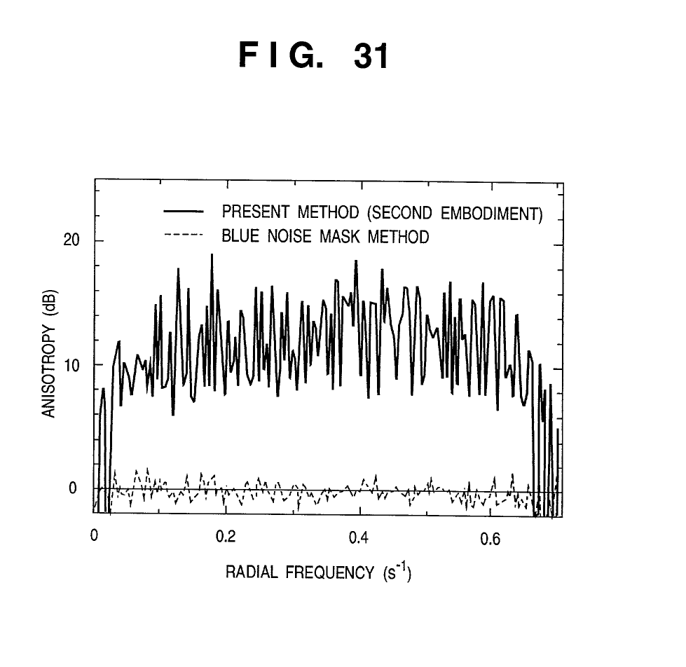

FIGS. 30 and 31 show the spatial frequency properties of the dot pattern for the 32nd gray level generated using the unit mask according to this embodiment, on an image plane of 256×256 pixels, which is a standard for evaluating spectra. FIG. 30 shows the one-dimensional power spectrum of the above dot pattern. In this figure, the solid line shows this embodiment, while the broken line shows the case of the 256×256 blue noise mask. This figure shows that, compared to the case of using only a single unit mask, the noise component is largely decreased with much increasing the isolated spectra having higher and sharper peaks.

FIG. 31 shows the anisotropy spectrum of the above dot pattern. In this figure, the solid line shows this embodiment and the broken line shows the case of the 256×256 blue noise mask. This embodiment exhibits an extremely high anisotropy of about 13 dB as an average value and provides a lot of spectra having a maximum value exceeding 15 dB, some of them close to 20 dB.

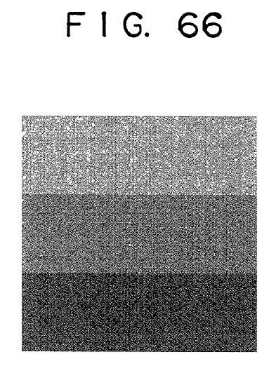

As described above, despite its high anisotropy equivalent to that of the dispersed-dot dithering method, this embodiment prevents periodic artifacts from being sensed, which are caused by the repetition of the same pattern as shown in the gray scale in FIG. 72 for the aforementioned 128×128 blue noise mask (FIG. 66 shows a part of a gray scale output using the mask according to the second embodiment and a 600 dpi printer).

In addition, when output images obtained respectively using the present mask and the 256×256 blue noise mask were compared using the input image having gradually changing tones in lower gray levels, the present mask exhibited a slightly better performance than that of the blue noise mask in reproducing the gradually changing tones. The high uniformity of the dot distribution according to this embodiment was also numerically verified.

As described above, the size of the mask generating visually pleasing dot patterns is only one-fourth of that of the 256×256 blue noise mask producing visually pleasing dot patterns. Besides, in the two sets of element pixel blocks having the same 16 dot patterns respectively, since every element mask corresponding to these 16 elements pixel blocks has the same threshold array, the number of element masks having an independent threshold array is 34. Since 34/256=0.13, the above size is substantially about one-eighth of that of the 256×256 blue noise mask rather than one-fourth. That is, by improving the method of reading data from the storage device, the storage requirement to store the mask according to this embodiment can be reduced to about one-eighth of that for a 256×256 blue noise mask.

These results of evaluations show that the mask according to this embodiment is not based on the scheme for the blue noise properties shown in FIG. 68 but on the new scheme shown in FIG. 1.

<Third embodiment>

A procedure for creating a mask having the features of the third embodiment will be described with reference to the flowchart in FIG. 5.

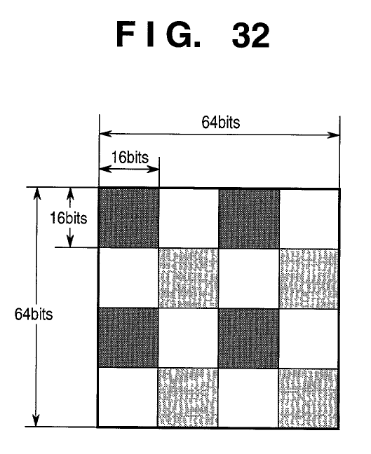

FIG. 32 shows the shape, the size, and the sets of element pixel blocks having the same dot arrangement of a unit pixel block corresponding to the unit mask according to the third embodiment. Every element pixel block of the set of four element pixel blocks painted dark gray or of the set of four element pixel blocks painted light gray has exactly the same dot pattern over all gray levels.

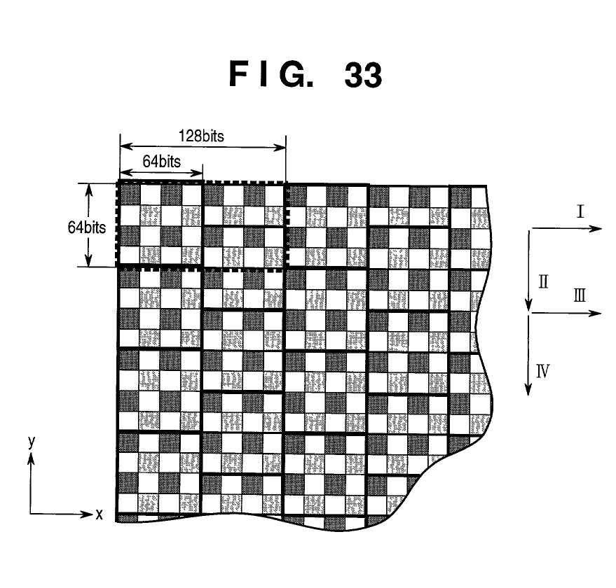

FIG. 33 shows a portion of the two-dimensional array of unit pixel blocks of 64×64 pixels each corresponding to the unit mask on an output image plane, where the array is determined in step S2 in FIG. 5. As is apparent from FIG. 33, the unit pixel blocks are arranged straight in the vertical direction (y direction), whereas in the horizontal direction (x direction), the blocks are arranged in such a way that the adjacent unit pixel block is offset by 32 pixels in the vertical direction. This arrangement is intended both to avoid the periodic structure being visually easily sensed as in a simple arrangement of the same small-scale patterns placed orderly in both horizontal and vertical directions and to reduce horizontally linear non-uniformity caused by non-uniform sheet feeding in conjunction with the orderly arrangement of the same small-scale patterns. To reduce horizontally linear non-uniformity more effectively in this similar manner, adjacent arrays of vertical unit pixel blocks should be offset from each other, for example, by 16 pixels always in the positive direction of the y axis.

On the other hand, to effectively reduce vertically linear non-uniformity, adjacent arrays of horizontal unit pixel blocks should be offset from each other, for example, by 16 pixels always in the positive direction of the x axis.

In this embodiment, however, a mask corresponding to the rectangular pixel block of 64×128 pixels shown by the thick dashed line in FIG. 33 is actually used for convenience. This figure shows, on the right, the order in which the mask is repeatedly scanned in generating a large size dot pattern.

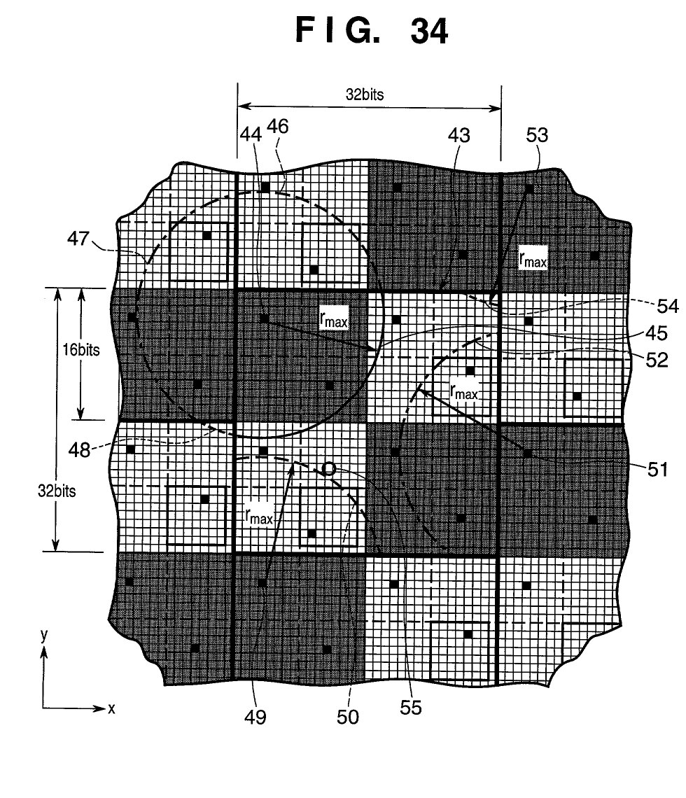

Steps S3 and S4 in FIG. 5 according to the third embodiment will be described with reference to FIG. 34. For simplicity, this embodiment will be described in accordance with applying a small 32×32 unit mask size. Consequently, the size of the unit pixel block is 32×32 pixels as shown in FIG. 34. Furthermore, horizontally adjacent unit pixel blocks are offset by 16 pixels in the y direction. The set of element pixel blocks painted gray has exactly the same dot pattern over all gray levels.

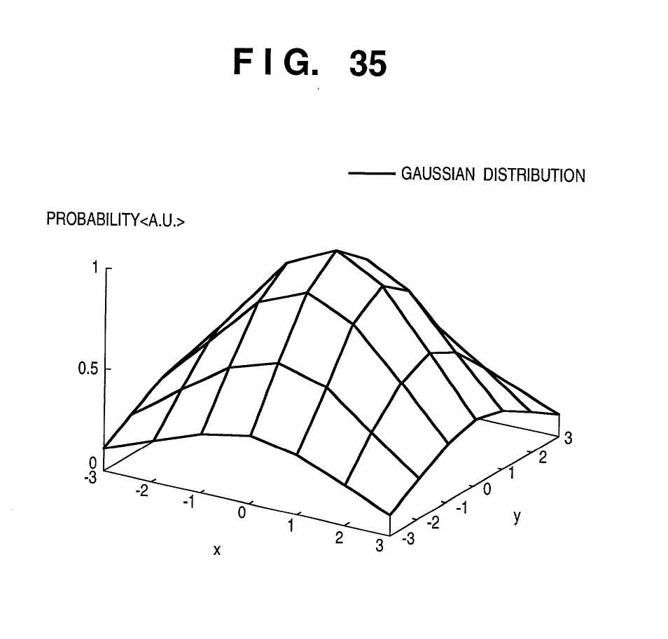

The dots each provided for the (4, 4) pixel of each element pixel block of 16×16 pixels form the dot pattern for the first gray level and coincide with the dot pattern for the first gray level of the dispersed-dot dithering method. The dots each provided for the (12, 12) pixel of each element pixel block of the set of element pixel blocks having the same dot pattern are for the second gray level and also coincide with the dots newly provided for the second gray level of the dispersed-dot dithering method. A small pixel block of 7×7=49 pixels is provided in each of the other, unpainted element pixel blocks, and one of the 49 pixels is randomly selected for the second gray level dot. All the 49 pixels, however, are not provided with the same probability of selection, but are weighted in a Gaussian manner as shown in FIG. 35 using the position of the central pixel as the origin so that pixels closer to the center are more possible to be selected.

The Gaussian function used in this weighting is given by the following equation.

W=e^{x}^{²}^{+y}^{²}^{/2τ}^{²} (where σ²=4). (6)

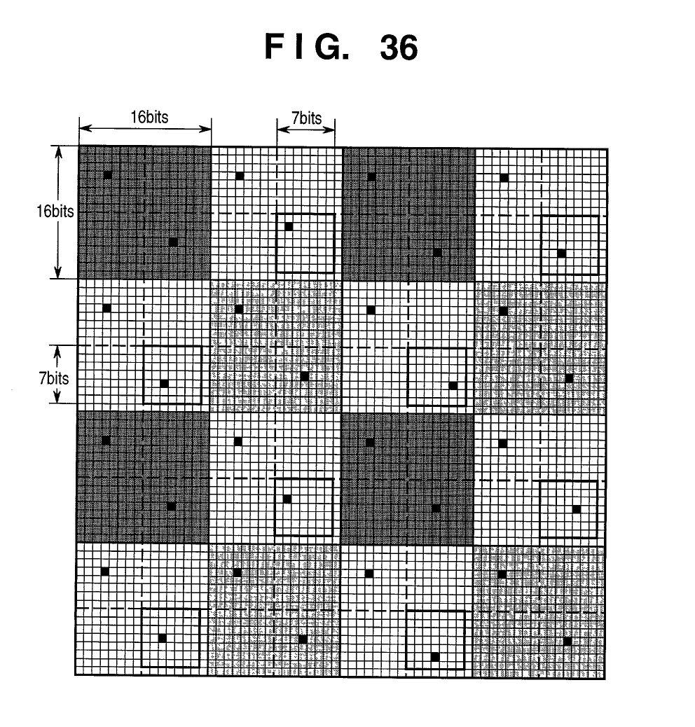

FIG. 36 shows the results of creation of dot patterns up to the second gray level for the unit pixel block shown in FIG. 32 using the above method. As described above, to make dot positions for the second gray level irregular, the dot positions are rather regulated by providing small pixel blocks of 7×7=49 pixels and further by weighting the pixels. This is because, when a mask is small, the number of irregularly positioned dots decreases and because the distribution of positions of the randomly selected dots rather yield deviation (from a random distribution) when regulated by simply providing the small pixel blocks, thereby allowing the periodicity caused by the repetition of the small-scale (inhomogeneous) dot pattern to be sensed more easily. Actually, in the second embodiment with a large-scale mask, there are 32 dots for the second gray level which are made irregular, requiring only regulation with the small pixel blocks. This embodiment, however, has only 8 dots for random positioning, so it is difficult to control the dots so that their positions are not deviated by simply regulating them with the small pixel blocks.

Returning to FIG. 34, a method for forming the dot pattern for the third gray level according to this embodiment is described. In contrast to the above embodiments in which the unit pixel blocks are arranged orderly in both horizontal and vertical directions on the output image plane, offsets among adjacent unit pixel blocks along their boundaries parallel to the sub-scanning direction occur in this embodiment, so a different method must be used to process a repulsive potential in the individual boundary.

With reference to FIG. 34 and taking as an example the dot 44 for the first gray level in the unit pixel block 43, a method for processing the repulsive potential given to this dot will be described.

The solid line arc 45 shows the boundary of the range, which is affected by this repulsive potential, inside of the unit pixel block 43. A portion of the potential that extends out from the upper boundary of the unit pixel block 43 and whose boundary is represented by the broken line arc 46 is shifted parallel into the block 43 without changing its shape until it abuts the lower boundary of the block 43, because there is no offset between the unit pixel blocks along the upper boundary. This shifted part of the potential is equal to the potential 50 inside the unit pixel block 43, which is affected by the repulsive potential given to the dot 49 for the first gray level in the unit pixel block located under and adjacent to the unit pixel block 43, where the dot 49 corresponds to the dot 44 for the first gray level in the block 43.

The portion 47 of the potential, that extends into the unit pixel block located obliquely above and on the left of the unit pixel block 43 in such a way to be offset therefrom by 16 pixels and represented by the single-point chain line arc, is shifted so as to be overlapped with the potential 52 in the unit pixel block 43, which is affected by the repulsive potential given to the dot 51 in the unit pixel block located obliquely below and on the right of the unit pixel block 43 in such a way as to be offset therefrom by 16 pixels, where the dot 51 corresponds to the dot 44 for the first gray level in the block 43.

The portion 48 of the potential, that extends into the unit pixel block located obliquely below and on the left of the unit pixel block 43 in such a way to be offset therefrom by 16 pixels and represented by the dotted line arc, is shifted so as to be overlapped with the potential 54 in the unit pixel block 43, which is affected by the repulsive potential given to the dot 53 in the unit pixel block located obliquely above and on the right of the unit pixel block 43 in such a way as to be offset therefrom by 16 pixels, where the dot 53 corresponds to the dot 44 for the first gray level in the block 43. In this manner, the processing of the repulsive potential applied to the dot 44 is completed.

The repulsive potential is applied to each of the other dots provided inside the unit pixel block 43, and the first dot for the third gray level is provided to the pixel 55 with the lowest overall repulsive potential in the unit pixel block 43. A new dot is basically provided, one at a time, to each of the remaining element pixel blocks in such a way that the repulsive potential applied to each new dot is accumulated to produce each new overall repulsive potential, thereby completing the dot pattern for the third gray level.

Although FIG. 34 uses the small-scale unit pixel blocks and repulsive potentials in order to simply describe the method for processing the repulsive potentials in the boundaries among the adjacent unit pixel blocks according to this embodiment, this method can be applied to the unit pixel block in FIG. 36 and the actual repulsive potential for the third gray level in order to create a dot pattern for the third gray level according to this embodiment.

Thus, for each of the third and subsequent gray levels, despite the change in the method for processing repulsive potentials at the boundaries, dot patterns are formed according to step S5 in FIG. 5, which is described in detail in the second embodiment, and a mask is produced based on these dot patterns.

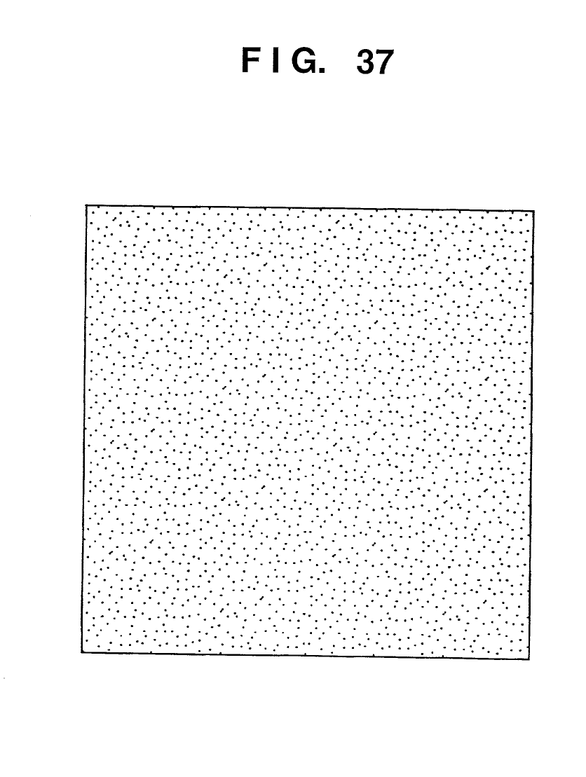

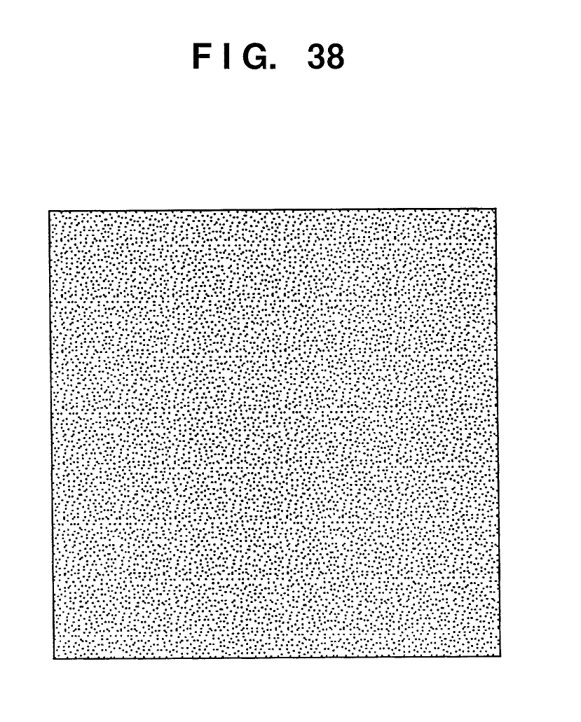

A mask created by this manner was used to output dot patterns for input images, each of a uniform density, on an image plane of 256×256 pixels by using a 600-dpi BJ printer. FIG. 37 shows a dot pattern for the 8th gray level, and FIG. 38 shows a dot pattern for the 32nd gray level. These figures show the dot patterns enlarged 10 times in both length and width of actually printed dot patterns obtained by using the 600-dpi BJ printer. The unit pixel blocks corresponding to the unit mask of 64×64 pixels are one-sixteenth of these patterns in size, and the distribution of dots shown in FIGS. 37 and 38 evidently show periodicity and/or artifacts caused by the unit mask itself.

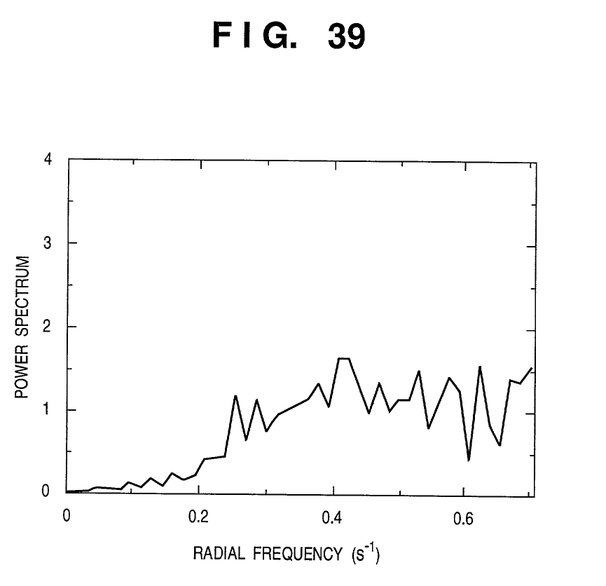

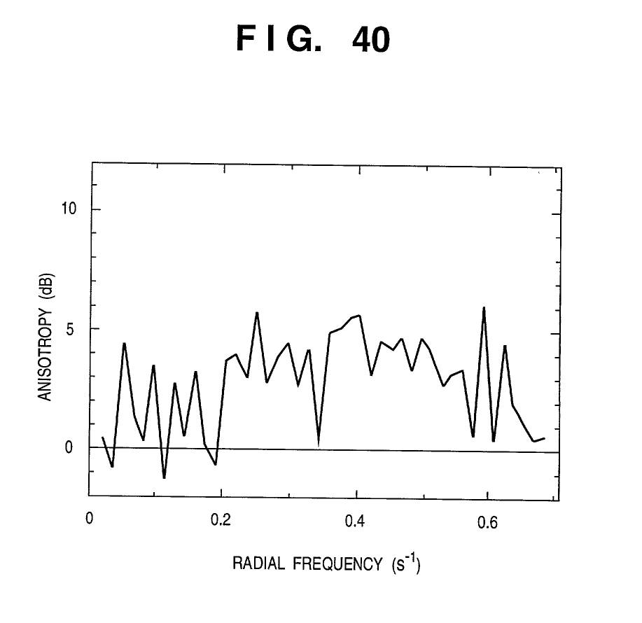

FIGS. 39 and 40 show the spatial frequency properties of the dot pattern (64×64 pixels) for the 32nd gray level generated using a single unit mask according to this embodiment. FIG. 39 shows the one-dimensional power spectrum of the above dot pattern and also shows many isolated spectra having peaks on a noise component.

FIG. 40 shows the anisotropy spectrum of the above dot pattern. This figure shows an average value of a little over 3 dB and a large number of spectra having maximum values exceeding 4 dB, which are evaluated to be an especially anisotropic level in the mask method. Since there are also spectra each having a maximum value of about 6 dB, this dot pattern definitely has the non-blue noise properties. If the frequencies of the peaks in the one-dimensional power spectrum coincide with the frequencies of the peaks in the anisotropy spectrum, then, spectra having these frequencies such as, for example, 0.24/s and 0.41/s are attributable to the periodicity of the mask itself.

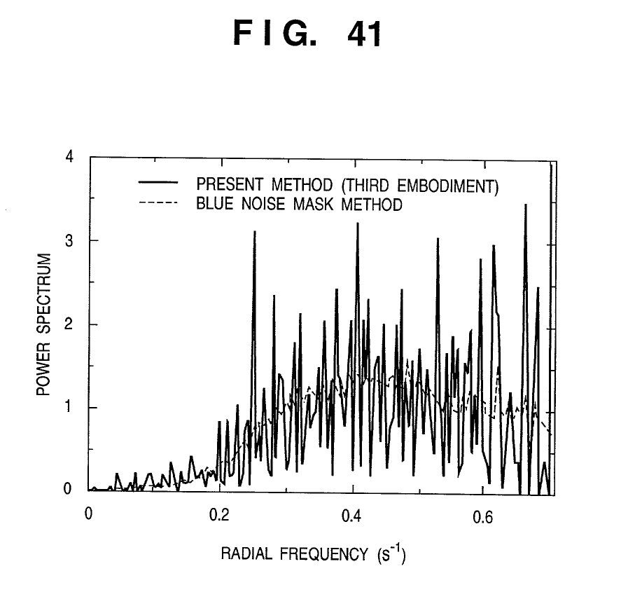

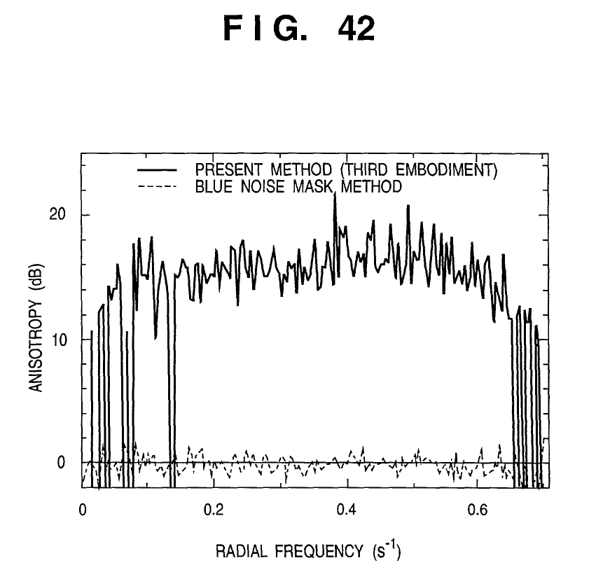

Such spectrum properties are not limited to the 32nd gray level but are found in all gray levels, so the unit mask according to this embodiment obviously has the non-blue noise properties in the all gray levels of dot patterns. FIGS. 41 and 42 show the spatial frequency properties of the dot pattern for the 32nd gray level generated using the unit mask according to this embodiment, on an image plane of 256×256 pixels, which is a standard for evaluating spectra. FIG. 41 shows the one-dimensional power spectrum of the above dot pattern. In this figure, the solid line shows this embodiment, while the broken line shows the case of the 256×256 blue noise mask. There are a very low noise component and a large number of isolated spectra having high sharp peaks.

FIG. 42 shows the anisotropy spectra of the above dot patterns. In this figure, the solid line shows this embodiment and the broken line shows the case of the 256×256 blue noise mask. This embodiment exhibits a very high anisotropy value of about 16 dB as an average value and provides several spectra exceeding 20 dB as the maximum values. Since similar anisotropy spectra are observed in the other gray levels, this embodiment has highest anisotropy in the above embodiments.

As described above, despite its very high anisotropy equivalent to that of the dispersed-dot dithering method, this embodiment does not show periodic artifacts which are caused by the repetition of the same pattern as shown in the gray-scale in FIG. 73 for the aforementioned 64×64 blue noise mask.

In addition, when output images obtained respectively using the present mask and the 256×256 blue noise mask were compared using the input image having gradually changing tones in lower gray levels, the present mask exhibited a slightly better performance than that of the blue noise mask in reproducing the gradually changing tones. The high uniformity of the dot distribution according to this embodiment was also numerically verified.

As described above, although the mask generating visually pleasing dot patterns according to this embodiment actually has a size of 64×128 pixels as shown in FIG. 33, the unit mask of 64×64 pixels can be used by improving the method for reading data from the storage device.

This size is one-sixteenth of the size of a 256×256 blue noise mask producing visually pleasing dot patterns. Besides, since the two sets of 4 element masks corresponding to 4 element pixel blocks having the same dot patterns, respectively, have exactly the same threshold array, the number of element masks each having an independent threshold array is 10. Accordingly, 10/256=0.039, so the above size is substantially one-twenty-fifth of that of the 256×256 blue noise mask rather than one-sixteenth. That is, by improving the method of reading data from the storage device, the storage requirement to store the mask according to this embodiment can be reduced to about one-twenty-fifth of that for the 256×256 blue noise mask.

These results of evaluations prove that the mask according to this embodiment is not based on the scheme for the blue noise properties shown in FIG. 68 but on the new scheme shown in FIG. 1.

<Fourth embodiment>

A procedure for creating another mask having the features of this embodiment will be described.

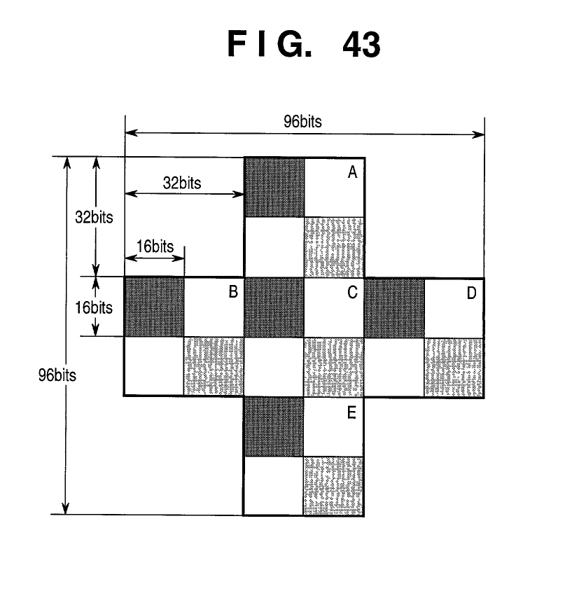

FIG. 43 shows the shape, the size, and the sets of element pixel blocks having the same dot arrangement of a unit pixel block corresponding to an initially assumed unit mask according to the fourth embodiment. According to this embodiment, the mask is shaped like a cross as is apparent from the figure, thereby giving a tilt between the main scanning direction of the printer and the array direction of the mask, as shown in FIGS. 83 and 84 cited from the prior art (U.S. Pat. No. 4,752,822) for clustered-dot dithering. That is, although the third embodiment allows the array of the mask to be shifted in only the x or y direction of the output image plane, this embodiment enables it to be two-dimensionally shifted to cope with non-uniformity in both the main scanning and sub-scanning directions.

In FIG. 43, every element pixel block of the set of five element pixel blocks painted dark gray or of the set of five element pixel blocks painted light gray has exactly the same dot pattern over all gray levels. Thus, although the total number of element masks is 20, since there are 12 independent element masks, the substantial storage capacity required to store a unit mask in this embodiment is only about one-twentieth of that for a 256×256 blue noise mask producing visually pleasing dot patterns.

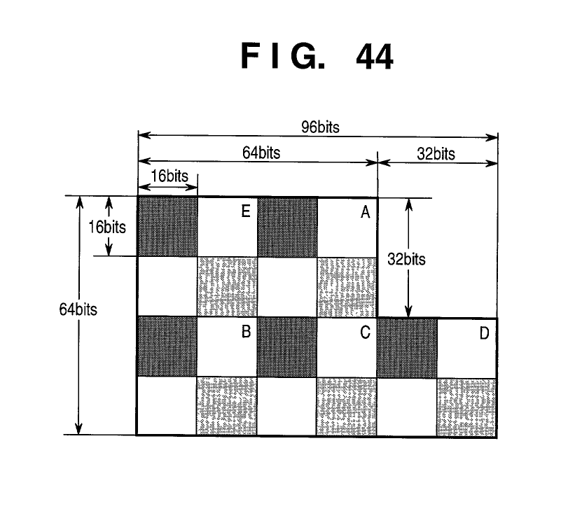

FIG. 44 shows the shape, the size, and the sets of element pixel blocks having the same dot arrangement of a unit pixel block corresponding to an actually produced unit mask according to the fourth embodiment. When 2×2=4 element pixel blocks are considered to be one block, the unit pixel block consists of 5 such blocks corresponding to blocks A through E shown in FIG. 43. Accordingly, exactly the same dot pattern as that produced by the unit mask shown in FIG. 43 can be obtained by two-dimensionally arranging this mask, but due to its smaller number of sides forming the external shape of the mask, the mask in FIG. 44 enables repulsive potentials in the boundaries to be processed simpler during mask creation.

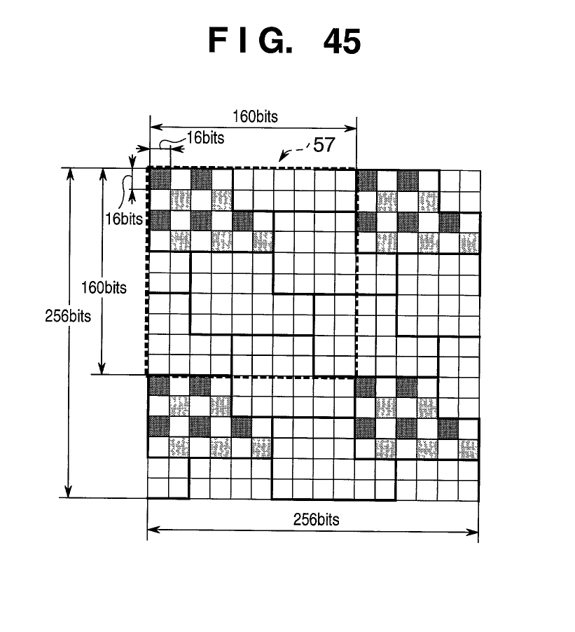

FIG. 45 shows how the unit pixel blocks according to the fourth embodiment are two-dimensionally arranged on an output image plane. As is easily understandable from the Fig., this embodiment can use a square mask of 160×160 elements, which is correspondingly shown by the thick dashed line 57 in the pixel domain.

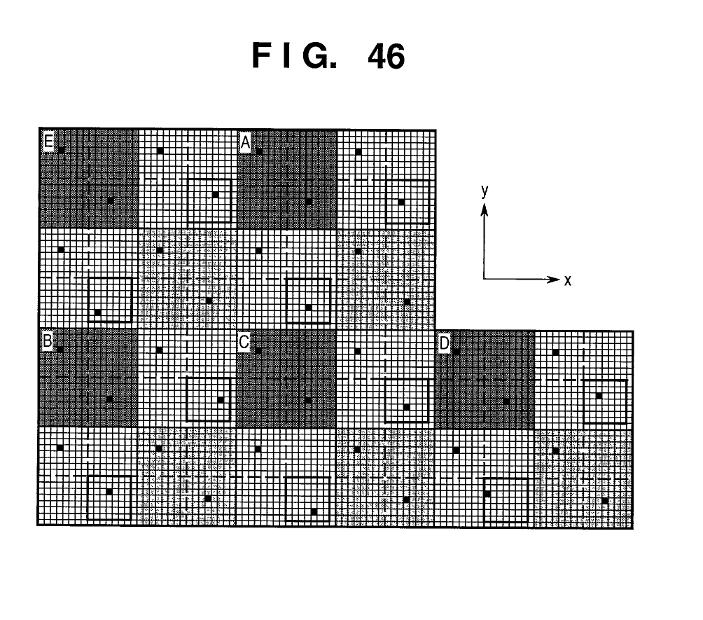

Steps S3 and S4 in FIG. 5 according to this embodiment will be described with reference to FIG. 46. For the first gray level, a dot is provided to the (4, 4) pixel of every element pixel block. Then, for each set of element pixel blocks having the same dot pattern, a dot for the second gray level is provided to the (12, 12) pixel. These dot positions coincide with dot positions for the second gray level of the dispersed-dot -a dithering method. The method for introducing irregularity (perturbation) into the position of a dot for the second gray level in each of the element pixel blocks having individual independent dot patterns is exactly the same as in the third embodiment. That is, a small block of 7×7 pixels centered at the (12, 12) pixel is provided in each of these element pixel blocks, and the pixels contained in this small block are weighted in a Gaussian manner before one of the pixels is randomly selected. In this manner, the dot pattern for the second gray level for the unit pixel block can be determined as shown in FIG. 46.

As in the above embodiment, the two-dimensional array of unit pixel blocks according to this embodiment is not simple, resulting in a complicated method for processing the repulsive potentials extending out from the boundaries. However, the basic method, which has been described above in detail, can be used in this case.

For the third and subsequent gray levels, dot patterns can be created according to step S5 and subsequent steps in FIG. 5 as in the third embodiment, thereby completing a dither matrix.

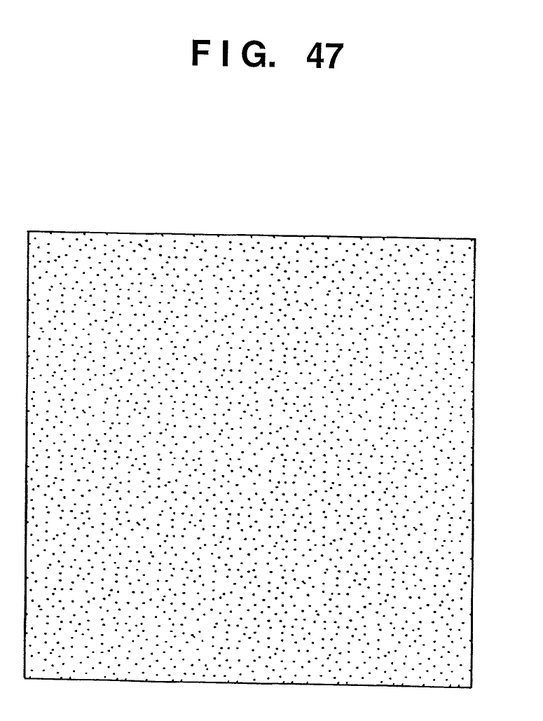

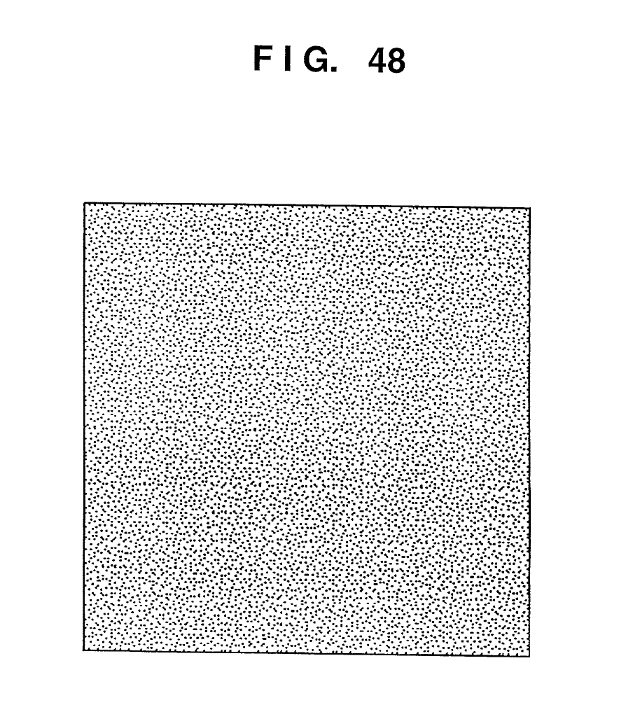

A mask created in this manner was used to output dot patterns by using a 600-dpi BJ printer for input images each of a uniform density on an image plane of 256×256 pixels. FIG. 47 shows a dot pattern for the eighth gray level, and FIG. 48 shows a dot pattern for the 32nd gray level. These figures show the dot patterns enlarged 10 times in both length and width of the actually printed dot patterns obtained by using the 600-dpi BJ printer. The distributions of dots shown in FIGS. 47 and 48 evidently show periodicity and/or artifacts caused by the unit mask itself.

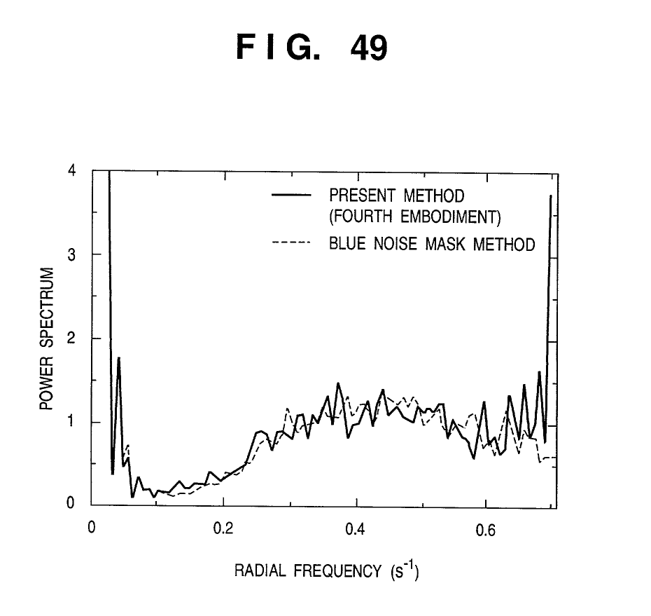

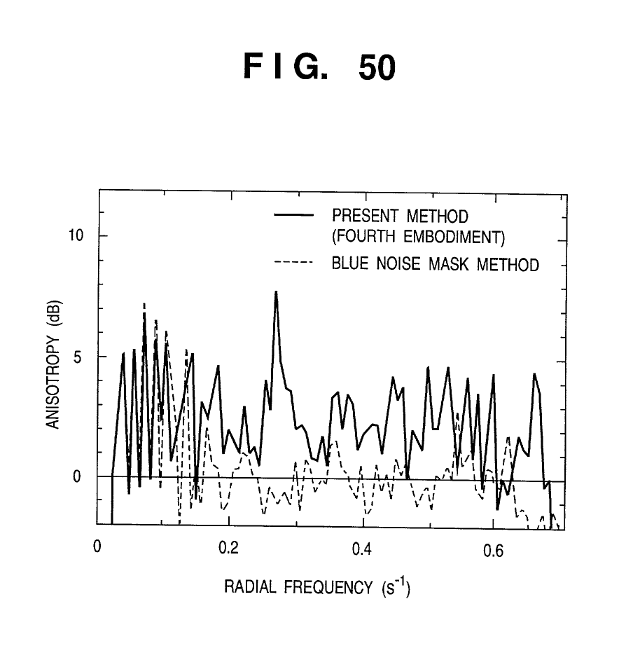

FIGS. 49 and 50 show the spatial frequency properties of the dot pattern for the 32nd gray level generated using a single unit mask according to this embodiment. Since the spatial frequency properties are usually evaluated using the Fast Fourier Transformation (FFT) algorithm, the pixel block for the evaluation must have a size of 2ⁿ×2ⁿ pixels, where n is a positive integer. Thus, in case of this embodiment, the properties of the above single mask pattern included in a 128×128 pixels block were evaluated assuming that there is no dot pattern outside the mask pattern.

Since the blue noise mask method, which is used as an example for comparison, uses Fast Fourier Transformation to create masks, it is very difficult for the blue noise mask method to design a mask such as the one generated according to this embodiment.

Accordingly, for convenience, a dot pattern for comparison was cut out from the original dot pattern generated using the blue noise mask of 128×128 pixels in such a way that the cutout dot pattern was shaped like the unit pixel block according to this embodiment.

FIG. 49 shows the one-dimensional power spectra of the above dot patterns for the 32nd gray level, which were compared and evaluated as described above, and FIG. 50 shows the anisotropy spectra of the above dot patterns. The one-dimensional power spectra show that both methods have very high spectra at frequencies lower than 0.1/s or 0.15/s. This is because the dot patterns each in the unit pixel block that was not square were evaluated using the image size of 128×128 pixels, larger than these dot patterns. Thus, the spectra in the frequency region higher than or equal to 0.2/s which is not substantially affected by these spectra are used for comparison.

For the one-dimensional power spectrum, this embodiment has relatively higher and sharper isolated spectra compared to those in the blue noise mask method. With respect to the anisotropy spectrum of the frequency region higher than or equal to 0.2/s, the blue noise mask method has an average value of 0 dB and is thus isotropic. Since even a spectrum exhibiting a high anisotropy shows the maximum value of about 3 dB or lower, the value of the blue noise mask method is almost equivalent to that of a spectrum exhibiting the highest anisotropy in the Perturbed Error Diffusion method. On the other hand, the anisotropy spectrum of this embodiment has an average value of a little over 2 dB, many spectra having maximum values higher than 4 dB, which are evaluated to be an especially anisotropic level, and a spectrum with a maximum value exceeding 6 dB.

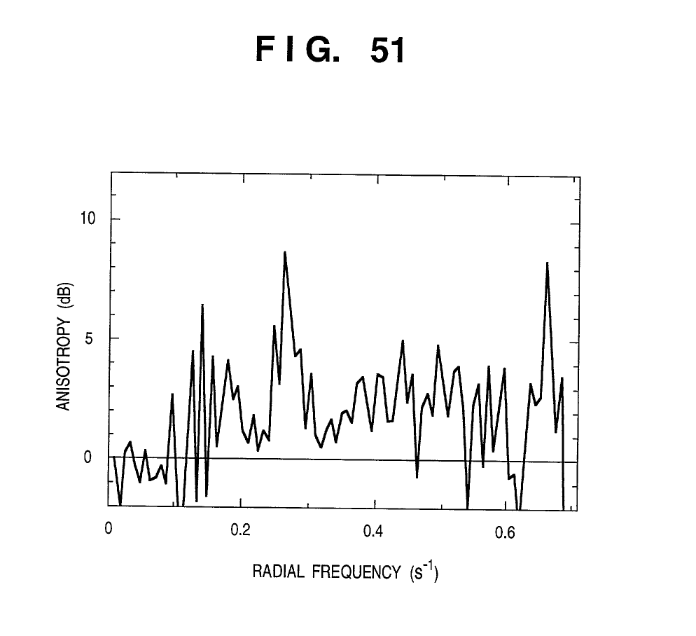

Accordingly, the above dot pattern for the 32nd gray level in this embodiment is obviously anisotropic and has the non-blue noise properties. For reference, FIG. 51 shows the result of subtraction of the anisotropy spectrum of the blue noise mask method from the anisotropy spectrum of this embodiment for the purpose of eliminating the effects of the specific shape of the unit pixel block. If the blue noise mask method is assumed to be isotropic, this embodiment exhibits higher anisotropy values than those in FIG. 50.

Such spectral properties are not limited to the 32nd gray level but are found in all gray levels, so the unit mask according to this embodiment obviously has the non-blue noise properties in the all gray-levels of dot patterns.

Another evaluation point also verifies the non-blue noise properties of the mask according to this embodiment. That is, due to its size being larger than the unit mask according to the third embodiment, the unit mask according to this embodiment has higher periodicity, thus, higher anisotropy. Since the mask according to the third embodiment exhibits the non-blue noise properties, the mask according to this embodiment naturally has the non-blue noise properties.

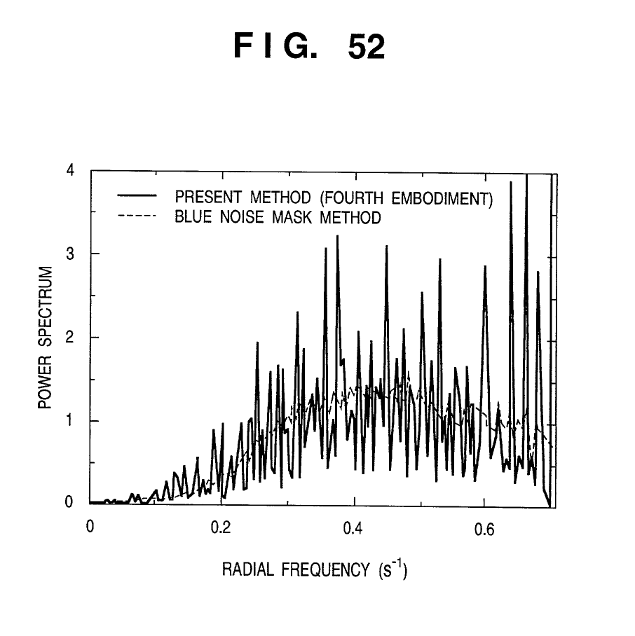

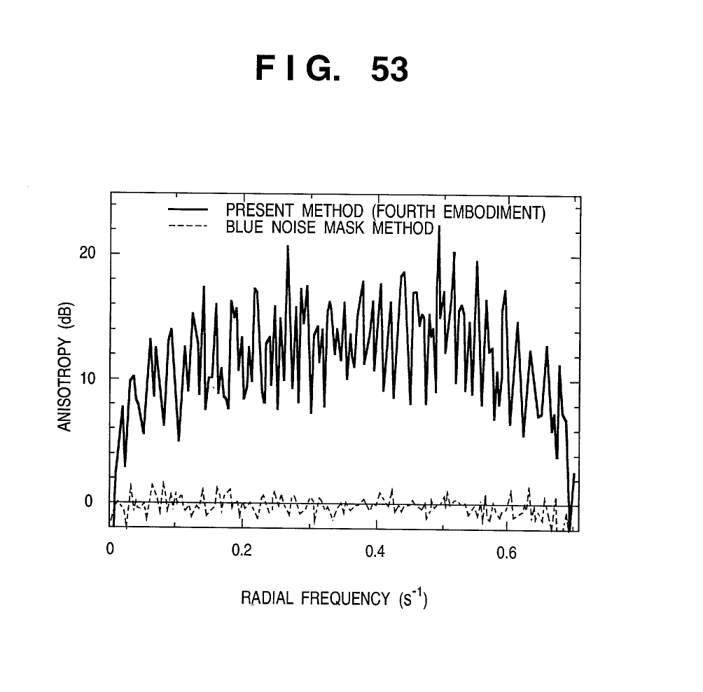

FIGS. 52 and 53 show the spatial frequency properties of the dot patterns of the 32nd gray level generated using the above unit mask of this embodiment and the 256×256 blue noise mask, on each image plane of 256×256 pixels, which is a standard for evaluating spectra. FIG. 52 shows the one-dimensional power spectra of the above dot patterns. In this figure, the solid line shows this embodiment, while the broken line shows the case of the 256×256 blue noise mask. This embodiment includes a very low noise component and is composed of isolated spectra having high sharp peaks.

FIG. 53 shows the anisotropy spectra of the above dot patterns. In this figure, the solid line shows this embodiment and the broken line shows the case of the 256×256 blue noise mask. This embodiment exhibits an extremely high anisotropy of about 12 dB as an average value and provides several spectra exceeding 20 dB.

Such spectral properties are not limited to the 32nd gray level but are found in all gray levels, so obviously, the dot patterns generated using the mask according to this embodiment are not blue noise patterns in the all gray levels.

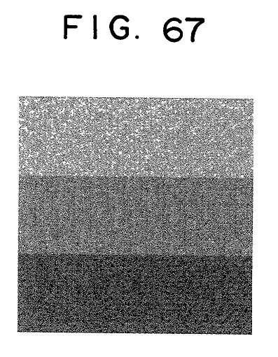

As described above, despite its extremely high anisotropy similar to that of the dispersed-dot dithering method, this embodiment substantially prevented viewers from sensing periodic artifacts caused by the repetition of each identical pattern as shown in the gray scale in FIG. 73 for the blue noise mask of 64×64 pixels (FIG. 67 shows a gray scale obtained using the mask according to this embodiment).

In addition, when output images obtained respectively using the mask of the present embodiment and the 256×256 blue noise mask were compared concerning the input image having gradually changing tones in lower gray levels, the present mask exhibited a slightly better performance in reproducing the gradually changing tones. The high uniformity of the dot distribution according to this embodiment was also numerically verified.

These results of evaluations indicate that the mask according to this embodiment is not based on the scheme for the blue noise properties shown in FIG. 68 but on the new scheme shown in FIG. 1.

<Fifth embodiment>

A procedure for creating yet another mask having the features of this embodiment will be described.

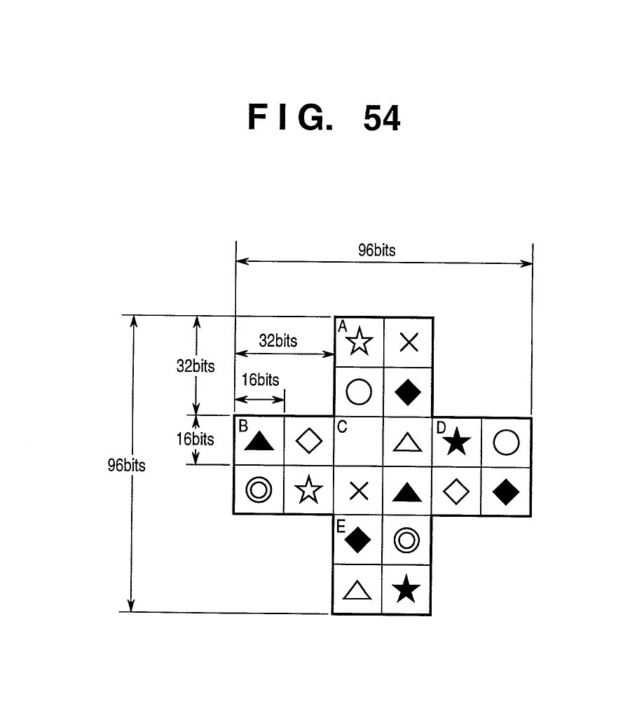

FIG. 54 shows the shape, the size, and the sets of element pixel blocks having the same dot arrangement of a unit pixel block corresponding to an initially assumed unit mask according to the fifth embodiment. Since the mask is shaped like a cross as in the fourth embodiment, this embodiment can simultaneously cope with the non-uniformity in both the main scanning and sub-scanning directions.

In FIG. 54, the individual element pixel blocks are mutually distinguished using patterns such as ☆ and ♦, and the sets of element pixel blocks having the same pattern individually have the same dot pattern over all gray levels. Although in this example, the total number of element pixel blocks is 20, there are 8 sets of element pixel blocks having the same pattern. Thus, this embodiment includes 10 independent element masks, and this value, which is equal to that of the third embodiment, is smaller than those of the other illustrated embodiments. Consequently, the storage capacity required to store the unit mask is only about one-twenty-fifth of that for a 256×256 blue noise mask.

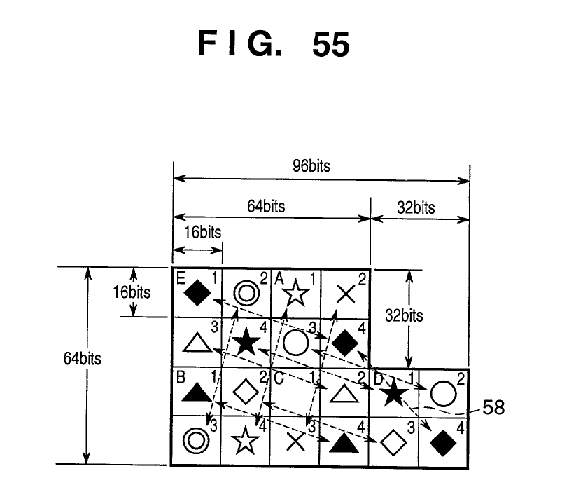

FIG. 55 shows the shape, the size, and the sets of element pixel blocks having the same dot arrangement of a unit pixel block corresponding to an actually produced unit mask according to the fifth embodiment. This figure uses dashed arrows to show the locations of sets of element pixel blocks each having exactly the same dot pattern, and shows that the individual locations conform to certain periodic properties except for one set shown by arrow 58.

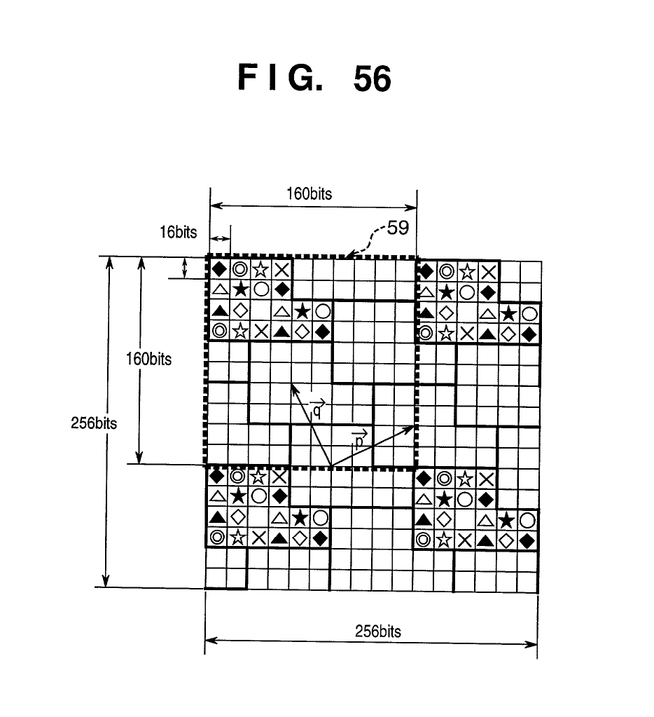

FIG. 56 shows how the unit pixel blocks according to the fifth embodiment are two-dimensionally arranged on an output image plane. This array is exactly the same as in the fourth embodiment and a square mask of 160×160 elements can also be used as shown by the thick dashed line 59 in the pixel domain.

This embodiment differs from the fourth embodiment in the method for determining a dot pattern for the second gray level.

In general, when a mask is small and its mask pattern is not uniform, periodic artifacts appear in the direction of the arrangement of unit pixel blocks. If the arrangement direction according to this embodiment is represented using vectors \vec{p} and \vec{q}, stripe patterns appear most probably in the directions parallel to \vec{p} and \vec{q}. \vec{p} and \vec{q} represent the direction and distance in and over which a unit pixel block moves parallel toward another adjacent unit pixel block until they overlap each other, and these vectors are mutually orthogonal.

In addition, the pixels can be located only at lattice points parallel to the x and y axes and the dots for the first gray level are in fact regularly arranged on such lattice points, so stripe patterns are tend to appear in these two directions next to the \vec{p} and \vec{q} directions.

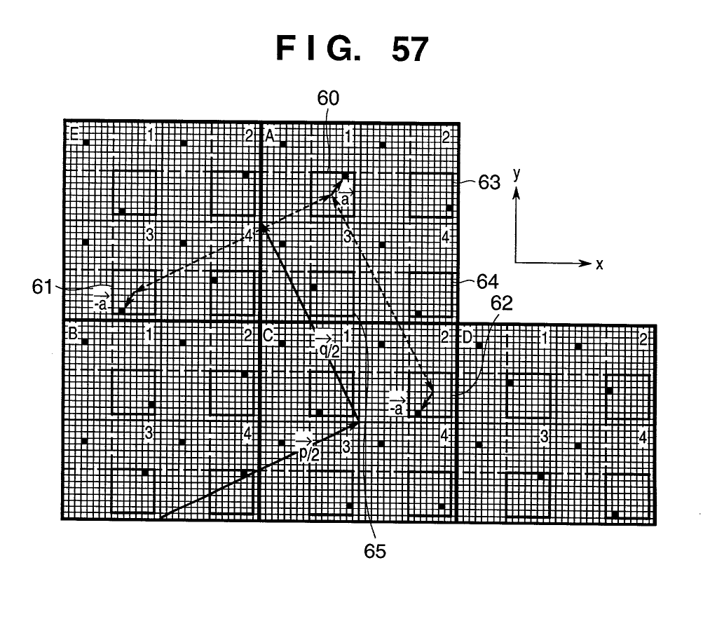

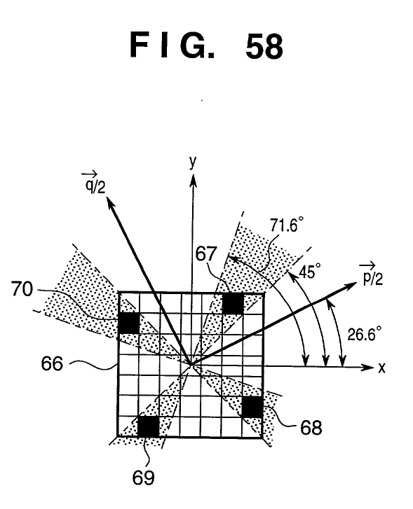

A method for determining a dot pattern for the second gray level in such a way as to prevent such stripe patterns from appearing in this embodiment will be described with reference to FIGS. 57 and 58.

FIG. 57 is a drawing for describing steps S3 and S4 in the flowchart in FIG. 5 according to the fifth embodiment. The (4, 4) pixel of each element pixel block is the dot for the first gray level, and the dot for the second gray level has been provided in each of the small block of 7×7 pixels centered at the (12, 12) pixel. These individual dots for the second gray level have not been randomly determined from the 7×7=49 pixels of each small block but have been selected from one of the predetermined four pixels according to a specific rule. The rule of this selection will be described with reference to FIG. 58 taking, as an example, two small blocks 60 and 61 located on a straight line parallel to the vector \vec{p} and two small blocks 60 and 62 located on a straight line parallel to the vector \vec{q} (FIG. 57).

In FIG. 57, when the small blocks 60 and 61 are seen from the p direction while the small blocks 60 and 62 are seen from the \vec{q} direction, the pixels individually located at an equal distance from the centers of the respective small pixel blocks as seen from either direction should be located in the direction that divides the angle between \vec{p} and \vec{q} into two.

In addition, when the respective small blocks are seen from the directions of the x and y axes, the pixel located at an equal distance from the centers of the respective small pixel blocks as seen from either direction should also be located in the direction that divides the angle between the x and y axes into two.

FIG. 58, illustrating the above considerations, shows a drawing for further describing a rule for selecting one pixel from a small pixel block where a dot is placed for the second gray level according to the fifth embodiment. In this figure, the center of the small pixel block 60 is used as an origin for an xy coordinate system, and two vectors are drawn in this system. In the first quadrant, a line dividing the angle between the two coordinate axes and a line dividing the angle between the two vectors are drawn as single-point chain lines. This similarly applies to the other quadrants. Only one pixel can be selected from the small block, so it can be selected from an area lying between the two bi-sectors in each quadrant. Then, four pixels, for example, 67, 68, 69, and 70, can be selected from the respective quadrants.

Thus, when the pixel 67 in FIG. 58 is determined to correspond to the pixel of the small block 60 in FIG. 57 to which the dot for the second gray level is to be provided and its position is represented using the vector \vec{a}, pixels located at (−\vec{a}) are selected from the small blocks 61 and 62 in order to avoid a one-sided dot distribution.

In the block A, the pixels corresponding to pixels 68, 69, and 70 located in the remaining quadrants, in FIG. 58, are individually selected from the three remaining small blocks 63, 64, and 65, in FIG. 57, also in order to avoid one-sided dots as seen from the two directions. According to the above selection of each individual pixel, two pixels, which should individually be selected in two specific small blocks each in a block other than the block A, are determined. In the other small blocks in the above blocks other than A, a similar determination method is used to select a pixel corresponding to one of the four pixels in FIG. 58. If such a method is not applicable, a pixel corresponding to one of the four pixels in FIG. 58 is selected in such a way as to avoid one-sided dots as seen from the two directions. FIG. 57 shows a state in which all dots for the second gray level have been provided to the all of the element pixel blocks.

In contrast to the order of the steps in algorithm shown in FIG. 5, this embodiment determines individual positions of dots for the second gray level one by one and then finally determines the sets of element pixel blocks having the same dot pattern as shown in FIG. 55. For example, the first element pixel block in the block A and the fourth element pixel block in block B are grouped into one set, and the third element pixel block in the block E and the second element pixel block in block C are grouped into one set. In this manner, the respective sets are determined to obtain the combinations shown in FIG. 55.

For the third and subsequent gray levels, dot patterns can be formed according to the step S5 and subsequent steps in FIG. 5 as in the third or fourth embodiment, thereby completing a dither matrix.

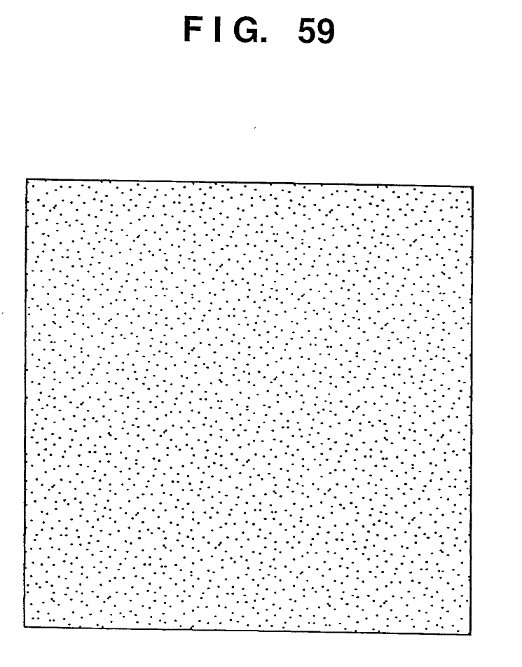

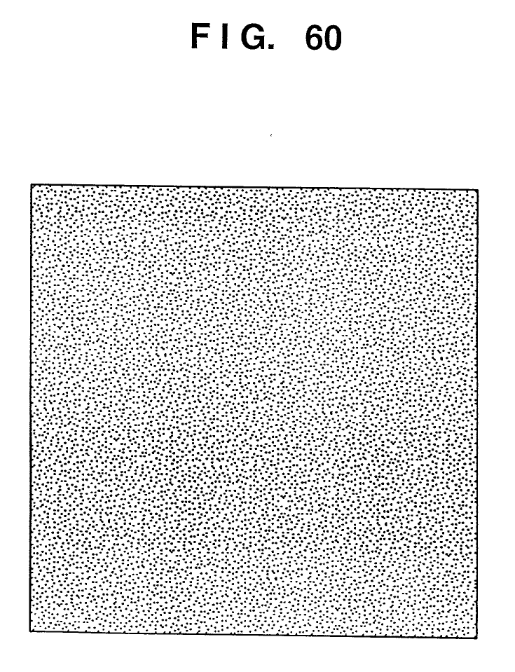

A mask created in this manner was used to output dot patterns for input images each of a uniform density on an image plane of 256×256 pixels by using a 600-dpi BJ printer. FIG. 59 shows a dot pattern for the eighth gray level, and FIG. 60 shows a dot pattern for the 32nd gray level. These figures show the dot patterns enlarged 10 times in both length and width of the actually printed dot patterns obtained by using the 600-dpi BJ printer. Of the third and subsequent embodiments using the small-scale masks, this embodiment provides the highest uniformity and prevents non-uniform dot distributions parallel to the x or y axis as originally intended.

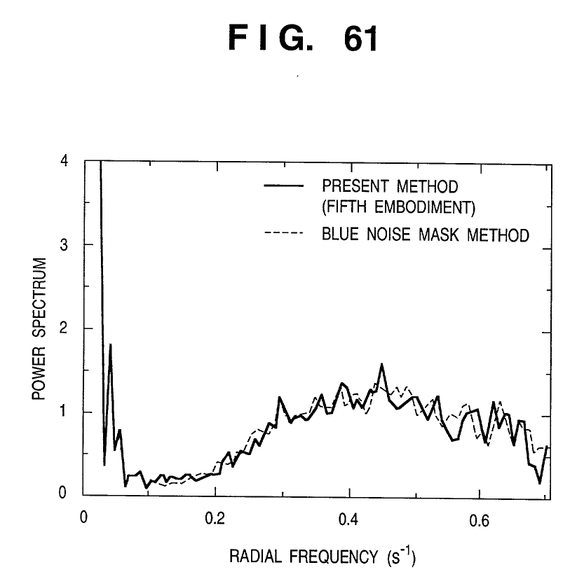

FIGS. 61, 62, and 63 show the spatial frequency properties of the dot pattern for the 32nd gray level generated only using a single unit mask according to this embodiment. Due to the same mask shape as in the fourth embodiment, the spatial frequency properties of the dot pattern for the single mask or of a dot pattern for the 128×128 blue noise mask cut out in the same shape as that of the single mask was evaluated in the same manner as in the fourth embodiment.

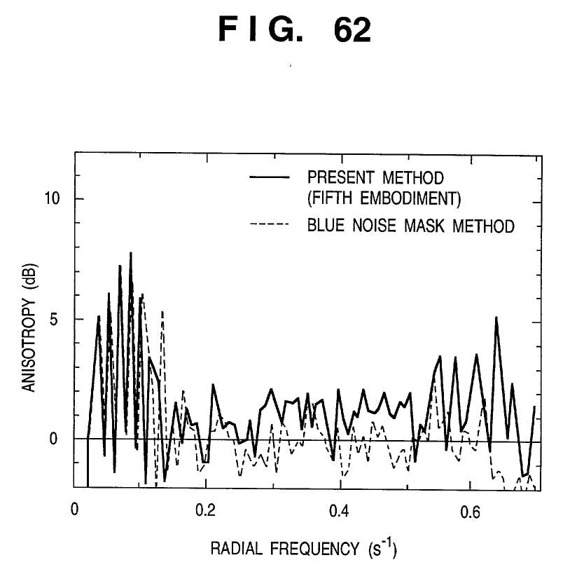

FIG. 61 shows the one-dimensional power spectra of the dot patterns for the 32nd gray level according to the fifth embodiment and the blue noise mask method, and FIG. 62 shows the anisotropy spectra of the above dot patterns. Since both methods show very high spectra at frequencies lower than 0.1/s or 0.15/s in FIG. 61, because each dot patter in the unit pixel block of a specific shape was evaluated using the square pixel block, the frequency area higher than or equal to 0.2/s which is not substantially affected by these spectra are used for comparison.

With respect to the one-dimensional power spectra, this embodiment has relatively higher isolated spectra than those in the blue noise mask method, but the difference between this embodiment and the blue noise mask method is smaller than the difference between the fourth embodiment and the blue noise mask method. With respect to the anisotropy of the frequency region higher than or equal to 0.2/s, the blue noise mask method has an average anisotropy of 0 dB and is thus isotropic, and even a very anisotropic spectrum its value is equivalent to that of the highest anisotropic spectrum at the gray level exhibiting the highest anisotropy in the Perturbed Error Diffusion method (Ulichney, FIG. 8.15).

On the other hand, this embodiment has an average value of 1.2 dB and includes one spectrum having a maximum value exceeding 4 dB, reaching 5 dB which is evaluated to be an especially anisotropic level. Thus, the spectral properties of this dot pattern corresponding to the single mask meet the conditions for the non-blue noise properties in the mask method, so the dot pattern has the non-blue noise properties.

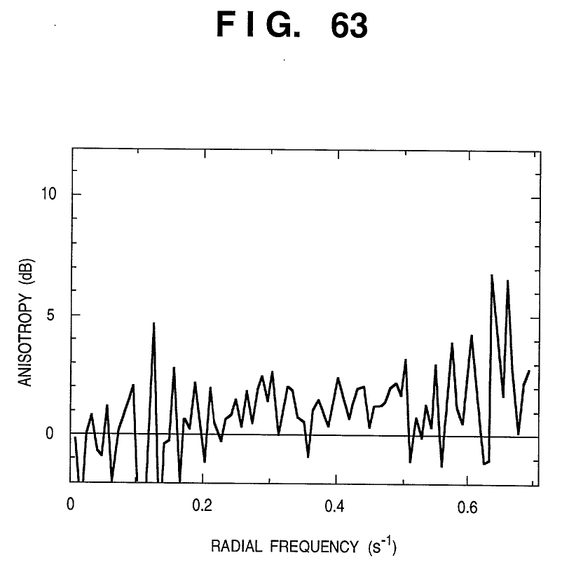

For reference, FIG. 63 shows the result of subtracting the anisotropy spectrum of the blue noise mask method from the anisotropy spectrum of this embodiment in order to eliminate the effects of the specific shape of the unit pixel block. Hence, if the blue noise mask method is assumed to be completely isotropic, this embodiment exhibits higher anisotropy than in FIG. 62 and includes two spectra exceeding 5 dB. The one-dimensional power spectrum and anisotropy spectrum include a plurality of isolated spectra having equal frequencies, and this shows that the mask itself has periodicity.

In the other gray levels, the number of gray levels exhibiting a maximum anisotropy value equivalent to that of the 32nd gray level reaching 5dB and the number of gray levels exhibiting a slightly lower spectrum maximum value are about in half. Due to the periodic structure of the mask, the unit mask according to this embodiment is more anisotropic than the Perturbed Error Diffusion method by Ulichney exhibiting a good isotropy for three of six comparable gray levels being able to refer with. Thus, this embodiment has a property basically different from that of the blue noise mask method having an average value indicating being isotropic.

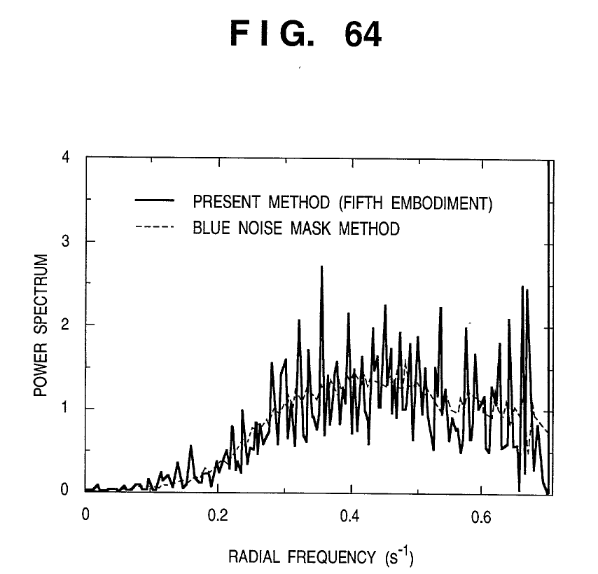

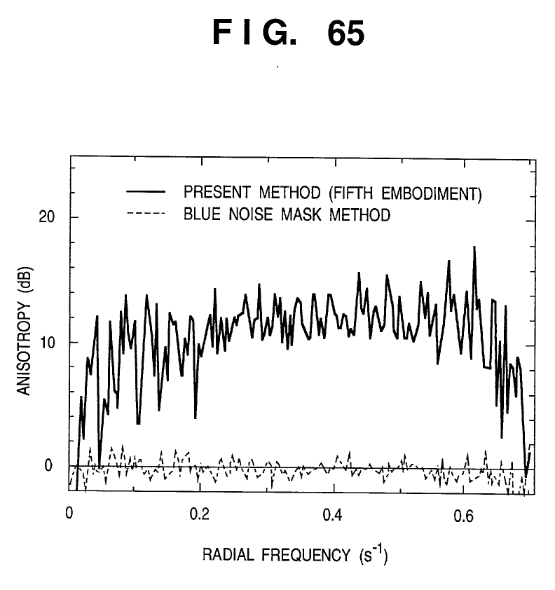

FIGS. 64 and 65 show the spatial frequency properties of the dot patterns for the 32nd gray level generated using both the unit mask of this embodiment and the 256×256 blue noise mask, on each image plane of 256×256 pixels, which is a standard for evaluating spectra. FIG. 64 shows the one-dimensional power spectra of the above dot patterns. In this figure, the solid line shows this embodiment, while the broken line shows the case of the 256×256 blue noise mask. This embodiment shows a low noise component and many isolated spectra having high sharp peaks.

FIG. 65 shows the anisotropy spectra of the above dot patterns. In this figure, the solid line shows this embodiment and the broken line shows the case of the 256×256 blue noise mask. This embodiment exhibits an extremely high anisotropy of about 10 dB as an average value.

Such spectral properties are not limited to the 32nd gray level but are found in all gray levels, so the dot patterns each generated in a standard size image plane using the mask according to this embodiment obviously have the non-blue noise properties in the all gray level.

As described above, despite its very high anisotropy, this embodiment substantially prevented viewers from sensing periodic artifacts caused by the repetition of each identical pattern as shown in the gray scale in FIG. 73 for the 64×64 blue noise mask almost equivalent to the mask of this embodiment in size (×0.8).

In addition, when output images obtained respectively using the mask of this embodiment and the 256×256 blue noise mask were compared using the input image having gradually changing tones in lower gray levels, the present mask exhibited a slightly better performance than that of the blue noise mask in reproducing the gradually changing tones. This result shows that the halftone reproduction performance of the mask of this embodiment is slightly higher than or equal to that of the 256×256 blue noise mask optimal for a 600-dpi printer, while its size is about one-thirteenth (substantially one-twenty fifth if an improved memory readout method is used) of the size of the 256×256 blue noise mask.

These results of evaluations prove that the mask according to this embodiment is not based on the scheme for the blue noise properties shown in FIG. 68 but on the new scheme shown in FIG. 1.

As described above in detail, although the conventional blue noise mask method causes artifacts when evaluation of reduced size masks is carried out by using a standard size image plane, the present embodiments using small masks enable to obtain output images of superior uniformity and quality, because the masks smaller than the size corresponding to a pixel block of the standard size prevent dot patterns each generated in the pixel block from causing artifacts such as moiré, a certain repetitive pattern caused by the mask itself, both having a visually unpleasing contrast, etc.

In addition, the dot pattern generated by each individual single mask exhibits the non-blue noise characteristics over all gray levels, that is, being regular, thereby enabling uniform high-quality images to be obtained.

Furthermore, despite being based on the various regular properties similar to those of the dispersed-dot dithering method, a low perturbation given to the individual dot distributions in the above method eliminates all of the following three disadvantages specific to the method: (1) moiré is tend to occur, (2) regular patterns appear in the image plane, and (3) non-uniform feeding is likely to cause striped noises. As a result, the present embodiments enable halftone reproduction having the following excellent characteristics:

(i) the dot distribution is uniform over all gray levels, and

(ii) the mask is small or substantially small.

This has been verified by the gray scale shown in FIG. 66 obtained using the mask according to the second embodiment and the gray scale shown in FIG. 67 obtained using the mask according to the fourth embodiment.

These figures show dot patterns for the 30th, 31st, and 32nd gray levels shown in the top row from left to right, dot patterns for the 40th, 41st, and 42nd gray levels shown in the middle row from left to right, and dot patterns for the 50th, 51st, and 52nd gray levels shown in the bottom row from left to right, all of which have been outputted by using a 600-dpi printer. In terms of quality, these dot patterns are comparable to the gray scale in FIG. 71 which has also been outputted by using the 256×256 blue noise mask. Nevertheless, the size of the mask according to the second embodiment is 128×128 pixels, which is one-fourth of that of the above blue noise mask, but it can be substantially one-eighth due to the use of a plurality of element masks having the same threshold arrays. In addition, the mask according to the fourth embodiment is about one-thirteenth of the blue noise mask in size, but it can be substantially about one-twentieth due to the use of a plurality of element masks having the same threshold arrays. Thus, the present gray scale reproduction method is suited for a direct print system including a digital camera.

Furthermore, the method, according to the present embodiments, has much of the regularity from the dispersed-dot dithering method. Accordingly, as in the dispersed-dot dithering method, the image quality improves as the definition of the printer increases, so a high quality printout is ensured even if this method is applied to recent 1,200 dpi printers. Thus, different from the blue noise mask method, the method of the above embodiments do not require larger masks even when it is applied to higher definition printers.

Furthermore, according to the method of these embodiments, a periodic or a pseudo periodic pattern is used at the first gray level and dot patterns for higher gray levels also have periodicity coming from the mask. Consequently, examining dot patterns enables us to notice the use of the algorithm for realizing the above embodiments on the evidence of periodicity of the dot patterns.

As described above the gray level reproduction method based on the scheme shown in FIG. 1 has the following characteristics: (1) it has high image quality, (2) the mask is small and/or substantially small, (3) it can prevent software from being used without permission due to unique characteristic dot patterns, and (4) it is more preferably used for high-definition printers. Thus, this method is suitable for a high-definition digital image age including the present and the near future. In regard to this, if a gray scale reproducing apparatus includes a storage medium of a large capacity, this invention is not limited to small masks used in each embodiment but may use a larger mask having, for example, a 256×256 size. Even so, since the larger mask has at least a set of element masks having the same threshold array, the mask is substantially smaller than the 256×256 size.

Although the above embodiments have been described in conjunction with the conversion of input image data into binary data, this invention is not limited to this aspect but is applicable to conversion into three-or-more-valued data.

Conversion into ternary data will be described.

If the output device is an ink-jet printer that has two types of ink with different densities, three values can be represented.

If input data has 256 gray levels because of assigning 8 bits to each pixel, the input data up to the 128th gray level is doubled and then binarized using one of the masks produced according to the above embodiments. If the resulting value is 1, the lighter ink is ejected. If data between the 129th and 256th gray levels is input, it is binarized using the mask created according to one of the above embodiments and the darker ink is ejected if the resulting value is 1. Alternatively, up to the 128th gray level, another mask having half the thresholds (decimals are omitted) of the mask created according to one of the above embodiments is separately provided for the lighter ink. Compared to the case when the darker ink alone is used, the number of dots in a dot pattern is doubled at each gray level up to the 128th gray level by using either one of the above methods, thereby enabling a gradually changing portion of an input image of low gray levels to be reproduced smoothly.

Thus, such multi-valued techniques shown above are important in improving the reproducibility of gradation such as those seen in the human skin etc., and higher-quality output images can be obtained by applying masks created according to the above embodiments to such techniques.

In addition, if this invention is applied to color image processing, different masks created according to the above embodiments are used for different colors (for example, Y/M/C/K) to provide binary or multivalue data.

System Configuration

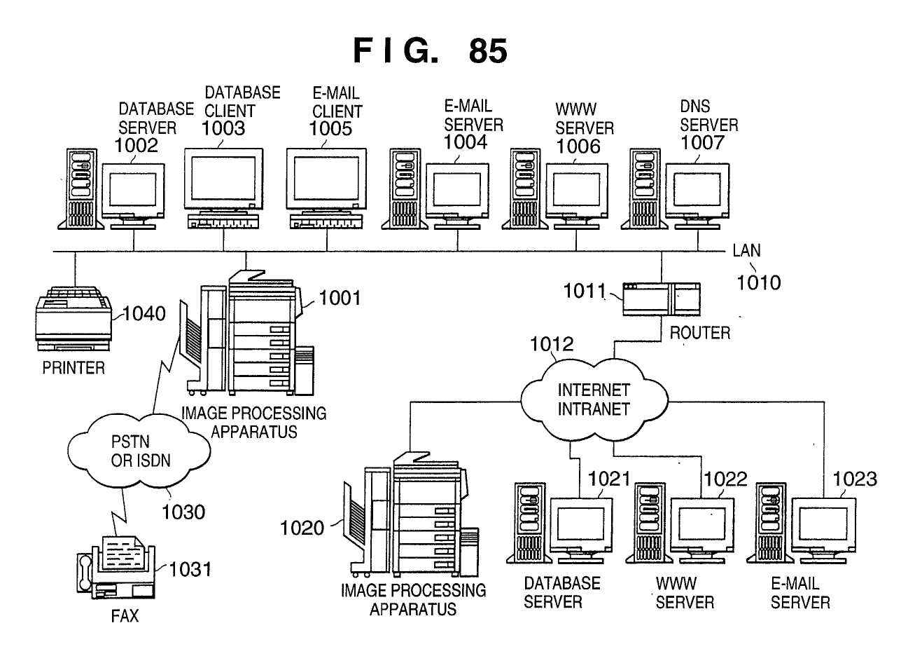

FIG. 85 shows a schematic diagram generally illustrating a system which can execute the scheme to which the present invention being concerned in the 1st through 5th embodiments conforms.

In FIG. 85, reference numeral 1001 denotes an image processing apparatus according to the present embodiment. This image processing apparatus includes a scanner, a printer, and other devices, which will be described later. Document image data obtained via the scanner can be output over a local area network (LAN). Conversely, image data received via the LAN can be printed on a sheet using the printer. Furthermore, a document image input via the scanner can be transmitted over a public network such as PSTN or ISDN using a facsimile transmission module and an image received via the public network such as PSTN or ISDN can be printed using the printer.

In the system shown in FIG. 85, a database server 1002 stores and manages two-level or multilevel image data input via the image processing apparatus 1001. A database client 1003 can retrieve and read the image data stored in the database server 1002.

An E-mail server 1004 can receive an image input to the image processing apparatus 1001 as data attached to an E-mail.

An E-mail client 1005 is a computer terminal having E-mail capability for receiving and transmitting E-mail via the E-mail server 1004.

A WWW server 1006 provides HTML documents over the LAN. The image processing apparatus 1001 can print HTML documents provided by the WWW server.

The LAN 1010 is connected to Internet/intranet 1012 via a router 1011. Devices 1020, 1021, 1022, and 1023 similar to the above-described database server 1002, the WWW server 1006, the E-mail server 1004, and the image processing apparatus 1001, respectively, are also connected to the Internet/intranet 1012.

The image processing apparatus 1001 can communicate with a facsimile machine 1031 via a PSTN/ISDN 1030. Furthermore, a printer 1040 is connected to the LAN so that an image input to the image processing apparatus 1001 can be printed by the printer 1040.

The construction and operation of the image processing apparatus 1001 is described in detail below in terms of hardware and also software.

1. Hardware

1.1 General Construction

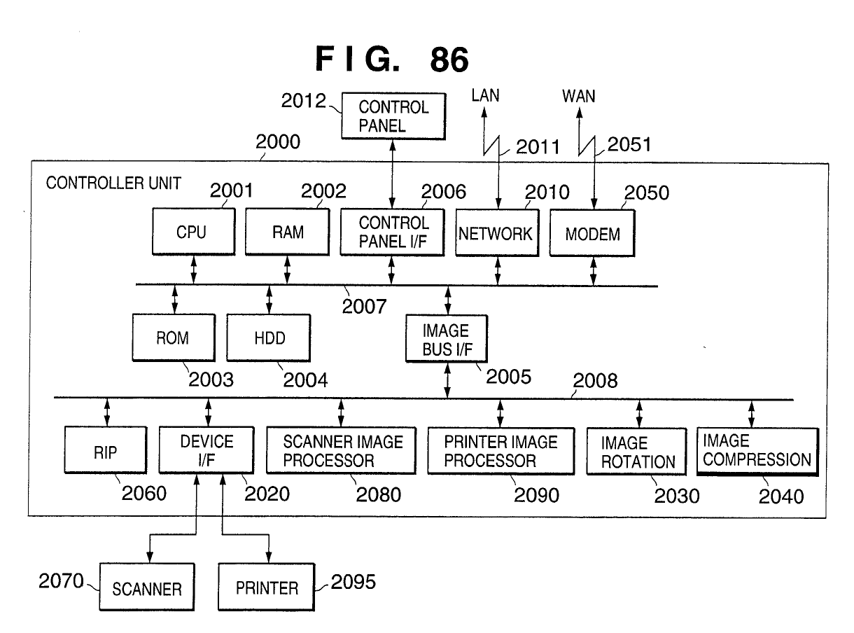

FIG. 86 shows a block diagram illustrating the general construction of the image processing apparatus 1001 shown in FIG. 85. A controller unit 2000 is connected to devices such as a scanner 2070 serving as an image input device (for scanning the image of a document) and a printer 2095 serving as an image output device (for outputting an image in a visible form) and also connected to a LAN 2011 (LAN 1010) and a public network (WAN) 2051 (PSTN/ISDN 1030) so as to control the input/output operation of image information and device information.

A CPU 2001 serves as a controller for controlling the operation over the entire image processing apparatus shown in FIG. 86. A RAM 2002 serves as a system work memory used by the CPU 2001 and also as an image memory for temporarily storing image data. A ROM 2003 is a boot ROM storing a boot program used by the image processing apparatus. A HDD 2004 is a hard disk drive for storing a system software program and image data.

A control panel I/F 2006 serves as an interface for a control panel 2012, for outputting image data to the control panel 2012. The control panel I/F 2006 also serves to transfer information input by a user via the control panel 2012 to the CPU 2001.

A network I/F 2010 serves to connect the image processing apparatus to the LAN 2011 including a plurality of terminals so as to make it possible to input and output information via the LAN 2011. A modem 2050 serves to connect the image processing apparatus to a public network 2051 so as to make it possible to input and output information via the public network 2051.

The devices described above are connected to a system bus 2007.

The system bus 2007 is connected to an image bus 2008 via a image bus I/F 2005 serving as a bus bridge for converting the data structure. The image bus 2008 may be realized using a PCI bus or an IEEE 1394 bus.

The following devices are located on the image bus 2008.

One device is a raster image processor (RIP) 2060 for converting a PDL code to a bit map image. Another device is a device I/F 2020 for connecting the scanner 2070 and the printer 2095, serving as image input/output devices, to the controller 2000 whereby image data can be transferred in a synchronous or asynchronous fashion between the image input/output devices and the controller 2000, Furthermore, a scanner image processor 2080 performs correction, edition, and other processing on the input image data, and a printer image processor 2000 performs correction, resolution conversion, and other processing on the image data to be output, depending on the characteristics of the printer. An image rotation unit 2030 is used to rotate image data and an image compression/decompression unit 2040 performs compression/decompression on image data according to the JPEG standard from multilevel image data and according to the JBIG, MMR, or MH technique for two-level image data.

1.2 Image Input/Output Device

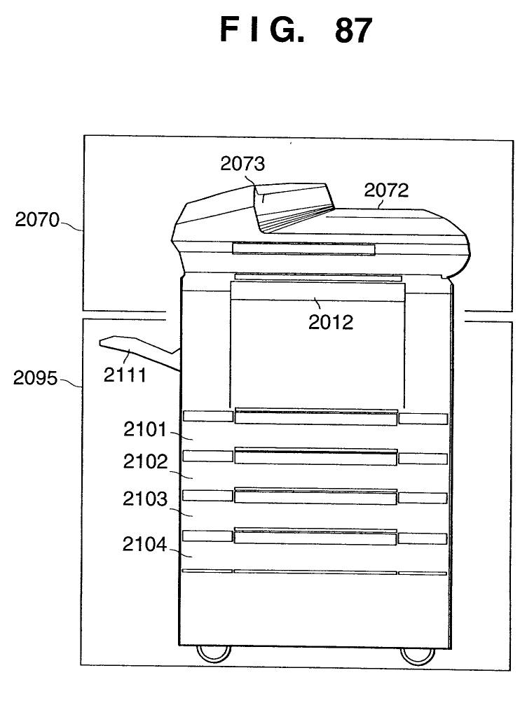

FIG. 87 shows an external view of an image input/output device, wherein similar reference numerals denote similar parts to those described above. In any other figures, similar reference numerals are used to denote similar parts.

A scanner 2070 serving as an image input device scans a document illuminated with light and senses the image thereof using a CCD line sensor (not shown) thereby generating raster image data in the form of an electric signal corresponding to the original image of the document. Documents are placed on a tray 2073 of a document feeder 2072. If a user issues a scan start command via a control panel 2012, a controller CPU 2001 sends a command to the scanner 2070 to feed one document at a time from the feeder and scan the image of the fed document.

A printer 2095 serving as an image output device converts the raster image data 2096 in the form of an electric signal to a corresponding visible image on a sheet of paper. The printer 2095 may be realized in any form such as an electro-photographic printer with a photo-sensitive drum or belt, or an ink-jet printer in which ink is emitted from a small-nozzle array thereby directly forming an image on a sheet of paper. Printing operation is started if a command 2096 is issued by the controller CPU 2001. The printer 2095 includes paper feeders in which paper cassettes 2101, 2102, 2103, and 2104 are placed so that paper of a desired size and/or direction can be fed from a selected paper cassette. Printed paper is fed onto an output tray 2111.

1.3 Scanner Image Processor

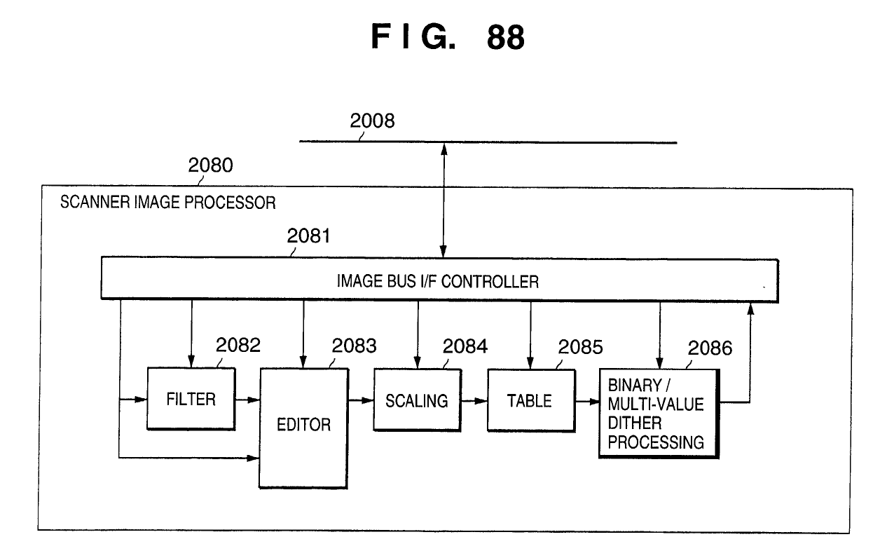

FIG. 88 shows a block diagram illustrating a construction of the scanner image processor 2080 shown in FIG. 86.

An image bus I/F controller 2081 is connected to the image bus 2008 so that it serves to control the bus access sequence and also controls the operation, including the timing control, of various devices of the scanner image processor 2080.

A filtering processing unit 2082 is a spatial filter for performing a convolution operation on image data. An editor 2083 performs an editing operation on input image data. For example, the editor 2083 detects, from the input image data, an area enclosed in a closed line marked on the document with a marker pen, and then performs various processes, such as shading, cross-hatching, and negative-positive inverting on the image data within the closed area. When the resolution of the image data is changed, a scaling unit 2084 scales the image data, up or down, by performing interpolation on the raster image in the main scanning direction. Scaling in the subscanning direction is performed by changing the scanning speed of an image line sensor (not shown). A table 2085 is a conversion table which is referred to when image data representing luminance obtained by scanning is converted to data representing intensity. A binarization unit 2086 converts input multilevel gray-scale image data to two-level or multivalue data by dither processing.

The dither processing applied here can be performed with any one of threshold matrices (masks) described in 1st through 5th embodiments.

After completion of the above-described process, the image data is transmitted over the image bus 2008 via the image bus controller 2081.

1.4 Printer Image Processor

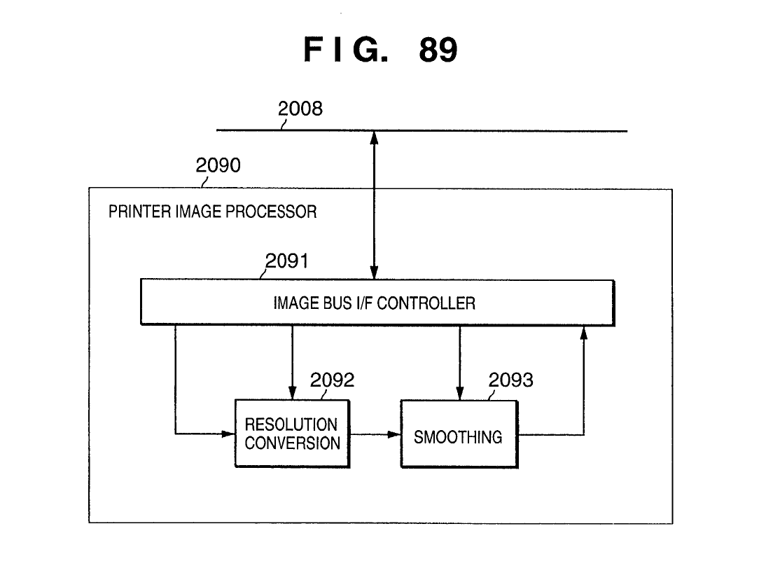

FIG. 89 shows a block diagram illustrating a construction of the printer image processor 2090 shown in FIG. 86.

An image bus I/F controller 2091 is connected to the image bus 2008 so that it serves to control the bus access sequence, and also controls the operation, including the timing control, of various devices of the printer image processor 2090. A resolution converter 2092 converts the resolution of image data received via the network I/F 2011 or the public line 2051 so that it matches resolution required by the printer 2095. A smoothing unit 2093 smoothes out jaggedness (appearing at a white/black boundary such as an oblique line) of image converted in resolution.

This invention can also be applied to a system composed of multiple devices such as a host computer, interface equipment, a reader, and a printer, and can further be applied to a single device such as a copier or facsimile terminal equipment.

This invention can also be applied to a case in which a storage medium on which is recorded a software program that implements the functions of the above embodiments is supplied to a system or an apparatus and in which a computer (or CPU or MPU) in the system or apparatus then reads out and executes program codes stored in the storage medium.

In this case, the program codes read out from the storage medium implements the functions of the above embodiments, and the storage medium storing the program codes constitutes this invention.

The storage medium supplying the program codes includes, for example, a floppy disc, a hard disc, an optical disc, a photo-magnetic disc, a CD-ROM, a CD-R, a magnetic tape, a non-volatile memory card, or a ROM.

Of course, the program codes read out by the computer cannot only be executed to realize the functions of the above embodiments but an OS (operating system) running on the computer can also carry out all or part of the actual processing in order to realize the functions of the above embodiments.

Furthermore, after the program code read out from the storage medium has been written in the memory of an extension board inserted into the computer or extension unit connected thereto, a CPU in the extension board or unit can execute all or a part of actual processing based on instructions form the program code in order to realize the functions of the above embodiments.

As described above, this invention makes it possible to obtain high-quality images each with a uniform dot distribution using small or substantially small masks and to obviate the need to increase the mask size for high-definition printers, reducing the memory capacity required to store the individual masks.

As many apparently widely different embodiments of the present invention can be made without departing from the spirit and scope thereof, it is to be understood that the invention is not limited to the specific embodiments thereof expect as defined in the appended claims.

What is claimed is:

1. A method of reproducing gray levels to represent the density of each pixel of an output image by binary or multivalue data based on a one-to-one correspondence of each pixel of an input image to each element of a threshold matrix (a mask), comprising the steps of:
providing non-blue noise properties for each respective gray level of a dot pattern generated in a pixel block of a standard size using the mask of a size corresponding to a size smaller or substantially smaller than the standard size of the pixel block; and
generating, in the output image, no visually unpleasing artifacts, when the input image undergoes the gray level reproducing process and the produced image is output by an output device.

2. The method according to claim 1, wherein said output device has a resolution of about 600 dpi or greater.

3. The method according to claim 1, wherein said artifacts include moiré and/or a certain repetitive pattern both having visually unpleasing contrast.

4. The method according to claim 1, wherein said dot pattern generated by the mask has a value equal to or greater than 0.6 dB as an average value of anisotropy at each respective gray level.

5. The method according to claim 1, wherein adjacent masks are shifted along boundaries when said mask is repeatedly used and arranged two-dimensionally.

6. The method according to claim 1, wherein said mask is not a quadrilateral.

7. The method according to claim 1, wherein, as a process of determining a dot distribution at each respective gray level for producing said mask, a repulsive potential is assigned to all dots constructing a determined dot pattern of a specific gray level and a new dot to determine a dot distribution for a next gray level is placed at a position having the lowest repulsive potential in/within the sum of said repulsive potentials.

8. A method of reproducing gray levels of a color image using the method according to any one of claims 1 to 7, wherein the color image is separated into a plurality of color components; and at least one of the color components of the color image is used as the input image.

9. A method of reproducing gray levels to represent the density of each pixel of an output image by binary or multivalue data based on a one-to-one correspondence of each pixel of an input image to each element of a threshold matrix (a mask), comprising the steps of:
providing non-blue noise properties for each respective gray level of a dot pattern generated by the single mask; and
generating, in the output image, no visually unpleasing artifacts when the input image undergoes the gray level reproducing process and the produced image is output by an output device.

10. The method according to claim 9, wherein said output device has a resolution of about 600 dpi or greater.

11. The method according to claim 9, wherein said artifacts include moiré and/or a certain repetitive pattern both having visually unpleasing contrast.

12. The method according to claim 9, wherein adjacent masks are shifted along boundaries when said mask is repeatedly used and arranged two-dimensionally.

13. The method according to claim 9, wherein said mask is not a quadrilateral.

14. The method according to claim 9, wherein, as a process of determining a dot distribution at each respective gray level for producing said mask, a repulsive potential is assigned to all dots constructing a determined dot pattern of a specific gray level and a new dot to determine a dot distribution for a next gray level is placed at a position having the lowest repulsive potential in/within the sum of said repulsive potentials.

15. A method of reproducing gray levels of a color image using the method according to any one of claims 9 to 14, wherein the color image is separated into a plurality of color components; and at least one of the color components of the color image is used as the input image.

16. A method of reproducing gray levels to represent the density of each pixel of an output image by binary or multivalue data based on a one-to-one correspondence of each pixel of an input image to each element of a threshold matrix (a mask), comprising the steps of:
providing a plurality of isolated spectra for a two-dimensional spatial frequency spectrum of an individual dot pattern generated by a single mask at each respective gray level; and
generating, in the output image, no visually unpleasing artifacts when the input image undergoes the gray level reproducing process and the produced image is outputted by an output device.

17. The method according to claim 16, wherein each dot pattern generated by said mask has a noise component having small low frequency components of a one-dimensional power spectrum due to weak irregularity (perturbation) or pseudo-periodicity introduced at a plurality of gray levels.

18. The method according to claim 16, wherein said output device has a resolution of about 600 dpi or greater.

19. The method according to claim 16, wherein said artifacts include moiré and/or a certain repetitive pattern both having visually unpleasing contrast.

20. The method according to claim 16, wherein adjacent masks are shifted along boundaries when said mask is repeatedly used and arranged two-dimensionally.

21. The method according to claim 16, wherein said mask is not a quadrilateral.

22. The method according to claim 16, wherein, as a process of determining a dot distribution at each respective gray level for producing said mask, a repulsive potential is assigned to all dots constructing a determined dot pattern of a specific gray level and a new dot to determine a dot distribution for a next gray level is placed at a position having the lowest repulsive potential in/within the sum of said repulsive potentials.

23. A method of reproducing gray levels of a color image using the method according to any one of claims 16 to 22, wherein the color image is separated into a plurality of color components; and at least one of the color components of the color image is used as the input image.

24. A method of representing the density of each pixel of an output image by binary or multivalue data based on a one-to-one correspondence of each pixel of an input image to each element of a threshold matrix (a mask), comprising the steps of:
said mask having the size of an array of a plurality of element masks, each of which being of the same size as that of a mask used in the dispersed-dot dithering method; and
a dot pattern generated by said mask:
(1) having at least a set of element pixel blocks, each of which corresponding to each element mask and having the same dot distribution at each respective gray level;
(2)having weak irregularity (perturbation) or pseudo-periodicity introduced at a certain gray level;
(3) having an equal number of dots in every element pixel block at each respective gray level; and
(4) having an equal number of dots in four individual partial element pixel blocks each having a quarter size of an element pixel block at each respective (4n)th (n indicates a positive integer) gray level.

25. The method according to claim 24, wherein said weak irregularity (perturbation) or pseudo-periodicity is introduced at a certain low gray level equal to or higher than the first gray level.

26. The method according to claim 24, wherein the size of said mask is smaller or substantially smaller than the size corresponding to a standard size pixel block and the mask is repeatedly arranged two-dimensionally and regularly corresponding to the entire input image.

27. The method according to claim 24, wherein said mask has the size of an array of a plurality of element masks, each of which being of the same size as that of a mask used in the dispersed-dot dithering method.

28. The method according to claim 24, wherein said dot pattern generated in the output image has no visually unpleasing artifacts, when the input image undergoes said gray level reproducing process and the produced image is outputted by an output device.

29. The method according to claim 28, wherein said output device has a resolution of about 600 dpi or greater.

30. The method according to claim 28, wherein said artifacts include moiré and/or a certain repetitive pattern both having visually unpleasing contrast.

31. The method according to claim 24, wherein adjacent masks are shifted along boundaries when said mask is repeatedly used and arranged two-dimensionally.

32. The method according to claim 24, wherein said mask is not a quadrilateral.

33. The method according to claim 24, wherein said weak irregularity (perturbation) or pseudo-periodicity is implemented by providing small pixel blocks, each having a number of pixels equal to or smaller than a quarter (¼) of the total number of pixels in an element pixel block, at predetermined positions in all or a part of the individual element pixel blocks, each corresponding to each element mask, and by selecting one pixel for a dot in each of said small pixel blocks.

34. The method according to claim 24, wherein, as a process of determining a dot distribution at each respective gray level for producing said mask, a repulsive potential is assigned to all dots constructing a determined dot pattern of a specific gray level and a new dot to determine a dot distribution for a next gray level is placed at a position having the lowest repulsive potential in/within the sum of said repulsive potentials.

35. A method of reproducing gray levels of a color image using the method according to any one of claims 24 to 34, wherein the color image is separated into a plurality of color components; and at least one of the color components of the color image is used as the input image.

36. An apparatus for reproducing gray levels to represent the density of each pixel of an output image by binary or multivalue data based on a one-to-one correspondence of each pixel of an input image to each element of a threshold matrix (a mask), wherein:
providing non-blue noise properties for each respective gray level of a dot pattern generated in a pixel block of a standard size using the mask of a size smaller or substantially smaller than the standard size of the pixel block; and
generating, in the output image, no visually unpleasing artifacts, when the input image undergoes the gray level reproducing process and the image is output by an output device.

37. An apparatus for reproducing gray levels to represent the density of each pixel of an output image by binary or multivalue data based on a one-to-one correspondence of each pixel of an input image to each element of a threshold matrix (a mask), wherein:
providing non-blue noise properties for each respective gray level of a dot pattern generated by the single mask; and
generating, in the output image, no visually unpleasing artifacts when an input image undergoes a gray level reproducing process and the produced image is output by an output device.

38. An apparatus for reproducing gray levels to represent the density of each pixel of an output image by binary or multivalue data based on a one-to-one correspondence of each pixel of an input image to each element of a threshold matrix (a mask), wherein:
providing a plurality of isolated spectra for a two-dimensional spatial frequency spectrum of a dot pattern generated by the single mask at each respective gray level; and
generating, in an output image, no visually unpleasing artifacts when the input image has undergone a gray level reproducing process and output by an output device.

39. An apparatus for representing the density of each pixel of an output image by binary or multivalue data based on a one-to-one correspondence of each pixel of an input image to each element of a threshold matrix (a mask), wherein:
composing said mask by an array of a plurality of element masks, each of which being of the same size as that of a mask used in the dispersed-dot dithering method; and
generating, by said mask, a dot pattern:
(1) having at least a set of element pixel blocks, each of which corresponding to each element mask and having the same dot distribution at each respective gray level;
(2) having weak irregularity (perturbation) or pseudo-periodicity introduced at a certain gray level;
(3) having an equal number of dots in every element pixel block at each respective gray level; and
(4) having an equal number of dots in four individual partial element pixel blocks each having a quarter size of an element pixel block at each respective (4n)th (n indicates a positive integer) gray level.

40. The apparatus according to claim 39, wherein said weak irregularity (perturbation) or pseudo-periodicity is introduced at a certain low gray level equal to or higher than the first gray level.

41. The apparatus according to claim 39, wherein the size of said mask is smaller or substantially smaller than the size corresponding to a standard size of a pixel block and repeatedly arranged two-dimensionally and regularly corresponding to the entire input image.

42. An apparatus for reproducing gray levels to represent the density of each pixel of an output image by binary or multivalue data based on a one-to-one correspondence of each pixel of an input image to each element of a threshold matrix (a mask), comprising:
storage means for storing the threshold matrix;
comparison means for comparing each value of the threshold matrix with density of each pixel of the input image; and
output means for outputting a binary or multivalue dot pattern based on comparison results of said comparison means, wherein:
said threshold matrix has a size corresponding to a size smaller or substantially smaller than a standard size pixel block, a dot pattern generated in the standard size pixel block has non-blue noise properties at each respective gray level, and visually unpleasing artifacts are not generated in the output image when the input image undergoes the gray level reproducing process and the produced image is output by an output device.

43. The apparatus according to claim 42, wherein said output device has a resolution of about 600 dpi or greater.

44. The apparatus according to claim 42, wherein said artifacts include moiré and/or a certain repetitive pattern both having visually unpleasing contrast.

45. An apparatus for reproducing gray levels to represent the density of each pixel of an output image by binary or multivalue data based on a one-to-one correspondence of each pixel of an input image to each element of a threshold matrix (a mask), comprising:
storage means for storing the threshold matrix;
comparison means for comparing each value of the threshold matrix with density of each pixel of the input image; and
output means for outputting a binary or multivalue dot pattern based on comparison results of said comparison means, wherein:
said threshold matrix produces, by itself, the dot pattern having non-blue noise properties at each respective gray level, and generates, in the output image, no visually unpleasing artifacts when the input image undergoes the gray level reproducing process and the produced image is output by an output device.

46. The apparatus according to claim 45, wherein said output device has a resolution of about 600 dpi or greater.

47. The apparatus according to claim 45, wherein said artifacts include moiré and/or a certain repetitive pattern both having visually unpleasing contrast.

48. An apparatus for reproducing gray levels to represent the density of each pixel of an output image by binary or multivalue data based on a one-to-one correspondence of each pixel of an input image to each element of a threshold matrix (a mask), comprising:
storage means for storing the threshold matrix;
comparison means for comparing each value of the threshold matrix with density of each pixel of the input image; and
output means for outputting a binary or multivalue dot pattern based on comparison results of said comparison means, wherein:
said threshold matrix produces, by itself, a dot pattern having a plurality of isolated spectra in a two-dimensional spatial frequency spectrum at each respective gray level and assigns a noise component having small low frequency components to a one-dimensional power spectrum of a dot distribution at a plurality of gray levels.

49. The apparatus according to claim 48, wherein said threshold matrix assigns said noise component by introducing weak irregularity (perturbation) or pseudo-periodicity in the dot distribution at said plurality of gray levels.

50. An apparatus for reproducing gray levels to represent the density of each pixel of an output image by binary or multivalue data based on a one-to-one correspondence of each pixel of an input image to each element of a threshold matrix (a mask), comprising:
storage means for storing the threshold matrix;
comparison means for comparing each value of the threshold matrix with the density of each pixel of the input image; and
output means for outputting a binary or multivalue dot pattern based on comparison results of said comparison means, wherein:
said mask has the size of an array of a plurality of element masks, each of which being of the same size as that of a mask used in the dispersed-dot dithering method, and generates a dot pattern:
(1) having at least a set of element pixel blocks, each of which corresponding to each element mask and having the same dot distribution at each respective gray level;
(2)having weak irregularity (perturbation) or pseudo-periodicity introduced at a certain gray level;
(3) having an equal number of dots in every element pixel block at each respective gray level; and
(4) having an equal number of dots in four individual partial element pixel blocks each having a quarter size of an element pixel block at each respective (4n)th (n indicates a positive integer) gray level.

51. The apparatus according to claim 50, wherein said weak irregularity (perturbation) or pseudo-periodicity is introduced at a certain low gray level equal to or higher than the first gray level.

52. A threshold matrix (a mask) for use in converting the density of each pixel of an input image into binary or multivalue data, wherein said threshold matrix has a size corresponding to a size smaller or substantially smaller than a standard size of a pixel block, a dot pattern generated by said threshold matrix in the standard size pixel block has non-blue noise properties at each respective gray level, and visually unpleasing artifacts are not generated in an output image when the input image undergoes the gray level reproducing process and the produced image is output by an output device.

53. The threshold matrix according to claim 52, wherein said output device has a resolution of about 600 dpi or greater.

54. The threshold matrix according to claim 52, wherein said artifacts include moiré and/or a certain repetitive pattern both having visually unpleasing contrast.

55. A threshold matrix (a mask) for use in converting the density of each pixel of an input image into binary or multivalue data, wherein said threshold matrix produces, by itself, a dot pattern having non-blue noise properties at each respective gray level, and generates in an output image no visually unpleasing artifacts when the input image undergoes the gray level reproducing process and the produced image is output by an output device.

56. The threshold matrix according to claim 55, wherein said output device has a resolution of about 600 dpi or greater.

57. The threshold matrix according to claim 55, wherein said artifacts include moiré and/or a certain repetitive pattern both having visually unpleasing contrast.

58. A threshold matrix (a mask) for use in converting the density of each pixel of an input image into binary or multivalue data, wherein said threshold matrix produces, by itself, a dot pattern having a plurality of isolated spectra in a two-dimensional spatial frequency spectrum at each respective gray level and assigns a noise component having small low frequency components to a one-dimensional power spectrum of the dot distribution at a plurality of gray levels.

59. The threshold matrix according to claim 58, wherein said threshold matrix assigns said noise component by introducing weak irregularity (perturbation) or pseudo-periodicity in the dot distribution at said plurality of gray levels.

60. A threshold matrix (a mask) for use in converting the density of each pixel of an input image into binary or multivalue data, wherein said mask having the size of an array of a plurality of element masks, each of which being of the same size as that of a mask used in the dispersed-dot dithering method, and a generated dot pattern has:
(1) at least a set of element pixel blocks, each of which corresponding to each element mask and having the same dot distribution at each respective gray level;
(2) weak irregularity (perturbation) or pseudo-periodicity introduced at a certain gray level;
(3) an equal number of dots in every element pixel block at each respective gray level; and
(4) an equal number of dots in four individual partial element pixel blocks each having a quarter size of an element pixel block at each respective (4n)th (n indicates a positive integer) gray level.

61. The threshold matrix according to claim 60, wherein said weak irregularity (perturbation) or pseudo-periodicity is introduced at a certain low gray level equal to or higher than the first gray level.

62. A computer-readable storage medium storing a control program for controlling a gray level reproducing process to represent the density of each pixel of an output image by binary or multivalue data based on a one-to-one correspondence of each pixel of an input image to each element of a threshold matrix (a mask), comprising:
a threshold matrix having a size corresponding to a size smaller or substantially smaller than a standard size of a pixel block, a dot pattern generated, by the threshold matrix, in a pixel block of the standard size having non-blue noise properties at each respective gray level, wherein visually unpleasing artifacts are not generated in the output image when the input image undergoes the gray level reproducing process and the produced image is output by an output device; and
a module for comparing each value of the threshold matrix with the density of each pixel of the input image, and for controlling an output of each binary or multivalue dot pattern depending on the comparison results.

63. The computer-readable storage medium according to claim 62, wherein said output device has a resolution of about 600 dpi or greater.

64. The computer-readable storage medium according to claim 62, wherein said artifacts include moiré and/or a certain repetitive pattern both having visually unpleasing contrast.

65. A computer-readable storage medium storing a control program for controlling a gray level reproducing process to represent density of each pixel of an output image by binary or multivalue data based on a one-to-one correspondence of each pixel of an input image to each element of a threshold matrix (a mask), comprising:
a threshold matrix for producing, by itself, a dot pattern having non-blue noise properties at each respective gray level, wherein visually unpleasing artifacts are not generated when the input image undergoes the gray level reproducing process and the produced image is outputted by an output device; and
a module for comparing each value of the threshold matrix with the density of each pixel of the input image, and for controlling an output of each binary or multivalue dot pattern depending on the comparison results.

66. The computer-readable storage medium according to claim 65, wherein said output device has a resolution of about 600 dpi or greater.

67. The computer-readable storage medium according to claim 65, wherein said artifacts include moiré and/or a certain repetitive pattern both having visually unpleasing contrast.

68. A computer-readable storage medium storing a control program for controlling a gray level reproducing process to represent the density of each pixel of an output image by binary or multivalue data based on a one-to-one correspondence of each pixel of an input image to each element of a threshold matrix (a mask), comprising:
the threshold matrix producing, by itself, a dot pattern having a plurality of isolated spectra in a two-dimensional spatial frequency spectrum at each respective gray level and assigning a noise component having small low frequency components to a one-dimensional power spectrum of a dot distribution at each of a plurality of gray levels; and
a module for comparing each value of the threshold matrix with the density of each pixel of the input image, and for controlling an output of each binary or multivalue dot pattern depending on the comparison results.

69. The computer-readable storage medium according to claim 68, wherein said noise component is caused by introducing weak irregularity (perturbation) or pseudo-periodicity in the dot distribution at said plurality of gray levels.

70. A computer-readable storage medium storing a control program for controlling a gray level reproducing process to reproduce the density of each pixel of an output image by binary or multivalue data based on a one-to-one correspondence of each pixel of an input image to each element of a threshold matrix (a mask), comprising:
the threshold matrix having the size of an array of a plurality of element masks, each of which being of the same size as that of a mask used in the dispersed-dot dithering method, wherein a generated dot pattern has:
(1) at least a set of element pixel blocks each of which corresponding to each element mask and having the same dot distribution at each respective gray level;
(2) weak irregularity (perturbation) or pseudo-periodicity introduced at a certain gray level;
(3) an equal number of dots in every element pixel block at each respective gray level; and
(4) an equal number of dots in four individual partial element pixel blocks each having a quarter size of each element pixel block at each respective (4n)th (n indicates a positive integer) gray level; and
a module for comparing each value of the threshold matrix with density of each pixel of the input image, and for controlling an output of each binary or multivalue dot pattern depending on the comparison results.

71. The computer-readable storage medium according to claim 70, wherein said weak irregularity (perturbation) or pseudo-periodicity is introduced at a certain low gray level equal to or higher than the first gray level.

72. A gray level reproducing apparatus for associating each pixel of an input image with each element of a threshold matrix (a mask) based on a one-to-one correspondence to reproduce the density of each pixel of an output image using binary or multivalue data, wherein:
a dot pattern generated by the threshold matrix has an anisotropy spectrum having an average value of 3 dB or more and a maximum value of 10 dB or more at each respective gray level, and visually unpleasing artifacts are not generated in the output image when the input image undergoes the gray level reproducing process and the produced image is outputted by an output device.

73. The computer-readable storage medium according to claim 72, wherein said output device has a resolution of about 600 dpi or greater.

74. The apparatus according to claim 72, wherein said artifacts include moiré and/or a certain repetitive pattern both having visually unpleasing contrast.
